(19) United States
(12) Patent Application Publication
(10) Pub. No.: US 2023/0214753 A1
(43) Pub. Date: Jul. 6, 2023

(54) GENERATING ISSUE GRAPHS FOR ANALYZING ORGANIZATIONAL INFLUENCE

(71) Applicant: FiscalNote, Inc., Washington, DC (US)

(72) Inventors: VLAD EIDELMAN, Bethesda, MD (US); Daniel Argyle, Provo, UT (US); Anthony DeStefano, Takoma Park, MD (US); Anastassia Kornilova, ARLINGTON, VA (US); Fallon Farmer, Washington, DC (US)

(21) Appl. No.: 17/566,453

(22) Filed: Dec. 30, 2021

(51) Int. Cl. G06Q 10/06; G06N 5/02

(52) U.S. Cl. CPC G06Q 10/06375; G06N 5/02

(57) ABSTRACT

A system for generating and analyzing organizational influence data is disclosed. In one embodiment, at least one processor is configured to access first data associated with a plurality of policymakers; generate first nodes representing the plurality of policymakers within an issue graph model; generate a second node representing an organization; receive a selection of an agenda issue of interest to the organization; access second data associated with the organization; generate links within the issue graph model representing relationships between the first nodes and the second node; determine an organizational influence factor comprising a measure of how likely the second node is to affect a property of each of the first nodes; identify at least one node of the first nodes associated with the selected agenda issue based on the organizational influence factor; and output node properties associated with the identified node.

### BACKGROUND

### Technical Field

This disclosure generally relates to systems and methods for generating and analyzing policy, policymaker, and organizational entities and relationships through the construction of issue-based knowledge graphs. More specifically, and without limitation, the present disclosure relates to systems and methods for automatically analyzing electronic structured and unstructured data related to legislative, regulatory, and judicial processes to compute entities and their relationships in a policy intelligence platform.

### Background Information

Organizations often follow policy making processes to best strategize how to promote their interests within a governmental unit. For example, an organization might have particular interest in the outcome of a particular policymaking process that might affect the organization's day-to-day operations, strategic goals, revenue expectations, or risk exposure. One approach used by organizations is to monitor and conduct qualitative and quantitative analysis on the impact various outcomes of the policymaking process may have on the organizations' interests. A second approach is to provide direct or indirect input to policymakers through outreach, advocacy, and educational initiatives. However, understanding what and how a policymaking process will impact is very difficult without resources and specialized software tool.

To effectively understand and act on policy making, organizations need to understand a policy document and connect it within the broader political context to other policy, people, organizations, and events. Manual analysis of policymaking requires a significant investment of time and financial resources with the difficulty of consistently and objectively collating related information while simultaneously accounting for multiple possible outcomes across different affected areas of interest. The sheer diversity, velocity and volume of disparate data sources and types involved in each policymaking process across different levels and governmental entities makes it impractical for an interested person or organization to monitor for emergence, track updates, analyze impact, and participate in potentially relevant policymaking initiatives without automated software tools.

Existing cloud-based software tools include information services systems that can be used to automatically collect and track unstructured data related to news, policymaking, analytics systems (e.g., systems that can be used to identify topics, trends, and potential outcomes in news and legal documents), customer relationship management systems (CRM) (e.g., systems that can be used to store structured people and organizational information and related activities), and social networks that can be used to find relationships between people and organizations. These existing software tools, however, are typically restricted to one or two types of data (e.g. only documents, only organizations, people and organizations) and relationships (e.g. documents related to other documents, people to related other people, people related to organizations). For example, many existing techniques either deal with structured or unstructured data, but lack or have limited capability of deriving structured data from unstructured data or analyzing a combination of structured and unstructured data. Further, many existing solutions obtain data from a limited number of databases and require a significant amount of interaction to create and update information. For example, CRM software predominantly contains people and organizational data, most of which is manually acquired and updated in a structured form. Information services software, such as document tracking and compliance tools contain large historical libraries of documents and can be automatically synced to new governmental documents, however, these systems have limited context for relating documents (e.g. within a single jurisdiction), largely ignore people and organizational data, and require significant manual inputs to update. Social networks may identify relationships between people and organizations, but lack the context of policy documents.

Accordingly, in view of these and other deficiencies in existing computer functionality, there is a need to automatically collect and analyze vast quantities of data stored in many disparate databases relating to many governmental jurisdictions. Technological solution should allow for a combined analysis of this collected data with proprietary user provided data in order to calculate and maintain complex relationships between the unstructured and structured data.

### SUMMARY

Embodiments consistent with the present disclosure provide systems and methods that incorporate machine-trained models and automated data aggregation techniques to automatically analyze electronic structured and unstructured data related to a wide range of policymaking processes (e.g. legislative, regulatory, and judicial processes) to generate and analyze policy, policymaker and organizational entities and relationships through the construction of issue-based knowledge graphs in a policy intelligence platform.

There are many possible applications for such capabilities. For example, organizations that currently use a combination of information services systems, social networks, CRMs, news services, and other tools to understand the context of policy and motivations of policymakers may benefit from the disclosed systems and methods. In addition, the disclosed systems and methods may eliminate redundancies when analyzing data across governmental levels and units.

In an embodiment, a system for analyzing organizational influence data includes at least one processor configured to access first data scraped from the Internet, the first data being associated with a plurality of policymakers; generate, using a machine trained model, one or more first nodes within an issue graph model based at least in part on the first data, the one or more first nodes representing the plurality of policymakers; generate, using the machine trained model, a second node within the issue graph model representing an organization; receive, via a user interface, a selection of at least one agenda issue of interest to the organization; access second data scraped from the Internet, the second data comprising data associated with the organization; generate links within the issue graph model representing relationships between the one or more first nodes and the second node, the relationships being identified based at least in part on the first data, the second data, and the selected agenda issue; determine an organizational influence factor, the organizational influence factor comprising a measure of how likely the second node is to affect a property of each of the plurality of first nodes, where the property includes a position of each of the plurality of policymakers on the at least one selected agenda issue, the position comprising at least one of a stance or political position of a policymaker on the at least one selected agenda issue and not an indicator of an outcome of a particular policymaking; identify at least one node of the plurality of first nodes associated with the at least one selected agenda issue based on the organizational influence factor; and output node properties associated with the identified at least one node.

In another embodiment, a computer-implemented method for analyzing organizational influence data may include accessing first data scraped from the Internet, the first data being associated with a plurality of policymakers; generating, using the machine trained model, one or more first nodes within an issue graph model based at least in part on the first data, the one or more first nodes representing the plurality of policymakers; generating, using the machine trained model, a second node within the issue graph model representing an organization; receiving, via a user interface, a selection of at least one agenda issue of interest to the organization; accessing second data scraped from the Internet, the second data comprising data associated with the organization; generating links within the issue graph model representing relationships between the first nodes and the second node, the relationships being identified based at least in part on the first data, the second data, and the selected agenda issue; determining an organizational influence factor, the organizational influence factor comprising a measure of how likely the second node is to affect a property of each of the plurality of first nodes, where the property includes a position of each of the plurality of policymakers on the at least one selected agenda issue, the position comprising at least one of a stance or political position of a policymaker on the at least one selected agenda issue and not an indicator of an outcome of a particular policymaking; identifying at least one node of the plurality of first nodes associated with the at least one selected agenda issue based on the organizational influence factor; and outputting node properties associated with the identified at least one node.

Consistent with other disclosed embodiments, non-transitory computer-readable storage media may store program instructions, which are executed by at least one processor and perform any of the methods described herein.

### BRIEF DESCRIPTION OF THE DRAWINGS

The accompanying drawings, which are incorporated in and constitute a part of this disclosure, illustrate various disclosed embodiments. In the drawings:

FIG. 1 is a depiction of an example of a system consistent with one or more disclosed embodiments of the present disclosure.

FIG. 2 is a depiction of an example of a server rack for use in the system of FIG. 1.

FIG. 3 is a depiction of an example of a device for use by the user(s) of the system of FIG. 1.

FIG. 4A is a depiction of another example of a device for use by the user(s) of the system of FIG. 1.

FIG. 4B is a side-view of the device of FIG. 4A.

FIG. 5 is a depiction of an example of a system for predicting an outcome of a future event.

FIG. 6 is a flowchart of an example of a method for predicting an outcome of a future event.

FIG. 7 is a depiction of the system of FIG. 5 and a first and second organization.

FIG. 8 is a flowchart of an example of a method of incorporating interconnected data between policymakers into the method of FIG. 6.

FIG. 9 is a depiction of example inputs into the systems of FIGS. 5 and 7.

FIG. 10 is a diagrammatic illustration of an example of a memory storing modules and data for altering predictive outcomes of dynamic processes.

FIG. 11 is a diagrammatic illustration of an example of a graphical user interface used for user collaboration and feedback.

FIG. 12 is a diagrammatic illustration of an example of a memory storing modules and data for performing internet-based agenda data analysis.

FIG. 13A is diagrammatic illustration of an example of a graphical user interface used for presenting a list of user-selectable agenda issues for performing internet-based agenda data analysis.

FIG. 13B is diagrammatic illustration of an example of a graphical user interface used for presenting a dashboard of alignment of bills with users.

FIG. 13C is diagrammatic illustration of an example of a graphical user interface used for presenting a dashboard where sector weights may be adjusted to provide a weighted score for each legislator.

FIG. 13D is a diagrammatic illustration of an example of a graphical user interface used for presenting a graphical display that includes alignment coordinates displayed in graphical form.

FIG. 14A is a flow chart illustrating an example of a process performed by the system in FIG. 1.

FIG. 14B is a flow chart illustrating an additional example of a process performed by the exemplary system in FIG. 1.

FIG. 15 illustrates an example of a memory containing software modules.

FIG. 16A illustrates an example of a virtual whipboard.

FIG. 16B illustrates an example of a communication that may be generated via use of the virtual whipboard of FIG. 16A.

FIG. 17 is a flow chart illustrating an example of a method for using a virtual whipboard in conjunction with a communication system.

FIG. 18 illustrates an example of a memory associated with a text analytics system.

FIG. 19 illustrates an example of text analytics consistent with one or more disclosed embodiments of the present disclosure.

FIG. 20 illustrates an example of a multi-sectioned document with correlated comments.

FIG. 21 illustrates another example of a multi-sectioned document with correlated comments.

FIG. 22 illustrates a flow chart of an example of a method for ascertaining sentiment about a multi-sectioned document associating the sentiment with particular sections.

FIG. 23 illustrates an example of a memory associated with a text analytics system.

FIG. 24 illustrates an example of a text analytics system consistent with one or more disclosed embodiments of the present disclosure.

FIG. 25 illustrates an example of a prediction with an indicator of an outcome.

FIG. 26 illustrates s a flow chart of an example of a method for predicting regulation adoption.

FIG. 27 illustrates an example issue graph representing knowledge about relationships between a person and a document.

FIG. 28 illustrates an example issue graph representing knowledge about relationships between a person and multiple documents.

FIG. 29 illustrates an example issue graph representing knowledge about relationships between documents.

FIG. 30 illustrates an example issue graph representing knowledge about relationships between documents.

FIG. 31 illustrates an example issue graph representing knowledge about relationships between documents.

FIG. 32 illustrates an example issue graph representing knowledge about relationships between documents.

FIG. 33 illustrates an example issue graph representing knowledge about relationships between documents.

FIG. 34A illustrates an example issue graph representing knowledge about relationships between documents.

FIG. 34B illustrates an example issue graph representing knowledge about relationships between documents.

FIG. 35 illustrates an example issue graph representing knowledge about a document.

FIG. 36 illustrates an example issue graph representing knowledge about relationships between documents.

FIG. 37 illustrates an example issue graph representing knowledge about relationships between a document, a person, and an organization.

FIG. 38 illustrates an example issue graph representing knowledge about relationships between multiple persons and multiple documents.

FIG. 39 illustrates an example issue graph representing knowledge about relationships between multiple persons and an organization.

FIG. 40 illustrates an example issue graph representing knowledge about relationships between organizations and a document.

FIG. 41 illustrates an example issue graph representing knowledge about a set of documents.

FIG. 42 illustrates an example issue graph representing knowledge about relationships between organizations and documents.

FIG. 43 illustrates an example issue graph representing knowledge about relationships between an organization and documents.

FIG. 44 illustrates an example issue graph representing knowledge about relationships between an organization and documents.

FIG. 45 illustrates an example issue graph representing knowledge about relationships between multiple persons and multiple documents.

FIG. 46 illustrates an example issue graph representing knowledge about relationships between multiple persons and multiple documents.

FIG. 47 illustrates an example issue graph representing knowledge about relationships between persons, documents, and an organization.

FIG. 48A illustrates a first portion of an example issue graph.

FIG. 48B illustrates a second portion of an example issue graph.

FIG. 48C illustrates a third portion of an example issue graph.

FIG. 48D illustrates an example issue graph representing knowledge about relationships between documents.

FIG. 48E illustrates an example issue graph representing knowledge about relationships between documents.

FIG. 49 is diagrammatic illustration of an example of a graphical user interface used for presenting an interface for a user to enter proprietary stakeholder data.

FIG. 50 is diagrammatic illustration of an example of a graphical user interface used for presenting an interface for a user to adjust metrics.

FIG. 51 is diagrammatic illustration of an example of a graphical user interface used for presenting an issue graph of a particular agenda issue selected as being of interest to an organization.

FIG. 52 is diagrammatic illustration of an example of a graphical user interface used for presenting an issue graph of a particular agenda issue selected as being of interest to an organization.

FIG. 53 is diagrammatic illustration of an example of a graphical user interface used for presenting an issue graph of a particular agenda issue selected as being of interest to an organization.

FIG. 54 is diagrammatic illustration of an example of a graphical user interface used for presenting a list of suggested stakeholders.

FIG. 55 illustrates a flow chart of an example of a method for agenda data analysis.

FIG. 56 is a diagrammatic illustration of an example of a memory storing modules and data for performing internet-based agenda data analysis.

FIG. 57 illustrates a flow chart of an example of a method for assessing an influence of an organization, consistent with the disclosed embodiments.

FIG. 58A illustrates an example user interface displaying a company profile, consistent with the disclosed embodiments.

FIG. 58B illustrates another example user interface displaying a company profile, consistent with the disclosed embodiments.

FIG. 58C illustrates an example policy index user interface consistent with the disclosed embodiments.

FIG. 58D illustrates an example user interface showing industry trends associated with an organization, consistent with the disclosed embodiments.

FIG. 58E illustrates an example geographic user interface showing policies relevant to an organization by location, consistent with the disclosed embodiments.

FIG. 58F illustrates an example stakeholder network user interface, consistent with the disclosed embodiments.

FIG. 58G illustrates an example user interface summarizing key stakeholders in an organization's network, consistent with the disclosed embodiments.

FIG. 58H illustrates an example user interface indicating a number of mentions of a company in the media, consistent with the disclosed embodiments.

FIG. 58I illustrates another example company profile user interface, consistent with the disclosed embodiments.

FIG. 59 illustrates a flow chart of an example of a method for identifying stakeholders relative to an issue, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The disclosed embodiments relate to systems and methods for generating and analyzing policy, policymaker, and organizational entities and their relationships through the construction of issue-based knowledge graphs. For example, this may include accessing electronic structured and unstructured data related to legislative, regulatory, and judicial processes, and automatically analyzing the data to generate one or more issue graphs within a policy intelligence platform. These issue graphs may include representations of various entities and their relationships that are automatically identified and extracted from the electronic data. Embodiments of the present disclosure may be implemented using a general-purpose computer. Alternatively, a special-purpose computer may be built using suitable logic elements.

The disclosed techniques for generating and analyzing policymaker and organizational issue graphs overcome several technological problems relating to operability, efficiency, and functionality in the fields of technology-enabled policy analysis. In particular, embodiments of the present disclosure may provide greater insights into relationships between various entities through a more complex analysis of a greater variety of data types. For example, many existing techniques either deal with structured or unstructured data and are unable to effectively extract structured data from unstructured data or perform a combined analysis of different data types. Further, many existing solutions obtain data from a limited number of data sources and require a significant amount of manual interaction to create and update information. The disclosed techniques overcome these and other deficiencies with current software-based techniques. For example, the disclosed techniques may gather data from various sources, including structured and unstructured data, which may be scraped from internet sources or otherwise collected from publicly available sources. In some embodiments, the disclosed technique may also access private data, such as proprietary data that may be collected from a user or organization. This collected data may be analyzed to generate one or more issue graph models, which may represent an interconnectedness between policymakers, organizations, stakeholders, or other entities associated with a policy or issue. These issue graphs may then be analyzed to gather valuable insights into the influence various entities may have in relation to a policy or issue. These issue graphs may be dynamically updated as additional data is collected or as relationships change over time.

Policymaking generally results in the production of large numbers of documents. These documents may be produced among various governmental levels. One governmental level may comprise, for example, international governmental bodies (e.g., the European Council, the United Nations, the World Trade Organization, etc.). A second governmental level may comprise, for example, federal governmental bodies (e.g., the United States, China, the United Kingdom, etc.). A third governmental level may comprise, for example, state governmental bodies (e.g., New York, British Columbia, etc.). A fourth governmental level may comprise, for example, county governmental bodies (e.g., San Bernardino County, Essex County, Abhar County, etc.). A fifth governmental level may comprise, for example, local governmental bodies (e.g., Chicago, Hidaj, Cambridge, etc.). Other governmental levels between those listed are possible (e.g., Chinese prefectures may exist between the county level and the state (or province) level). Accordingly, as is evident, a wide range of governmental levels exist and may produce a vast array of policymaking documents.

Policymaking documents produced at a given level of government may be produced across a plurality of jurisdictions. For example, at the federal level, documents may be produced by the United States, Belgium, etc. Policymaking documents produced at a given level of a given jurisdiction may be produced across a plurality of governmental units. For example, within the United States, the U.S. Congress may comprise a governmental unit, the U.S. Court of Appeals for the Federal Circuit may comprise another governmental unit, etc. In addition, some governmental units may comprise a plurality of subunits; for example, the U.S. House may comprise a subunit of the U.S. Congress, the Bureau of Labor Statistics may comprise a subunit of the U.S. Department of Labor. Some subunits may further comprise a plurality of sub-subunits. As used herein, a “governmental unit” may refer to a unit, subunit, sub-subunit, etc.

In general, governmental units may be grouped into three categories. Legislatures comprise governmental units that produce laws (or legislation), e.g., the U.S. Congress, the UK Parliament, etc. Legislatures usually sit for preset periods of time called “sessions.” Any particular piece of legislation may be termed a “legislative bill.” Generally, a number of documents are produced that relate to bills (e.g., one or more committee reports, transcripts of one or more floor proceedings and/or debates, etc.). These documents may be “legislative documents” and a group of these documents that relate to a single bill may be termed a “legislative history.”

Commissions or regulatory agencies comprise governmental units that produce regulations and/or enforcement actions (e.g., the Federal Trade Commission, the Federal Institute for Drugs and Medical Devices, etc.). Regulatory rules comprise rules and/or guidelines that may have the force of law and may implement one or more pieces of legislation. A collection of documents related to a particular rule or guideline may comprise a “regulatory history.” In addition, commissions/agencies may further comprise one or more panels and/or administrative judges that rule on enforcement actions (e.g., actions to enforce antitrust laws, actions to enforce privacy laws, etc.).

Courts comprise governmental units that resolve disputes between parties (e.g., the U.S. District Court for Wyoming, the Akita District Court, etc.). Resolution of these dispute, or “court cases,” usually result in one or more written or oral “court decisions.” Decisions may include intermittent decisions (e.g., decisions on motions to exclude evidence, minute orders, motions to remittitur, etc.), as well as final decisions on the merits.

As used herein, the term “policymaker” may refer to any person within a governmental unit involved with producing policymaking documents. Thus, the term “policymaker” may include persons having a vote on a particular policy (e.g., a member of a congress or parliament, a member of a regulatory commission or agency, a judge sitting on a panel, etc.). A record of all previous votes that a policymaker has cast may be termed a “voting history.”

The term “policymaker” may also include persons with power to take unilateral action (e.g., an attorney general, a president or prime minister, etc.). Furthermore, the term “policymaker” may also include persons who support other policymakers yet do not possess a vote or any unilateral authority (e.g., staffers, assistants, consultants, lobbyists, etc.).

The volume of documents produced during policymaking may be overwhelming to track and manage even through the use of automated approaches. For example, using existing computer-based systems, identification of entities and analysis of relationships between the entities to form contextually relevant insights may impose a heavy time and financial cost. Moreover, existing software tools and algorithms may be limited to one source database, such as level of government and/or one governmental unit, and may fail to account for a sufficient amount of different types of entities and types of relationships between entities in aggregated information. Systems and methods of the present disclosure may alleviate one or more of these technical problems by aggregating and comingling data from multiple source databases, and computing different kinds of entities and relationships.

For example, systems and methods of the present disclosure may aggregate documents produced during and/or related to policymaking. In some embodiments, the disclosed systems and methods may convert each aggregated document to one or more forms appropriate for machine analysis to construct machine-trained models. For example, each document may be represented as an N-dimensional vector with numerical coordinates derived from the content and context of the document, such as one or more words, phrases, sentence, paragraphs, pages, topics, metadata and/or combinations thereof. In some embodiments, a document vector may represent a superposition of features associated with the document. As used herein, a “feature” may refer to a term of interest or other linguistic pattern derived from the text of or a subset of the text of the document. In addition, the term “feature” may also refer to one or more pieces of metadata either appended to or derived from the document. Further, the term “feature” may also refer to one or more pieces of data derived from at least one linguistic pattern, e.g., a part-of-speech identification, syntactic parsing, mood/sentiment analysis, tone analysis, or the like. The term “feature” is also not limited to a single document but may represent one or more relationships between documents.

In some embodiments, a numerical value or weight may be computed and associated with each feature and may form the basis for the subsequent superposition. For example, if a feature comprises whether a given term appears in the document, the value may comprise +1 if the term appears and may comprise 0 if the term does not appear. By way of further example, the value of the feature may be weighted according to its rate of occurrence in the document (e.g., the value is greater if the term occurs more often), weighted according to its rate of occurrence across a plurality of documents (e.g., the value is greater if the term is more unique to the document), or the like.

In some embodiments, other techniques may be used in lieu of or in addition to the vector analysis described above. For example, features may be assigned a multi-dimensional vector rather than a real value. Word embedding using neural networks or performing dimensionality reductions are two examples of additional techniques that may be used to convert documents into feature vector formats appropriate for machine analysis to construct machine-trained models.

In some embodiments, the machine analysis may include construction of machine-trained models. As used herein, a “model” may refer to any mathematical transformation, function, or operator that represents an association between an input feature vector(s) and an output assignment, prediction and/or likelihood. Further, a model may take into account one or more parameters. In some embodiments, a feature, as discussed above may constitute a parameter. An assignment may refer to a finite set of labels or ranks produced by the model for an input item. For example, an assignment may include a topic of a document, or strength of relationship between entities. In the context of a future event, a “prediction” may refer to any one of a finite set of outcomes of that event. For example, in an election having three candidates, there may be three possible outcomes: the first candidate is elected, the second candidate is elected, or the third candidate is elected. By way of further example, if a policymaker is casting a vote, there may be at least two possible outcomes: the policymaker votes yes (e.g., “yea”), or the policymaker votes no (e.g., “nay”). Further, in the context of a prediction, a “likelihood” may refer to a probability that the prediction will be fulfilled.

As used herein, the term “outcome” may refer to any possible future event with respect to one or more policies. For example, with respect to legislation, outcomes may include whether or not a particular bill will be introduced, to which committees it will be assigned, whether or not it will be recommended out of committee, whether or not it will be put to a floor vote, what the final tally of the floor vote will be, and the like. Similarly, with respect to regulatory rules, outcomes may include whether or not a particular rule will be promulgated, which persons or companies will submit comments thereon, whether the rule will be amended in response to one or more comments, and the like. With respect to court cases, outcomes may include whether or not a motion will be granted, granted in part, or denied, whether or not a party will be sanctioned, how much in damages a judge or jury will award, and the like. In some embodiments, the term “outcome” may include a likelihood. In the context of legislative outcomes, it may refer to the likelihood that legislation is introduced, assigned to certain legislative committees, recommended out of a certain legislative committee, taken up for consideration on a legislative floor, passes a floor vote, or is ultimately passed and enacted. Aspects of the disclosure in their broadest sense, are also not limited to any type of predictive outcome. For example, a set of possible outcomes may include various stages of legislative, regulatory, administrative, judicial, and other related proceedings or processes are contemplated.

Furthermore, an “outcome” may include the date associated with the future event (e.g., on what date the vote is taken, on what date a rule will be published in the Federal Register, on what date a hearing concerning one or motions is held, etc.). The term “outcome” may further include one or more effects that a policy has on existing policies. For example, an “outcome” may include one or more statutes that will be amended by a pending bill, one or more regulations that will be amended by a pending regulatory rule, one or more judicial precedents that will be affected by a pending judicial decision, etc.

The term “outcome” may also refer to an impact that a policy has on one or more geographic areas, one or more sectors of an economy (e.g., manufacturing or retail), one or more industries within an economy (e.g., health care industry or services industry), or one or more companies (e.g., a non-profit, a public corporation, a private business, or a trade association). As used herein, an “impact” may refer to an assessment of the qualitative (e.g., favorable or unfavorable) or quantitative (e.g., 9/10 unfavorable, $1 billion additional costs) effects of a policy. Further, in some embodiments, an outcome may contain a subset of outcomes, and a group of outcomes may include intermediate outcomes.

In some embodiments, the model may also learn one or more scores reflecting the weight or strength of correlation that one or more input features may have on the outcome prediction and/or likelihood. In certain aspects, the scores may be integrated with the model. In other aspects, the scores may be computed based on the model (e.g., by raw tallying of outcomes based on a plurality of input features, by tallying of outcomes subject to a threshold, etc.).

As used herein, a “model” is not limited to a function or operator with one set of inputs and one set of outputs. A “model” may have intermediate operations in which, for example, a first operation produces one or more outputs that comprise one or more features that are then operated on by a second operation that produces one or more outputs therefrom. For example, a first operation may accept a full set of features as input and output a subset of the features that meet a threshold for statistical significant; a second operation may then accept the subset of features as input and output additional derived features; a third operation may then accept the subset of features and/or the derived features as input and output one or more predictions and/or likelihoods.

In some embodiments, the disclosed systems and methods may generate a model, at least in part, based on one or more partitions of feature vectors from a collection of documents according to one or more similarity measures. The collection of documents may include, at least in part, one or more documents comprising a training set. As used herein, a “training set” may refer to documents created for the purpose of constructing a machine-trained model or may refer to documents created during or related to policymaking that have been manually analyzed.

Thus, the disclosed systems and methods may generate a machine-trained model using machine learning. Further, consistent with disclosed embodiments, a machine-trained model may be constructed using machine learning algorithms comprising logistic regression, support vector machines, Naïve Bayes, neural networks, decision trees, random forest, any combination thereof, or the like. Further, a model may be modified and/or updated using machine learning such that the model is modified during subsequent uses of the model.

In some embodiments, a plurality of models may be developed and applied to one or more documents. For example, a plurality of predictions and/or likelihoods may be output by the plurality of models. In certain aspects, a subsequent model may accept the plurality of predictions and/or likelihoods as input and output a single prediction and/or likelihood representing a combination and/or normalization of the input predictions and/or likelihoods.

The aforementioned techniques for aggregation and modeling may be used with one or more of the systems discussed below and/or with one or more of the methods discussed below.

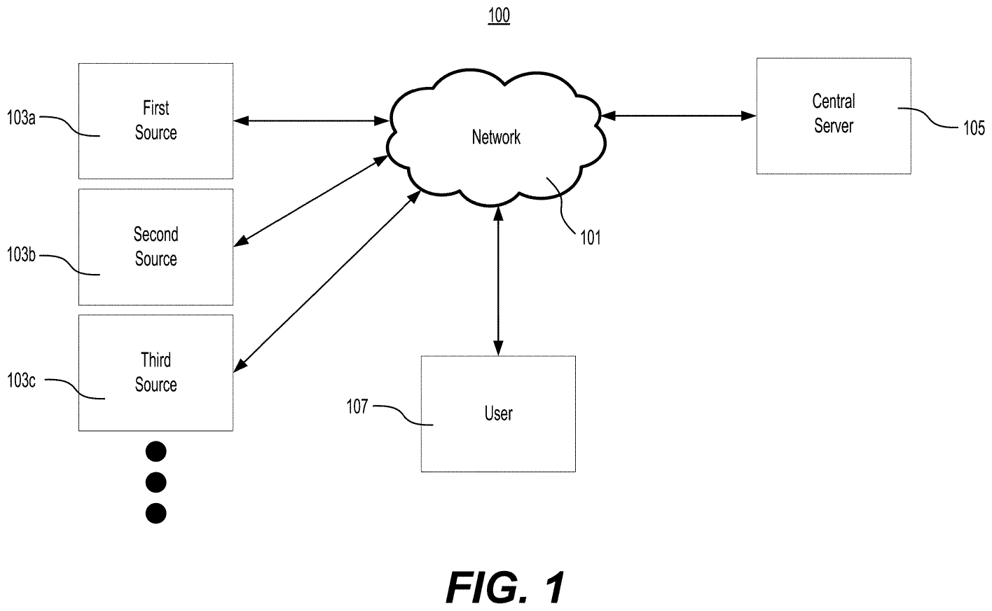

FIG. 1 is a depiction of a system 100 consistent with the embodiments disclosed herein. As depicted in FIG. 1, system 100 may comprise a network 101, a plurality of sources, e.g., source 103a, 103b, and 103c, a central server 105, and user(s) 107. One skilled in the art could vary the structure and/or components of system 100. For example, system 100 may include additional servers—for example, central server 105 may comprise multiple servers and/or one or more sources may be stored on a server. By way of further example, one or more sources may be distributed over a plurality or servers, and/or one or more sources may be stored on the same server.

Network 101 may be any type of network that provides communication(s) and/or facilitates the exchange of information between two or more nodes/terminals. For example, network 101 may comprise the Internet, a Local Area Network (LAN), or other suitable telecommunications network. In some embodiments, one or more nodes of system 100 may communication with one or more additional nodes via a dedicated communications medium.

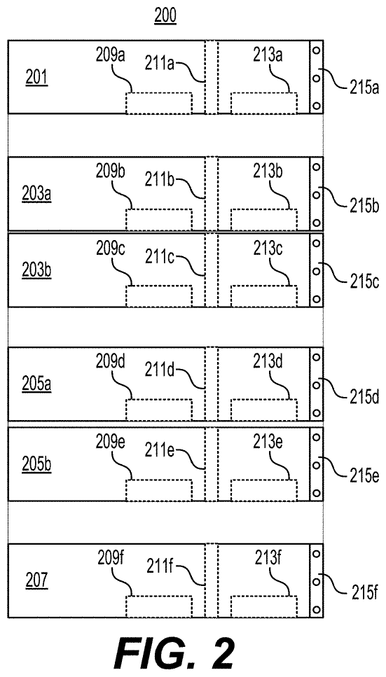

Central server 105 may comprise a single server or a plurality of servers. In some embodiments, the plurality of servers may be connected to form one or more server racks, e.g., as depicted in FIG. 2. In some embodiments, central server 105 may store instructions to perform one or more operations of the disclosed embodiments in one or more memory devices. Central server 105 may further comprise one or more processors (e.g., CPUs, GPUs) for performing stored instructions. In some embodiments, central server 105 may send information to and/or receive information from user(s) 107 through network 101.

In some embodiments, sources 103a, 103b, and 103c may comprise one or more databases. As used herein, a “database” may refer to a tangible storage device, e.g., a hard disk, used as a database, or to an intangible storage unit, e.g., an electronic database. For example, a local database may store information related to particular locale. A locale may comprise an area delineated by natural barriers (e.g., Long Island), an area delineated by artificial barriers (e.g., Paris), or an area delineated by a combination thereof (e.g., the United Kingdom). Thus, the website of any governmental body may comprise a local database.

In other embodiments, sources 103a, 103b, and 103c may comprise one or more news databases (e.g., the website of The New York Times or the Associated Press (AP) RSS feed. As used herein, the term “news” is not limited to information from traditional media companies but may include information from blogs (e.g., The Guardian's Blog), websites (e.g., a senator's campaign website and/or institutional website), or the like.

In still other embodiments, sources 103a, 103b, and 103c may comprise other databases. For example, sources 103a, 103b, and 103c may comprise databases of addresses, phone numbers, and other contact information. By way of further example, sources 103a, 103b, and 103c may comprise databases of social media activity (e.g., Facebook or Twitter). By way of further example, sources 103a, 103b, and 103c may comprise online encyclopedias or wikis.

Further, system 100 may include a plurality of different sources, e.g., source 103a may comprise a local database, source 103b may comprise a news database, and source 103c may comprise one of the other databases. In some embodiments, one or more sources may be updated on a rolling basis (e.g., an RSS feed may be updated whenever its creator updates the feed's source) or on a periodic basis (e.g., the website of a town newspaper may be updated once per day). In certain aspects, one or more sources may be operably connected together (e.g., sources 103b and 103c) and/or one or more sources may be operably independent (like source 103a).

In some embodiments, central server 105 may receive information from one or more of the plurality of sources, e.g., sources 103a, 103b, and 103c. For example, central server 105 may use one or more known data aggregation techniques in order to retrieve information from sources 103a, 103b, and 103c.

In some embodiments, network 101 may comprise, at least in part, the Internet, and central server 105 may perform scraping to receive information from the plurality of sources. As used herein, “scraping” or “scraping the Internet” may include any manner of data aggregation, by machine or manual effort, including but not limited to crawling across websites, identifying links and changes to websites, data transfer through API's, FTP's, GUI, direct database connections through, e.g. using SQL, parsing and extraction of website pages, or any other suitable form of data acquisition. In certain aspects, central server 105 may execute one or more applications configured to function as web scrapers. A web scraper may comprise a web crawler and an extraction bot. A web crawler may be configured to find, index, and/or fetch web pages and documents. An extraction bot may be configured to copy the crawled data to central server 105 or may be configured to process the crawled data and copy the processed data to central server 105. For example, the bot may parse, search, reformat, etc., the crawled data before copying it.

Information scraped from the plurality of sources may comprise web pages (e.g., HTML documents) as well as other document types (e.g., pdf, txt, rtf, doc, docx, ppt, pptx, opt, png, tiff, png, jpeg, etc.). The web scraper may be configured to modify one or more types of scraped data (e.g., HTML) to one or more other types of scraped data (e.g., txt) before copying it to central server 105.

The web scraper may run continuously, near continuously, periodically at scheduled collection intervals (e.g., every hour, every two hours, etc.), or on-demand based on a request (e.g., user 107 may send a request to central server 105 that initiates a scraping session). In some embodiments, the web scraper may run at different intervals for different sources. For example, the web scraper may run every hour for source 103a and run every two hours for source 103b. This may allow the web scraper to account for varying excess traffic limits and/or to account for varying bandwidth limits that may result in suboptimal performance or crashes of a source.

In some embodiments, manual operators may supplement the processes performed by the web scraper. For example, a manual operator may assist with indexing one or more web pages that employ anti-crawling technology. By way of further example, a manual operator may assist with parsing data that the extraction bot cannot interpret.

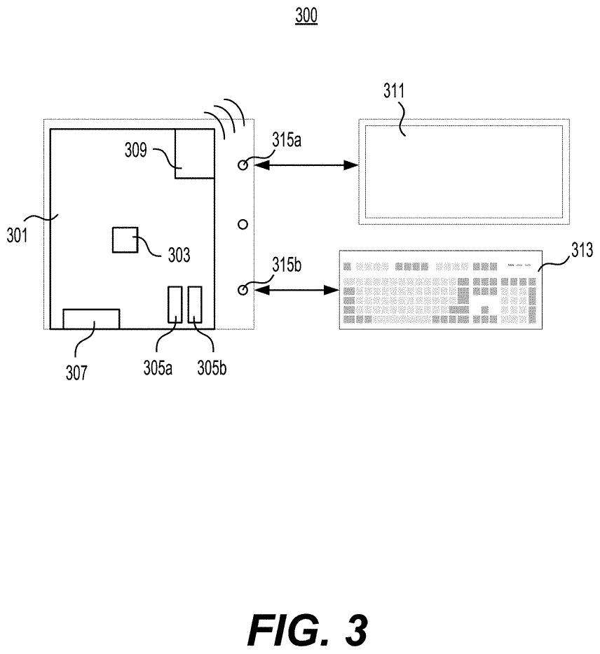

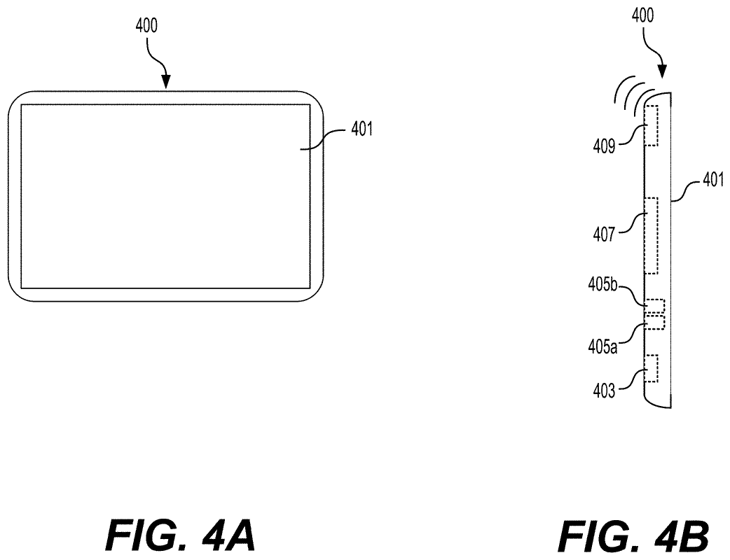

User(s) 107 may connect to network 101 by using one or more devices with an operable connection to network 101. For example, user(s) 107 may connect to network 101 using one or more devices of FIG. 3 or 4 (described below). In some embodiments, user(s) 107 may send information to and receive information from central server 105 though network 101.

In some embodiments, user 107 may send proprietary information to central server 105 via network 101. As used herein, proprietary information may include any information with limited or restricted accessibility. For example, proprietary information may comprise information privy to user 107 like the results of a private meeting between user 107 and one or more persons, or non-public organizational actions. By way of further example, proprietary information may comprise information obtained by user 107 from a subscription news service or other service requiring payment in exchange for information. By way of further example, proprietary information may comprise information generated by the user, such as through their own efforts or by a collective group of, e.g., an organization. Accordingly, proprietary information may be described as information determined through “proprietary research.” Moreover, in some embodiments, proprietary information may be considered to be non-scraped (e.g. uploaded by the user through communication device to the system), and in other embodiments, proprietary information may be scraped from a resource (e.g., collected from a central server). Accordingly, the proprietary information may be collected periodically by connecting to proprietary user database and collecting data, or collected through other automated methods.

FIG. 2 is a depiction of a server rack 200 for use in system 100 of FIG. 1. As depicted in FIG. 2, server rack 200 may comprise a management/control server 201, one or more compute servers, e.g., servers 203a and 203b, one or more storage servers, e.g., servers 205a and 205b, and spare server 207. The number and arrangement of the servers shown in FIG. 2 is an example, and one of skill in the art will recognize any appropriate number and arrangement is consistent with the disclosed embodiments.

In some embodiments, one or more servers of server rack 200 may comprise one or more memories. For example, as depicted in FIG. 2, management/control server 201 comprises memory 209a, compute server 203a comprises memory 209b, compute server 203b comprises memory 209c, storage server 205a comprises memory 209d, storage server 205b comprises memory 209e, and spare server 207 comprises memory 209f. A memory may comprise a traditional RAM, e.g., SRAM or DRAM, or other suitable computer data storage. The one or more memories may store instructions to perform one or more operations of the disclosed embodiments. In addition, the one or more memories may store information scraped from the Internet.

In some embodiments, one or more servers of server rack 200 may further comprise one or more processors. For example, as depicted in FIG. 2, management/control server 201 comprises processor 211a, compute server 203a comprises processor 211b, compute server 203b comprises processor 211c, storage server 205a comprises processor 211d, storage server 205b comprises processor 211e, and spare server 207 comprises processor 211f. A processor may comprise a traditional CPU, e.g., an Intel®, AMD®, or Sun® CPU, a traditional GPU, e.g., an NVIDIA® or ATI® GPU, or other suitable processing device. In some embodiments, the one or more processors may be operably connected to the one or more memories. Further, in some embodiments, a particular server may include more than one processor (e.g., two processors, three processors, etc.).

In some embodiments, one or more servers of server rack 200 may further comprise one or more non-volatile memories. For example, as depicted in FIG. 2, management/control server 201 comprises non-volatile memory 213a, compute server 203a comprises non-volatile memory 213b, compute server 203b comprises non-volatile memory 213c, storage server 205a comprises non-volatile memory 213d, storage server 205b comprises non-volatile memory 213e, and spare server 207 comprises non-volatile memory 213f. A non-volatile memory may comprise a traditional disk drive, e.g., a hard disk drive or DVD drive, an NVRAM, e.g., flash memory, or other suitable non-volatile computer data storage. The one or more non-volatile memories may store instructions to perform one or more operations of the disclosed embodiments. In addition, the one or more non-volatile memories may store information scraped from the Internet.

In some embodiments, one or more servers of server rack 200 may further comprise one or more network interfaces. For example, as depicted in FIG. 2, management/control server 201 comprises network interface 215a, compute server 203a comprises network interface 215b, compute server 203b comprises network interface 215c, storage server 205a comprises network interface 215d, storage server 205b comprises network interface 215e, and spare server 207 comprises network interface 215f. A network interface may comprise, for example, an NIC configured to use a known data link layer standard, such as Ethernet, Wi-Fi, Fibre Channel, or Token Ring. In some embodiments, the one or more network interfaces may permit the one or more servers to execute instructions remotely. In addition, the one or more network interfaces may permit the one or more servers to access information from the plurality of sources.

Server rack 200 need not include all components depicted in FIG. 2. Additionally, server rack 200 may include additional components not depicted in FIG. 2 (e.g., a backup server or a landing server).

FIG. 3 is a depiction of an example of a device 300 for use by user(s) 107 of system 100 of FIG. 1. For example, device 300 may comprise a desktop or laptop computer. As depicted in FIG. 3, device 300 may comprise a motherboard 301 having a processor 303, one or more memories (e.g., memories 305a and 305b, a non-volatile memory 307, and a network interface 309). As further depicted in FIG. 3, network interface 309 may comprise a wireless interface (e.g., an NIC configured to utilize Wi-Fi, Bluetooth, 4G, etc.). In other embodiments, network interface 309 may comprise a wired interface (e.g., an NIC configured to use Ethernet, Token Ring, etc.). In some embodiments, network interface 309 may permit device 300 to send information to and receive information from a network.

In some embodiments, device 300 may further comprise one or more display modules (e.g., display 311). For example, display 311 may comprise an LCD screen, an LED screen, or any other screen capable of displaying text and/or graphic content to the user. In some embodiments, display 311 may comprise a touchscreen that uses any suitable sensing technology (e.g., resistive, capacitive, infrared, etc.). In such embodiments, display 311 may function as an input device in addition to an output module.

In some embodiments, device 300 may further comprise one or more user input devices (e.g., keyboard 313 and/or a mouse (not shown)). As further depicted in FIG. 3, the one or more display modules and one or more user input devices may be operably connected to motherboard 301 using hardware ports (e.g., ports 315a and 315b). For example, a hardware port may comprise a PS/2 port, a DVI port, an eSata port, a VGI port, an HDMI port, a USB port, or the like.

Device 300 need not include all components depicted in FIG. 3. Additionally, device 300 may include additional components not depicted in FIG. 3 (e.g., external disc drives, graphics cards, etc.).

FIG. 4A is a depiction of an example of a device 400 for use by user(s) 107 of system 100 of FIG. 1. For example, device 400 may comprise a tablet (e.g., an iPad or Microsoft Surface), or a cell phone (e.g., an iPhone or an Android smartphone). As depicted in FIG. 4A, device 400 may comprise screen 401. For example, screen 401 may comprise an LCD touchscreen, an LED touchscreen, or any other screen capable of receiving input from the user and displaying text and/or graphic content to the user.

FIG. 4B is a side view of example device 400 that depicts example hardware included within device 400. As depicted in FIG. 4B, device 400 may comprise a processor 403, one or more memories (e.g., memories 405a and 405b), a non-volatile memory 407, and a network interface 409. As further depicted in FIG. 4, network interface 409 may comprise a wireless interface, e.g., an NIC configured to use Wi-Fi, Bluetooth, 4G, or the like. In some embodiments, network interface 409 may permit device 400 to send information to and receive information from a network.

Device 400 need not include all components depicted in FIG. 4. Additionally, device 400 may include additional components not depicted in FIG. 4 (e.g., external hardware ports, graphics cards, etc.).

Predicting Future Event Outcomes Based on Data Analysis

In some embodiments, systems and methods consistent with the present disclosure may determine one or more predictions for one or more future events. A prediction may refer to a specific outcome for a future event. An outcome may, for example, be a resolution of a vote or other possible future event with respect to one or more policies.

Systems and methods of the present disclosure may also determine a likelihood for the one or more predictions. A likelihood may refer to a probability that the prediction will be fulfilled. For example, a likelihood may be a probability associated with a particular vote resolution or other possible outcome of a future event with respect to one or more policies.

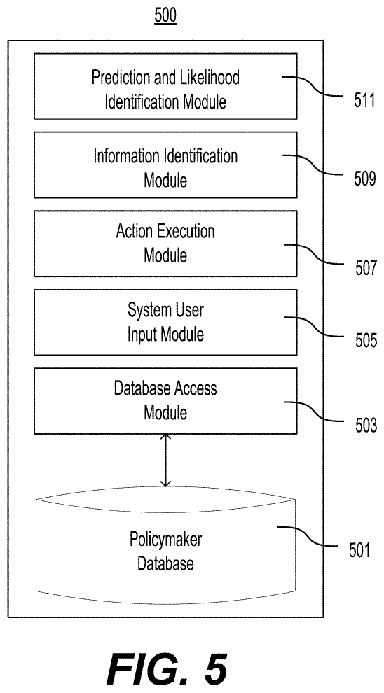

FIG. 5 is a depiction of a memory 500 storing program modules and data for predicting an outcome of a future event. In some embodiments, memory 500 may be included in, for example, central server 105, discussed above. Further, in other embodiments, the components of memory 500 may be distributed over more than one location (e.g., stored in a plurality of servers in communication with, for example, network 101).

As depicted in FIG. 5, memory 500 may include a policymaker database 501. Policymaker database 501 may store information related to policies and policymakers that is aggregated from a plurality of sources and/or parsed via machine analysis. For example, policymaker database 501 may store information related to one or more future events and indexed by policy and/or policymaker.

As further depicted in FIG. 5, memory 500 may include a database access module 503. Database access module 503 may control access to the information stored in database 501. For example, database access module 503 may require one or more credentials from a user or another application in order to receive information from policymaker database 501.

Memory 500 may further include a system user input module 505. System user input module 505 may receive input from one or more users of memory 500. For example, a user may send input to system user input module 505 using one or more networks (e.g., network 100) operably connected to a server (e.g., central server 105) storing system user input module 505.

As depicted in FIG. 5, memory 500 may further include an action execution module 507. Action execution module 507 may manage one or more execution lists executed on one or more processors (not shown) operably connected to memory 500. For example, action execution module 507 may permit for multi-threading in order to increase the efficiency with which one or more execution lists are executed.

Memory 500 may also include an information identification module 509. Information identification module 509 may associate one or more identities with information received from policymaker database 501 using system user input module 505. For example, information identification module 509 may associate an identity of a policymaker with a news story received from database 501 via system user input module 505. By way of further example, information identification module 509 may associate an identity of a policy with a legislative report received from policymaker database 501 via system user input module 505.

As further depicted in FIG. 5, memory 500 may include a prediction and likelihood identification module 511. Prediction and likelihood identification module 511 may generate and/or apply one or more models as discussed above. For example, prediction and likelihood identification module 511 may receive information from policymaker database 501 using system user input module 505 and use the received information as input in one or more models. After applying one or more models, prediction and likelihood identification module 511 may output one or more predictions and/or one or more likelihoods related to a future event.

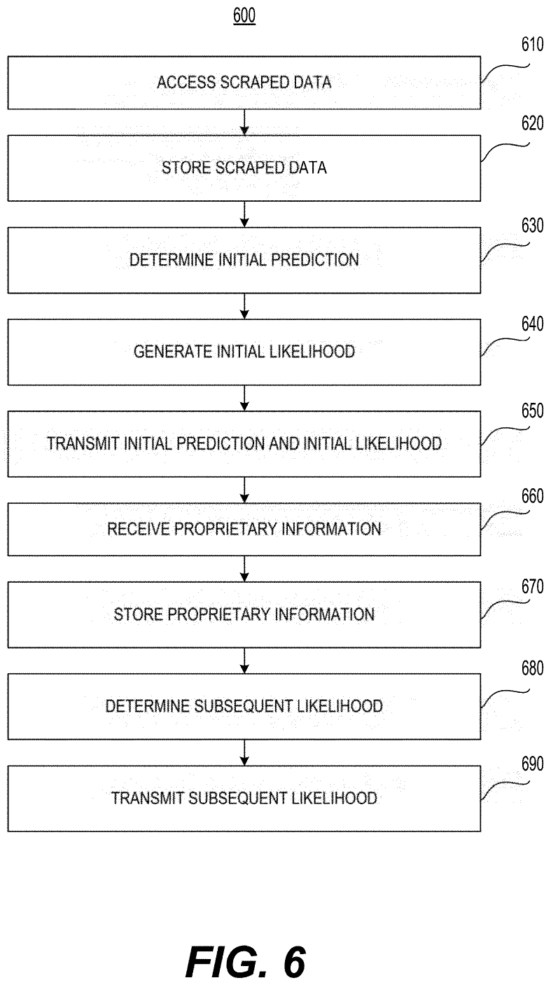

FIG. 6 is a flowchart of exemplary method 600 for predicting an outcome of a future event, consistent with disclosed embodiments. Method 600 may, for example, be executed by one or more processors of a server (e.g., central server 105 of FIG. 1) or any other appropriate hardware and/or software. Further, when executing method 600, the one or more processors may execute instructions stored in one or more of the modules discussed above in connection with FIG. 5.

At step 610, the server may access scraped data. For example, the server may implement one or more techniques for scraping data from the Internet as, described above. In other embodiments, the server may access data from a separate web scraper.

At step 620, the server may store the scraped data. For example, the server may store the scraped data in a database (e.g., policymaker database 501). In some embodiments, the server may parse the data prior to storing it and/or associated one or more identities with the data prior to storing it. For example, the server may remove one or more formatting tags from a scraped HTML documents before storing the document. By way of a further example, the server may associate a scraped document with one or more policymakers and/or one or more policies before storing it.

In some embodiments, the server may receive previously scraped and stored data from one or more databases in lieu of accessing scraped data and storing it.

At step 630, the server may determine an initial prediction regarding a future event based on the scraped data. For example, the server may apply one or more models with some or all of the scraped data as one or more inputs. Instead of using raw scraped data, the server may extract one or more features from the data, as discussed above, to use as inputs for the model.

In some embodiments, the server may identify the future event, at least in part, via a query from a user. For example, the server may receive a query from a user via a data input terminal. The data input terminal may comprise a device associated with the user, e.g., a cell phone, a tablet, or other personal computing device. For example, the user may input the number of a pending legislative bill, and the server may identify the future event as the outcome of a floor vote on that bill. As another example, the user may input the number of an enacted legislative bill, and the server may identify the future event as financial impact on user's organization. Similarly, the user may input the number of a pending regulatory rule, and the server may identify the future event as the enactment or non-enactment of the pending rule. By way of further example, the user may input the number of a pending court case, and the server may identify the future event as which party the jury will find in favor of.

In some embodiments, the server may receive the query before accessing scraped data or before storing the data. For example, the server may determine, at least in part, which scraped data to access based on the query. The server may determine which scraped data to access based on preexisting tags in the data and/or based on a dynamic determination of relevance. For example, if the user query included “healthcare,” the server may determine which scraped data to access based on whether the data was tagged as related to “healthcare.”

By way of a further example, if the future event involves a vote on a legislative bill, the server may access one or more websites of governmental bodies to identify pending legislation related to the query (in this example, “healthcare”). Similarly, if the future event involves adoption of a government regulation, the server may access one or more websites of governmental bodies to identify pending regulations related to the query (in this example, “healthcare”). By way of a further example, if the future event involves a decision in a court case, the server may access one or more websites of governmental bodies to identify pending cases related to the query (in this example, “healthcare”).

At step 640, the server may determine an initial likelihood regarding the initial prediction. For example, if the initial likelihood is that a particular bill is likely to pass a legislature, the server may then determine that the bill has a 62% likelihood of passing. In some embodiments, the server may use the same model(s) that determined the initial prediction to determine the initial likelihood. In other embodiments, the server may use one or more different models, either separately or in combination with the model(s) used to determine the initial prediction, to determine the initial likelihood.

For example, the server may determine the initial likelihood based on one or more voting histories or records of one or more policymakers. In this example, the server may access the voting history of a policymaker (e.g., using policymaker database 501) and then determine the likelihood of that policymaker voting a particular way on a particular policy based on similarities between the policy and other policies included in the voting history. In this example, the server may determine the initial likelihood based on an aggregation of the likelihoods associated with each policymaker.

By way of a further example, the server may determine the initial likelihood based on one or more identified policymakers supporting and opposing a policy and an influence measure associated with each of the identified policymakers. For example, the server may identify one or more members of the National Assembly of South Korea that support and/or oppose a particular policy and then predict how other members will vote based on influence measures associated with the identified member(s). The server may determine the initial likelihood based on an aggregation of the predictions associated with each policymaker. In other embodiments, the server may determine the initial likelihood based on influence from non-policymaker entities. For example, this may be based on an organizational influence factor or stakeholder relevance analysis, as described in further detail below.

In some embodiments, the server may perform steps 630 and 640 simultaneously. For example, the server may use one or more models that generate an initial prediction in conjunction with an initial likelihood.

At step 650, the server may transmit the initial prediction and initial likelihood to one or more devices. For example, the server may transmit the initial prediction and initial likelihood to a device associated with a user, e.g., a cell phone, a tablet, or other personal computing device.

At step 660, the server may receive proprietary information. For example, the server may receive the information from a user via a device associated with the user or from a server over a network (e.g., the Internet). As discussed above, proprietary information may include information privy to the user, such as the results of a private meeting between the user and one or more persons or information obtained by the user from a subscription news service or other service requiring payment in exchange for information. In some embodiments, the proprietary information may constitute non-scraped proprietary information. In other embodiments, the server may automatically receive proprietary information obtained through automated scraping of at least one proprietary data source.

In some embodiments, the server may receive the proprietary information via a data input terminal. For example, as discussed above, the data input terminal may comprise a device associated with the user, e.g., a cell phone, a tablet, or other personal computing device. For example, the user may enter into the data terminal that a specific policymaker will vote a particular way based on a meeting between the user and the policymaker. As another example, the server may receive an electronic communication, such as email, sent to the server by the user, which may contain proprietary information about non-policymakers interested in a policymaking process. The server may parse the electronic communication to associate information with a corresponding policymaking process. In some embodiments, the server may receive proprietary information by scraping a source provided by the user. For example, a user may provide access to proprietary source, e.g. an internal network, a database, and/or an API.

At step 670, the server may store the received proprietary information. For example, the proprietary information may be stored in policymaker database 501 or in a separate database. In some embodiments, the system may use the received proprietary information without storing it.

At step 680, the system may determine a subsequent likelihood based on the scraped information and the proprietary information. For example, a user may input, as proprietary information, information indicating one or more policymakers will vote differently than in the initial prediction. In this example, the system may then determine a subsequent likelihood based on the scraped information that produced that initial likelihood and the new vote(s) of one or more policymakers input by the user.

In some embodiments, the user may provide access to a database of proprietary information such as, for example, financial contributions to one or more policymakers. In this example, the server may then determine a subsequent likelihood based on the scraped information that produced that initial likelihood and the financial contributions to one or more policymakers provided by the user.

By way of a further example, a user may input, as non-scraped proprietary information, information indicating a pending bill will be amended to include new and/or different language. In this example, the server may then determine a subsequent likelihood based on the scraped information that produced that initial likelihood and the new and/or different language input by the user.

In some embodiments, the server may use the same model(s) used to determine the initial likelihood to determine the subsequent likelihood. In other embodiments, the server may use one or more different models, either separately or in combination with the model(s) used to determine the initial likelihood, to determine the subsequent likelihood.

At step 690, the server may transmit the subsequent likelihood to one or more devices. For example, the server may transmit the initial prediction and initial likelihood to a device associated with a user, e.g., a cell phone, a tablet, a smart watch, or other personal computing device. The server may transmit the subsequent likelihood to a device associated with the user that inputted the proprietary information and/or a user different from the user that inputted the proprietary information.

Systems and methods consistent with the present disclosure may calculate initial predictions, initial likelihoods, and subsequent likelihoods for a plurality of users. One or more subsets of the plurality of users may prefer to share some or all predictions, likelihoods, proprietary information, and the like. Other subsets of the plurality of users may prefer to keep private some of all predictions, likelihoods, proprietary information, and the like. Systems and methods consistent with the present disclosure may allow for subsets of users to select and enforce such desired privacy settings.

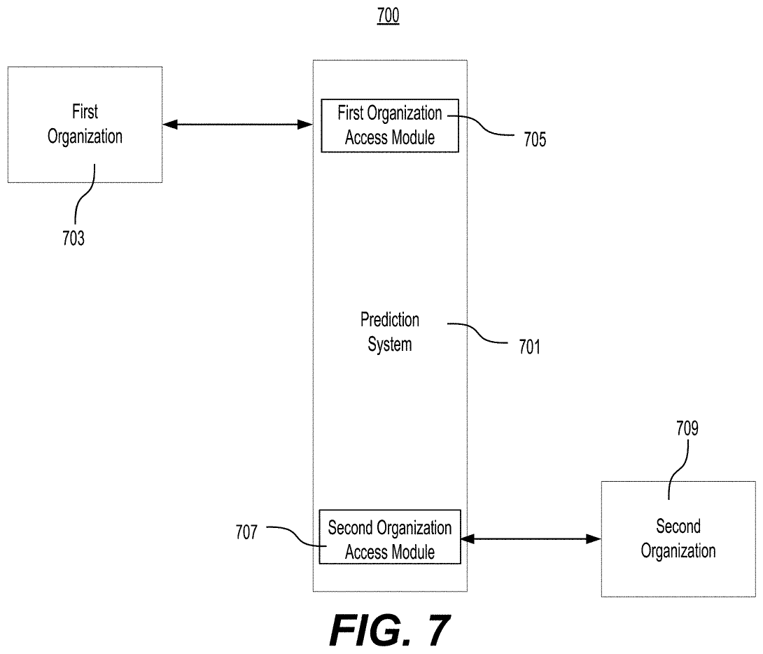

FIG. 7 is a depiction of a system 700 adapted to include a first and second organization. Exemplary system 700 may comprise a variation of central server 105 of FIG. 1. As depicted in FIG. 7, system 700 may include a prediction system 701. Prediction system 701 may include memory 500 of FIG. 5. As depicted in FIG. 5, module 705 and module 709 may be located within a memory of system 700 or may be located on another server. Prediction system 701 may be configured to execute, for example, method 600 of FIG. 6.

As further depicted in FIG. 7, system 700 may include a first organization 703 operably connected to prediction system 701 via a first organization access module 705. First organization 703 may comprise one or more users (e.g., user 107 of FIG. 1), operably connected to first organization access module 705 via one or more devices associated with the user(s). Similarly, system 700 may include a second organization 707 operably connected to prediction system 701 via a second organization access module 709. Second organization 707 may also comprise one or more users (e.g., user 107 of FIG. 1), operably connected to second organization access module 709 via one or more devices associated with the user(s).

As used herein, an “organization” may refer to a legally cognizable organization such as a corporation, one or more official groups internal to a legally cognizable organization such as human resources, or one or more unofficial groups internal to a legally cognizable organization like a project team or working group. The term “organization” may also refer to one or more groups of employees across different legally cognizable organizations or one or more groups of individual persons. As used herein, the term “individual” includes any person, government, corporation, or organization. Accordingly, one or more users of system 700 may self-organize themselves into a first organization or a second organization.

In some embodiments, first organization access module 705 may require authentication from a user that confirms the user is a member of the first organization in order to access prediction system 701. Similarly, in some embodiments, second organization access module 709 may require authentication from a user that confirms the user is a member of the second organization in order to access prediction system 701. For example, first organization access module 705 and second organization access module 709 may receive a password, a fingerprint, or other identifier and compare the received identifier to a stored identifier associated with the first or second organization. In some embodiments, first organization access module 705 and second organization access module 709 may hash the received identifier before comparing the hashed identifier to a stored identifier that is stored in a hashed format.

Further, first organization access module 705 may determine whether users associated with other organizations are permitted to access proprietary information input by users associated with the first organization and/or subsequent likelihoods determined therefrom. Similarly, second organization access module 709 may determine whether users associated with other organizations are permitted to access proprietary information input by users associated with the second organization and/or subsequent likelihoods determined therefrom. For example, if the first organization and the second organization agree to collaborate, first organization access module 705 and second organization access module 709 may allow each organization to access proprietary information input by the other organization. Moreover, first organization access module 705 and second organization access module 709 may allow each organization to access subsequent likelihoods (which may be termed “first organizational updates” and/or “second organizational updates”) determined using the proprietary information input by the other organization.

Accordingly, if predication system 701 or central server 105 or the like determines an initial prediction, an initial likelihood, and a subsequent likelihood based on proprietary information from one or more users associated with the first organization, system 701 may store the initial prediction, initial likelihood, subsequent likelihood, and proprietary information in a manner preventing access by one or more users associated with a second organization. In such an example, the second organization may be referred to as an “unrelated organization.” By way of a further example, system 700 may store the initial prediction, initial likelihood, subsequent likelihood, and proprietary information in a manner preventing access to some of the information (e.g., the subsequent likelihood, the proprietary information) and permitting access to other of the information (e.g., the initial prediction, the initial likelihood) by one or more users associated with a second organization. In a third example, system 700 may store the initial prediction, initial likelihood, subsequent likelihood, and proprietary information in a manner permitting access to the information by one or more users associated with a second organization. Thus, system 700 may allow for customization of sharing settings by a plurality of organizations.

Addition collaborative setups using system 700 are possible. For example, collaborative agreements involving more than two organizations are possible. By way of further example, collaborative agreements involving a subset of proprietary information and/or a subset of subsequent likelihoods are also possible.

As discussed above, systems and methods consistent with the present disclosure may relate to policymaking among various governmental levels (e.g., an international level, a federal level, a state level, a county level, a local level, etc.). To more easily communicate information relating to nested governmental levels, systems and methods consistent with the present disclosure may allow for graphic displays of multiple sub-areas comprising one or more levels of government within a larger area comprising one or more higher levels of government.

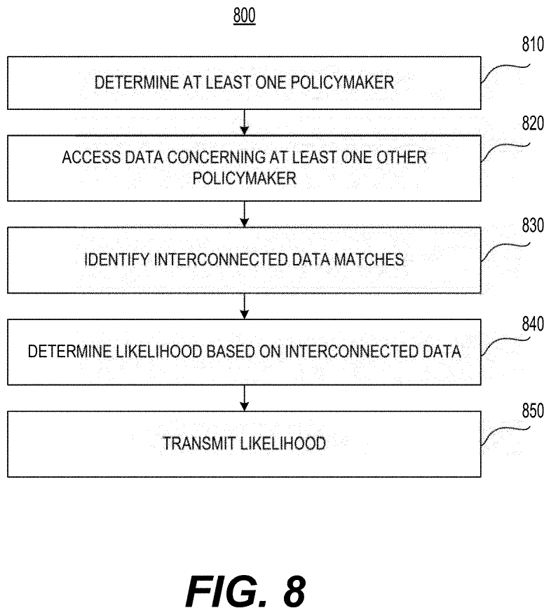

FIG. 8 is a flowchart of a method 800 of incorporating interconnected data between policymakers into method 600 of FIG. 6. Method 800 may, for example, be executed by one or more processors of a server (e.g., central server 105 of FIG. 1) or any other appropriate hardware and/or software. Further, when executing method 800, the one or more processors may execute instructions stored in one or more of the modules discussed above.

With respect to a single policymaker, systems consistent with the present disclosure may perform one or more analyses on the policymaker. For example, a disclosed system may calculate an ideology rating for the policymaker. The system may use a uni-dimensional or multi-dimensional space to map the ideological leanings of the policymaker. For example, with a uni-dimensional space, a policymaker may be scored as more “conservative” or more “liberal”; with a multi-dimensional space, a policymaker may be scored as more “conservative” or more “liberal” on one issue (e.g., healthcare) and scored separately as more “conservative” or more “liberal” on other issues (e.g., immigration).

The ideological ends may vary as appropriate to the political culture in which the policymaker exists (e.g., “tory” versus “labour” rather than “conservative” versus “liberal”) and may include more than two ends as appropriate (e.g., “conservative,” “labour,” and “liberal democrat”). An ideology may also include other belief structures, such as “religious” versus “non-religious,” or a combination of a plurality of belief structures.

An ideological rating may be based on a plurality of factors, e.g., a policymaker's voting history, a policymaker's history of cosponsorship, a policymaker's comments or statement on their website or a news story or the like, financial contributions received by the policymaker, etc. As with modeling, a ranking algorithm may be trained using a training set coupled with machine learning.

In addition to ideology rankings, systems and methods consistent with the present disclosure may generate an interconnectedness model. For example, in such a model, a plurality of policymakers may be represented as a network with each node representing a policymaker. In certain aspects, the edges of the network may be binary—that is, representing a connection or lack thereof. In other aspects, the edges may be weighted, for example, with a higher weight indicating a closer relationship between nodes. Weights may be calculated using a plurality of factors, such as the number of times two policymakers have voted together, sponsored together, received donations from similar organizations, attended the same school or schools, and the like.

In addition to ideology rankings, systems and methods consistent with the present disclosure may generate an effectiveness score for one or more policymakers. For example, an effectiveness score may represent how likely a policy sponsored by that policymaker is likely to pass committee, pass a vote, be enacted, or the like. An effectiveness score may be calculated based on overall activity, based on one or more limited time periods, based on one or more particular policy areas (e.g., healthcare, tax, etc.), or the like.

Similar to effectiveness, systems consistent with the present disclosure may generate a gravitas score for one or more policymakers. For example, a gravitas score may represent how likely that policymaker is to sway or influence other policymakers. A gravitas score may be calculated based on the years the policymaker has served, the ranks the policymaker holds (e.g., in committees or organizations), or the like. A gravitas score may further be calculated based on an interconnectedness network, for example, with a policymaker's gravitas score based on the number of connections and the closeness of those connections within the network.

At step 810 of method 800, the server may determine at least one policymaker. For example, the server may receive the determination from a user via a device associated with the user. In other embodiments, the server may generate the determination using one or more algorithms. For example, the server may determine the at least one policymaker based on which policymakers occupy one or more leadership positions (e.g., speaker, whip, chairperson, chief judge, etc.) within the policymaking body. By way of further example, the server may determine the at least one policymaker based on an effectiveness score, a gravitas score, or the like.

At step 820, the server may access data related to at least one other policymaker. In some embodiments, the server may access the data via scraping or other aggregation techniques. In other embodiments, the server may access the data from stored data in a database. The server may also use a combination of aggregation and stored data to access data related to at least one other policymaker.

For example, the server may access and identify information about a plurality of policymakers slated to vote on a pending bill, or making a determination on a pending rule, action, or case. In addition, the information may include voting records and party affiliation for the policymakers.

At step 830, the server may identify interconnected matches (or “interconnected data matches”) between the at least one policymaker and the at least one other policymaker. For example, as described above, the server may generate an interconnectedness network using the at least one policymaker and the at least one other policymaker.

By way of further example, the server may determine trends in similar voting patterns between the at least one policymaker and the at least one other policymaker. In this example, the system may determine how often the at least one policymaker and the at least one other policymaker voted together on the same policy; based on this frequency, the system may predict whether the at least one policymaker and the at least one other policymaker tend to vote together or not. This prediction may comprise a global prediction or may be limited to one or more types of policy (e.g., bill, joint resolution, and the like) to one or more areas of policy (e.g., taxes, healthcare, and the like), or to other categorizations.

By way of a further example, the server may determine influence indicators that connect policymakers. For example, the server may determine an influence score that quantifies one policymaker's influence over at least one other policymaker. As an example, the server may determine a high influence score for a Chief Justice and thus predict that he or she is likely to influence certain judges to vote in particular ways.

At step 840, the server may determine a likelihood based on the interconnected matches. For example, the server may determine the likelihood of an outcome based on predicted positions of one or more policymakers as adjusted to account for the interconnectedness network.

By way of further example, the server may determine a likelihood based on predicting how each of a plurality of policymakers is likely to vote or make the determination. For example, the server may determine how each policymaker is likely to vote or make the determination based on interconnected match data, e.g., trends in similar voting patterns, influence indicators, and the like. As an example, the system may determine a likelihood of a bill in the UK Parliament being enacted by determining that Prime Minister David Cameron has a strong influence on most members of the Conservative Party and that Leader of the Opposition Ed Miliband has a mild influence on most members of the Labour Party and, based on these determinations, generating likelihoods on how each MP within the Parliament is likely to vote or make the determination.

At step 850, the server may transmit the determined likelihood to a user. For example, the server may transmit the likelihood to a device associated with a user, e.g., a cell phone, a tablet, or other personal computing device.

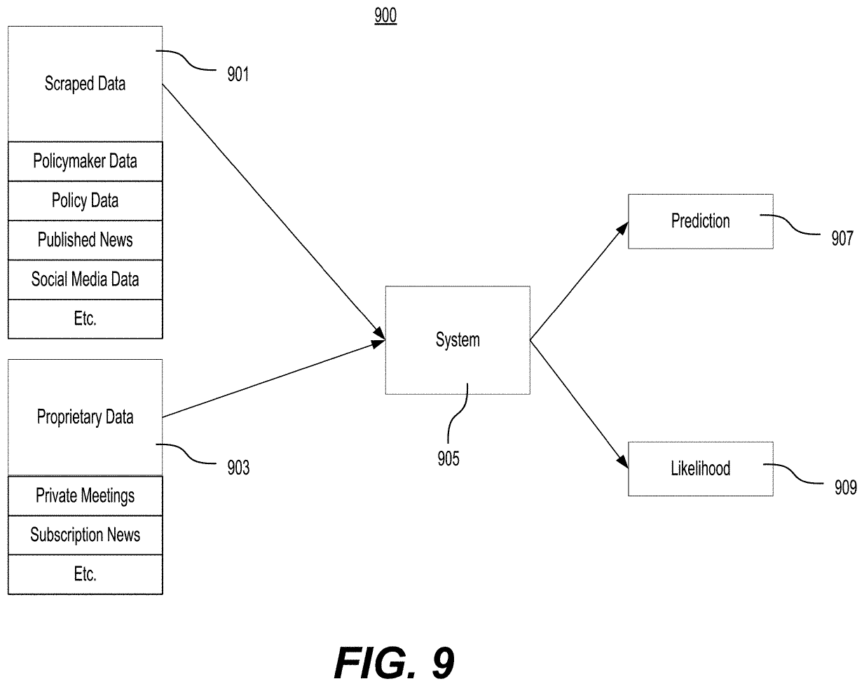

FIG. 9 is a depiction of possible inputs into a system 900. System 900 may comprise, for example, a variation of central server 105 of FIG. 1. Moreover, system 900 may include memory 500 of FIG. 5. As depicted in in FIG. 9, system 900 may include prediction system 905. In some embodiments, prediction system 905 may comprise a variation of central server 105 of FIG. 1, exemplary system 700 of FIG. 7, or the like. Prediction system 905 may further include memory 500 of FIG. 5.

As further depicted in FIG. 9, scraped data 901 and proprietary data 903 may be input into prediction system 905. Scraped data 901 may comprise data related to one or more policymakers, data related to one or more policies, data related to one or more published news stories, data scraped from one or more social networks, or the like. Proprietary data 903 may comprise information related to one or more private meetings, data related to one or more subscription news stories, or the like.

As depicted in FIG. 9, prediction system 905 may generate a prediction 907 and a likelihood 909 from scraped data 901 and proprietary data 903. For example, system 905 may apply one or more models, as discussed above, using scraped data 901 and proprietary data 903 as inputs. In some embodiments, system 905 may parse and/or extract one or more features from some or all of scraped data 901 and/or proprietary data 903 before applying the data and/or features as inputs. Moreover, as discussed above, in some embodiments, proprietary data 903 may include scarped data and/or may include non-scraped data.

In addition to the hardware and software discussed above, systems and methods of the present disclosure may be implemented, at least in part, using one or more graphical user interfaces (GUIs). For example, a user may submit queries and/or non-scraped proprietary information via one or more GUIs. By way of further example, interaction with one or more graphical displays may be facilitated via one or more GUIs. Accordingly, steps of methods 600 of FIG. 6 may be facilitated via the use of one or more GUIs.

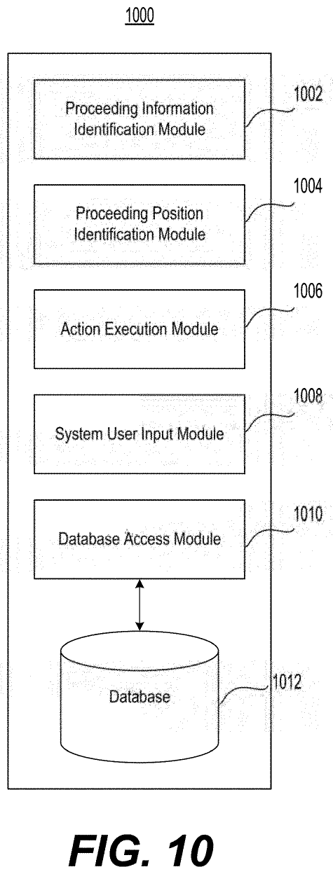

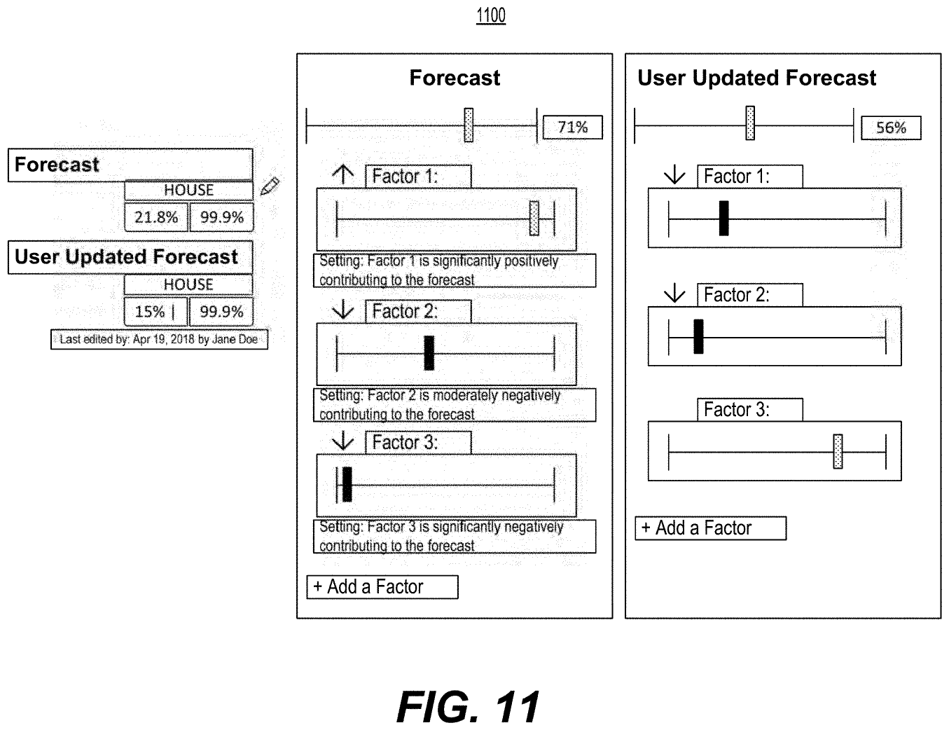

FIG. 10 is a diagrammatic illustration of a memory 1000 storing modules and data for altering predictive outcomes of dynamic processes in accordance with the present disclosure. Memory 1000 may include an application or software program providing instructions for collaboration between multiple user(s) 107 according to a communication-based dynamic workflow. The term “communication-based dynamic workflow” includes any set of instructions or rules that facilitate operational steps according to communication between user(s) 107. In some embodiments, memory 1000 may be included in, for example, central server 105, discussed above. Further, in other embodiments, the components of memory 1000 may be distributed over more than one location (e.g., stored in a plurality of servers in communication with, for example, network 101).

Memory 1000 may include a proceeding information identification module 1002, a proceeding position identification module 1004, an action execution module 1006, a system user input module 1008, a database access module 1010, and a database 1012. In some embodiments, system user input module 1008 may receive user input or a request from user(s) 107 interacting with a graphical user interface (GUI) on devices 300, 400. Proceeding information identification module 1002 may then communicate with system user input module 1008 to identify the nature of the user input or request.

Proceeding information identification module 1002 may then communicate with action execution module 1006 to take action and execute instructions to gather information related to the user input or request. For example, action execution module 1006 may instruct database access module 1010 to gather information from database 1012. In still other embodiments, proceeding position identification module 1004 may analyze the information procured from the database 1012 in order to provide a tendency or likelihood of a favorable outcome. Action execution module 1006 may then display this result to user(s) on GUIs displayed on devices 300, 400. Other types of communication-based dynamic workflows between user(s) are also contemplated.

In further embodiments, and in response to one or more results displayed to the user, user(s) 107 may provide feedback to system user input module 1008 related to their experience with part or all of the system 100. The term “feedback” may include communication related to data, analytics on data, mappings, predicted outcomes and their likelihoods, and any other user or system generated feedback. For example, feedback may reflect relevance of information or prediction to the user(s), in general or based on a specific query, user priority of the information, user position on the information, correctness, and timeliness.

In other embodiments, feedback may be provided prior to, at the time of, or after the item data is acquired or a prediction is generated. For example, user(s) 107 may create and update a profile at any time during their engagement with system 100. The term “profile” may include a set of user preferences, and a preference may be interpreted as feedback. For example, a preference may indicate the type of data the user is interested in. This indication may be in the form of specific terms that occur in documents, broad or specific subject areas which are produced by system 100 via analysis to categorize the document, local or global milestones, and policymakers associated with the data, such as legislators or agencies, and document types.

In some embodiments, a preference may indicate the likelihoods of predicted outcomes which the user is interested in. For example, the user may only want to be notified on any predicted outcomes with a very low likelihood. A preference may also have or more sub-preferences, or may constitute a combination of one or more preferences. For example, a user 107 may define his or her own preference to indicate the threshold at which a predicted outcome likelihood becomes “very low.” A user 107 may further have more than one definition of such a likelihood. In some aspects, a different threshold may be set to indicate “very low likelihood” for each different piece of analysis, such as predicted passage of a bill having a different threshold than promulgation of a rule.

In other embodiments, a preference may indicate the relationship a first user holds to a second user. For example, this may include the type of feedback, models, or other user generated data the first user restricts, or shares.

In some embodiments, both the first and second user may be able to jointly provide feedback, including on existing models, and create new models, or any sub-parts. In this example, system 100 may hold a single version of the feedback for both users, or hold individual copies of feedback for each user that is then combined to form the combined feedback. In other embodiments, the user may distinguish which feedback was provided by which user, or feedback may be anonymized such that user is unable to distinguish where the feedback came from.

In some embodiments, generated models successively updated by a first user may have versions, each version representing a single piece of feedback, or multiple pieces of feedback. Each version of the model may be stored and accessed separately. Similarly, feedback provided by the second user on the same set of outcomes may be versioned. In other embodiments, if the first and second user do not share a permission group, and both provide feedback on the same data for the same outcome, their respective feedback may be processed separately and a first users system may be unaffected by second users feedback, and the second users system may be unaffected by first users feedback.

In some embodiments, if a first user selects to share feedback, models, out other data with second user, second user may see the initial predicted outcome, a version of the predicted outcome, or first user predicted outcome and the associated likelihoods. In other embodiments, a preference may also indicate the frequency at which the user should be notified of updates to the data, including new or updated data, second user feedback, or new or updated predicted outcomes or likelihoods. For example, a first user may provide feedback on the feedback of a second user.

In some embodiments, a preference may also indicate the position the user will take on a given issue. An issue may be a system predefined subject area categorization, a user updated system model, or a user specified issue area, represented as a set of terms, linguistic patterns, labels, or a user initiated categorization model. A position may be an indication of the user's opinion on the issue, such as the issues priority, relevance, importance, or if the user is in support or opposition of the issue. These preferences may be set prior to the acquisition or generation of a target piece of data or analysis, and may be applied to the target at the time it is acquired, or at any point later, such as on user request.

In other embodiments, feedback may include proprietary data, as discussed above. For example, feedback may also include feedback on sub-parts of the data or analysis. As a further example, users may provide feedback on the predicted outcome of a given model, such as their agreement with the predicted outcome of a given legislator voting favorability for a bill. They may also provide feedback on the thresholds used in the model scoring function, such as that a probability of a sponsor voting yes with less than 70% probability means they will vote no.

In other embodiments, users may provide feedback on one or more parameters used by the model, such as the features used and weighting of those features. Users may also provide feedback on an individual feature or weight, or a grouping of features or weights together, where the grouping may be determined by the user or the system.

For example, a user may indicate that the feature representing the sponsor effectiveness for a specific sponsor of a legislative bill should be removed or that the features representing the sponsor effectiveness for all sponsors should be removed, or may select a specific sub-group of sponsors for whom the feature should be removed, or that the sponsor effectiveness features should be removed their importance as computed by the model is lower than some threshold. Moreover, the user may indicate that any of those features or groupings may be weighted lower by the model.

In some embodiments, a user may indicate that some training instances such as documents be given higher or lower importance for computation of model parameters. For example, a user may indicate for subject area categorization of documents into the “financial” category, documents containing the term “angel fund.” Therefore, a feature vector generated from those documents may be weighted lower than documents containing the term “toxic assets.” The feedback on weighting may be relative, such as a first feature weighted lower than a second feature, or absolute, such as when a feature should receive a specific weight set by the user. The feedback on weighting may completely replace system generated weighting, or may alter it, such as by adding or subtracting some amount. In other embodiments, relative and absolute weighting may be represented as real numbers. For example, a first feature may have a weight of 5.3. The first feature may be represented in percentages, and the first feature may be 50% of the second feature. A first feature may also have a coding scheme comprised of high, medium, and low levels.

In some embodiments, feedback and collaboration may change the calculation of an existing system defined feature. For example, user feedback may indicate that the legislator effectiveness score should not take into account non-substantive legislation. In some embodiments, user feedback may create new features for a model. For example, a user may create an additional feature for the argument recognition model for the outcome of recognizing if a policy documents presents the argument of lacking time. The feature may be a term, such as “this policy does not provide enough.” The feature may be associated with a desired outcome by the user, such that when observed by the system in a policy it is associated with the outcome of lacking time. If such a feature and the associated outcome conflicts with any set of features derived by the model, or the predicted outcome, the user may have a preference of how the conflict should be resolved. Alternatively, the user created feature may be left to the system to decide the correlation. The features associated weights may be specified by the user or computed by the system. The user created feature may be a term, linguistic pattern, user-defined coding system, etc.

In other embodiments, feedback on the model, such as the predicted output, or sub-parts of the model, such as weighting or parameters, may result in the model being recomputed. Any feedback, including modified features, weights, or new features may be computed by the system on all data, only for a subset of data or models, including, for example, proprietary data, as indicated by the default profile settings or user profile settings.

In some embodiments, the re-computation may include removal of an entire training instance, such as when the user indicates that part or all of the system data was incorrect, removal of features from a training instance, changing of weights applied to features of a training instance, introducing new training instances, such as from proprietary data provided by the user, introducing new features into a training instances, such as from new features created by the user.

In other embodiments, the model may not be recomputed based on feedback. For instance, after feedback indicating that a feature or group of features should be removed, a previously generated model may be applied, while removing those features indicated by the user from the scoring function, thus removing their effect on the output, without re-computation of the model in a model training phase.

In some embodiments, feedback on a model predicted output or likelihood may affect other predicted outputs of the model according to memory 1000. For example, feedback indicating one legislator will vote yes on a given bill, may result in the updating of the predicted outcome and likelihoods of the other legislators. In some embodiments, this update may occur for the predicted votes on the specific data instance, i.e., bill, on which the feedback was provided. In other embodiments, this update may also affect the predicted outcome (e.g., voting behavior) of the user updated legislator on other bills, not directly given feedback by the user, and other legislators on other bills.

In other embodiments, feedback indicating that a first comment submitted for a regulation is opposing the regulation, may update the analysis of a second comment, either on the same regulation or others. For instance, analysis of the second comment may have indicated that the commenter agrees with the position of the first comment. If automated or manual analysis of the first comment indicated the comment is supporting the regulation, user feedback indicating the comment is in fact opposing the regulation, will update the position of the second comment to opposition.

In some embodiments, feedback on a model predicted output or likelihood may affect other models or module 1000, that produce a different predicted outcome. For example, user collaboration or feedback on a given bill's likelihood of enactment may affect the predicted outcome and likelihood of the model predicting when a rule on the subject will be promulgated. As a further example, user collaboration or feedback on a given bill's likelihood of enactment may affect the predicted outcome and likelihood of the model predicting the stance taken by a comment on a regulation.

In other embodiments, feedback on one model may or may not affect other models. Users may have the option to enable or restrict their feedback on one model from being used by other instances of the same model, or another model. Furthermore, users may have the option to enable or restrict their feedback from being used as feedback for other users models, whether in their organization or outside of it.

In some embodiments, another type of user feedback may instantiate the creation of an additional model. The additional model may be intended to compute one or a set of the same outcomes as existing models generated by the system, or may be intended to compute a new outcome that was previously unavailable by the system. The model may be generated by the system, or uploaded by the user. For example, user feedback may specify that the user wants to create a new model that computes how likely a bill is to be enacted. They may upload such a model into the system. Uploading a model may include transfer of data, associated files, etc. either through the network, into a computer, etc. in a specified format understood by the system. The user may instantiate the generation of a model for a new outcome. In one embodiment, the user may provide feedback to the system by labeling the impact a bill will have on their organization. The user labeled data may constitute training data for the creation of a model, as described above. The system may generate one or more models with some or all of the users' data as one or more inputs. Instead of using the raw user labeled data, the system may extract one or more features from the data, as discussed above, to use as inputs for the model. The system may generate and update these models periodically, e.g., on a schedule, or at the direction of the user. In other embodiments, a user may provide feedback to the system by labeling a user-defined subject area, such that documents deemed to be within that subject area are relevant to the users definition of that issue.

In some embodiments, for either an existing or new outcome, the system may select or allow the selection of a set of data, select or allow for the selection of a set features to be extracted, select or allow for the selection of a or a set of models to be generated, and select or allow for the selection of associated outcomes, e.g. enactment, impact, issue relevance, and initiate a model generation phase through the system. For example, if a user-defined wanted to create subject area model for “background checks for teen drivers,” a user may select existing documents they deem relevant to the issue, select the set, or types of feature they want to extract, for example, phrases occurring in the document, select the type of model they want to have, for example a combination of a logistic regression and neural network, and have the system generate the model.

In other embodiments, the new model may be updated with additional feedback as any existing system model. Users may create new predicted outcomes from existing system models, or user generated models, or some combination thereof. Additionally, user generated models may be used by the system or the user as sub-parts of other models. User feedback, including on the models, sub-parts thereof, or creation of new models, may result in one or more models for each outcome. The user feedback may be used to generate a new model in a user specific model generation phase, or used to update the existing model, or a combination thereof, where a model may be a combination of the model generated from or update with user feedback, and a model generated by the system. For example, there may be multiple models that predict when a regulation will be promulgated, for example one from the system, one from a user providing feedback to the system model, and one from the user creating their own. Accordingly, the system may be able to provide users with tailored and more relevant information based on the users' requests and feedbacks. The system may also combine system acquired and generated data and proprietary data and may update the analytics and predictions to reflect the combination.

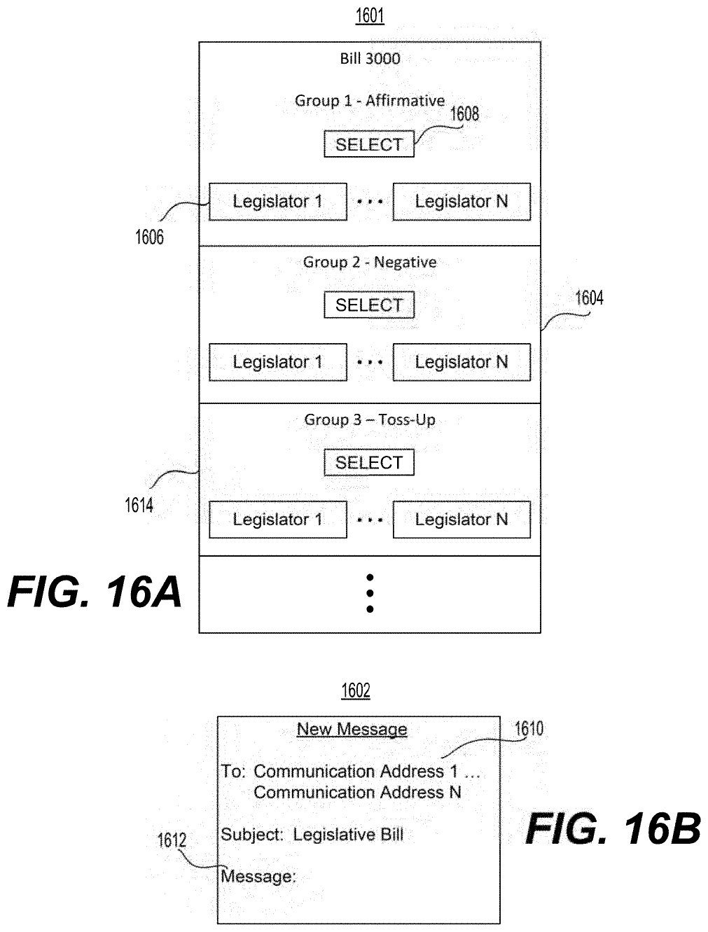

FIG. 16A is a diagrammatic illustration of an exemplary graphical user interface (GUI) 1600 for user collaboration and feedback consistent with the disclosure. GUI 1600 may be displayed as part of a screen executed by a software application on, for example, device 300 or device 400. The screen may take the form of web browser or web page consistent with the present disclosure. Exemplary GUI 1600 may include a system predicted outcome and likelihood and a user predicted outcome and likelihood based upon factors (e.g. features) that may be integrated with system 100 or defined by a user(s) 107. Exemplary GUI 1600 may include “Factor 1,” “Factor 2,” and “Factor 3,” and may allow to “Add a Factor.” GUI 1600 may further indicate an amount each factor is contributing to a predicted outcome and likelihood, whether system or used based. In particular, a quantitative output may be displayed indicating a likelihood of passage in percentage terms. For example, a system predicted outcome and likelihood may indicate a “71%” likelihood of passage as compared to a user predicted outcome and likelihood of “56%” likelihood of passage according to specified feedback and user set factors. The feedback factors may update a model, as discussed above, in order to change a predicted outcome and likelihood.

In some embodiments, feedback may be applied to data in the system automatically or manually. For example, a stored user preference may be to increase the likelihood of passage for any bill introduced by a specific senator to 90%. Another preference could be to weight a specific factor higher or lower than another specific factor for a given predicted outcome. For example, a preference may be to weight the occurrence of the term “tax liability” higher than the committee assignment of a bill in the predicted outcome of favorable recommendation out of the committee. This feedback may be applied automatically when the system acquires any bill sponsored by specific senator, or at some user defined time. User feedback or collaboration (including preferences) may be provided explicitly or implicitly. Explicit feedback may come in the form of user providing feedback that directly affects a specific model. Examples of direct feedback may be marking a document irrelevant for a specific subject-area categorization, which may update the subject-area categorization model to down weight any features associated with the irrelevant document; marking a document as opposing the rule, which may update the stance detection model to include that comment as part of the training set for opposing comments.

In other embodiments, implicit feedback may come from any interaction the user has with the system, whether or not it is intended to update existing or create new analysis. Implicit feedback may include uploading a draft document or sharing a document with another user on the system or publicly, which may be used to update existing or create new models for subject-area relevancy categorization, where the terms inside the uploaded or shared document may be deemed relevant to the user.

In some embodiments, a profile may also be established by the system for a user, treating the user settings as predicted outcomes with an associated model. For example, the system may generate a model with the predicted outcome of whether the user will take a support or opposition opinion on an issue. The system may use data derived from a user's explicit and implicit feedback to establish this profile. The system may also use data derived from a second users feedback, in the users organization, or from other users, if the second users permission setting allow. In other embodiments, users may have the option to enable or restrict their feedback from being used as data for the establishment of other system generated user profiles, or other models. Once user feedback is in the system, it may be saved and be accessible for later use, either by the system, or other users. Feedback may be removed from the system.

In some embodiments, feedback may include user feedback on the system generated profile. For example, if the system generated profile contains a system generated model for predicting a user's support on an issue, and it predicts incorrectly, the user feedback on the system generated profile may include correcting the outcome. Feedback may be generated and represented in a number of forms such as clicking or selecting an option to indicate a correction to data or an analytic, input via a text entry, wherein the feedback will be parsed by the system, verbal feedback input through a microphone, wherein the feedback will be parsed by the system, or through an API, or other interface, etc. The profile may be represented and generated by a number of means. Users may create and update preferences via a GUI, and users' profiles may be set to default settings by the system, or preset based. Both the initial system prediction, and the updated predicted outcome based on user feedback may be presented to the user. Feedback may be stored by the system in one or more databases and files. The databases may be segregated from other databases containing non-proprietary data. User generated models or models incorporating any user feedback may be stored or run on the same machines as system derived models or may be stored or run in their own environment.

Analyzing Policymaker Alignment with Organizational Posture

In some embodiments, the disclosed systems and methods may involve internet-based agenda data analysis. For example, the disclosed systems and methods may enable one or more organizations to determine how policymakers align with the organizations' legislative, regulatory, or judicial postures. Organizations may weigh issues that are of interest to them, and based on the weighing, a user interface may reveal, in a graphical format, the relative alignment of legislators to the organizations' legislative posture.

Aspects of the disclosure, in their broadest sense, are not limited to an issue-based analysis of legislator alignment with an organizational posture. Rather, it is contemplated that the foregoing principles may be applied to enable one or more organizations to determine how policymakers, including regulators, administrators, judges, and other related officials align with the organization's corresponding postures. The term “organizational posture” includes the particular stance or political position of an organization. The term “organization” includes any collection of individuals operating according to a common purpose, as described above.

For example, in some embodiments, internet-based agenda data analysis may enable determination of legislator alignment with an organization's legislative posture. In other embodiments, internet-based agenda data analysis may enable determination of administrator alignment with an organization's administrative posture. In still other embodiments, internet-based agenda data analysis may enable determination of judicial alignment with an organization's judicial posture. Internet-based agenda data analysis may be performed to determine alignment for any policymaker with any of an organization's related postures.

As discussed above, system 100 may comprise network 101, plurality of sources, e.g., source 103a, 103b, and 103c, central server 105, and user(s) 107. Consistent with the disclosure, system 100 may include devices 300, 400 for receiving user input from user(s) 107 and for displaying the alignment position of multiple policymakers relative to an organizational or user posture. The term “alignment position” includes a measure of how policymakers are oriented relative to an organizational or user posture. In some embodiments, the alignment position of a policymaker may be based on one or more positions of a plurality of organizations or at least two organizations.

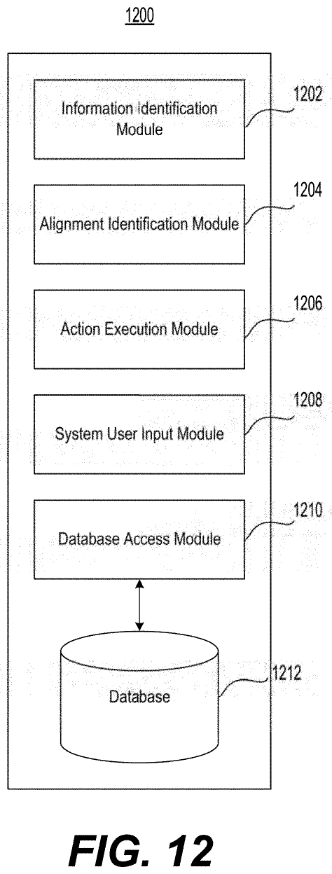

FIG. 12 is a diagrammatic illustration of a memory 1200 storing modules and data for performing internet-based agenda data analysis and, in particular, for performing an issue-based analysis of a policymaker alignment with an organizational posture. Memory 1200 may include an information identification module 1202, an alignment identification module 1204, an action execution module 1206, a system user input module 1208, a database access module 1210, and a database 1212. In some embodiments, memory 1200 may be included in, for example, central server 105, discussed above. Further, in other embodiments, the components of memory 1200 may be distributed over more than one location (e.g., stored in a plurality of servers in communication with, for example, network 101).

Based on a selection of user-selectable agendas from a list, system user input module 1208 may receive agenda issues of interest to an organization. Information identification module 1202 may then identify an indication of an organization's position or posture on each selected issue. Memory 1200 may further instruct database access module 1210 to search database 1212 for policymaker data from which an alignment position on each of the agenda issues is determinable. In some aspects, if policymaker data is not available, action execution module 1206 may scrape the Internet in accordance with the disclosure to determine individual policymaker data including one or more alignment positions.

In some embodiments, alignment identification module 1204 may calculate an alignment position data from individual policymaker data. In some aspects, the alignment position data may correspond to relative positions of each of the plurality of policymakers on the plurality of selected issues. In other embodiments, action execution module 1206 may transform the alignment position data into a graphical display that presents the alignment positions of multiple policymakers relative to an organizational or user posture.

In further embodiments, memory 1200 may store instructions for perform internet-based agenda data analysis to identify how actors including policymakers (e.g. legislators, regulators), and other users or organizations align with a user's position. A rating system may be produced which indicates an alignment score for each selected actor, and may be used to rate each actor relative to other actors. In this example, a higher score may indicate a greater alignment between the user and actor. The rating system or any other mechanism of establishing alignment may further be used to suggest policymakers for a user to contact, for the purpose of making a financial contribution, for proposing a bill that will benefit the user and have the highest likelihood of bill introduction and passage, for selecting the jurisdiction for a judicial proceeding, or for coordination with a second user or organization that shares aspects of the first users' or organizations' posture.

In some embodiments alignment identification module 1204 may predict an indication of an organization's position on a selected issue. For example, alignment identification module 1204 may apply one or more models to data related to the organization to determine a prediction of one or more possible positions of an organization and may also determine a likelihood that the organization will in fact have a particular predicted position (e.g., a confidence score expressed, for example, as a percentage).

In other embodiments, identifying a legislator's position or posture on an issue may be determined by examining a legislator's previous history, including voting behavior, sponsoring behavior, statements, received financial contributions, and other information. In still other embodiments, identifying a legislator's position or posture on an issue may be determined by other data. Such data may be proprietary data, including private conversations, in person, phone, or through other technology enabled means: email, IMS, etc. This data may be ingested by the system and may be used to establish the legislator's positions.

In addition to identifying legislator's posture, in still other embodiments, a user of system 100 (i.e. non-policymaker) may have a position or posture on an issue that may be established by the user. For example, this may be established in a user profile, or through an internet-based agenda data analysis system, via automated analysis of the user's feedback. For example, the system may automatically identify bills where the user has indicated support, and where legislators voted in support of the bill. In some aspects, if no vote data is present, a predicted outcome, i.e., the likelihood of the legislator voting in support of the bill, may be entered or used in place of a real legislator vote to identify bills on which both the user (i.e. a non-policymaker) and the legislator may agree.

In some embodiments, if the user has uploaded additional proprietary data indicating legislators' positions, a model may be generated to predict legislator positions using the uploaded data. This user-generated model may be used in addition to, in place of, or in combination with any system models to predict legislators' positions, and to compute agenda issue agreement between the user and a legislator. Furthermore, if the user has not indicated that they support a given bill, a system-generated or user-generated model for predicting the user position may be used in place of the explicit user position on a bill, in conjunction with a real or predicted vote or position, to identify bills on which the user and the legislator agree. In other embodiments, a first user's indicated or system-generated or user-generated predicted positions and a second user's indicated or system-generated or user-generated predicted positions may be used to compute alignment.

In other embodiments, an internet-based agenda data analysis may perform an ideology analysis to identify a legislator's position on an issue. A user may be projected to occupy the same ideology as the legislators according to an ideology analysis or ideology model, and real or predicted user positions. In some aspects, a rating system may be applied to actors that are other users, or non-user organizations. The rating system may connect users that share similar positions, in order to form a coalition with and drive a similar agenda, or to share resources. In other aspects, similar users may choose to establish a permission group that may allow sharing feedback to the system, as described above.

In some embodiments, one or more organizational positions or postures may contribute to rating uniformly, or there may be a system or user specified weighing that weights the contribution of organizational positions differently. A weighing may include weighing single positions or groups of positions. Weighing of groups of positions may include some positions pertaining to particular issues weighted higher than other positions. Other weighing may apply to specific bill, where the alignment of position on that bill may contribute to the overall alignment rating differently than other bills. Other weighing may apply to specific regulation, where the alignment of position on that regulation may contribute to the overall alignment rating differently than other regulations. Other types of weighing are contemplated in accordance with the present disclosure.

In other embodiments, the weighing system may be accessed through a GUI, where a user may select items and their associated weight. The rating may be presented to the user as a list, where a user can select an ordering, and see names and information relating to policymakers, along with associated scores ranking the policymakers.

In some embodiments, a visual graph may be displayed to a user and include alignment coordinates to represent a policymaker's position on one or more agenda issues. In some aspects, this graph may be a multi-dimensional presentation, where one axis constitutes an alignment rating between the user and a legislator, and a second axis constitutes an effectiveness of the legislators, or how much money the user has contributed to the legislator. In other aspects, the graph may include one axis representing user favorability toward one agenda issue and another axis representing user favorability toward a different agenda issue.

In still other aspects, the user may overlay the alignment rating system on a whipboard predicting the likelihood that legislators will vote for a given bill. For example, users may select a group of legislators, as can be defined by the grouping in the whipboard, and direct at communication at those legislators. In further aspects, the first axis may represent the alignment between the first user and other users, and the second axis may represent the geographical distance between users' locations. Other types of graphical display may be contemplated.

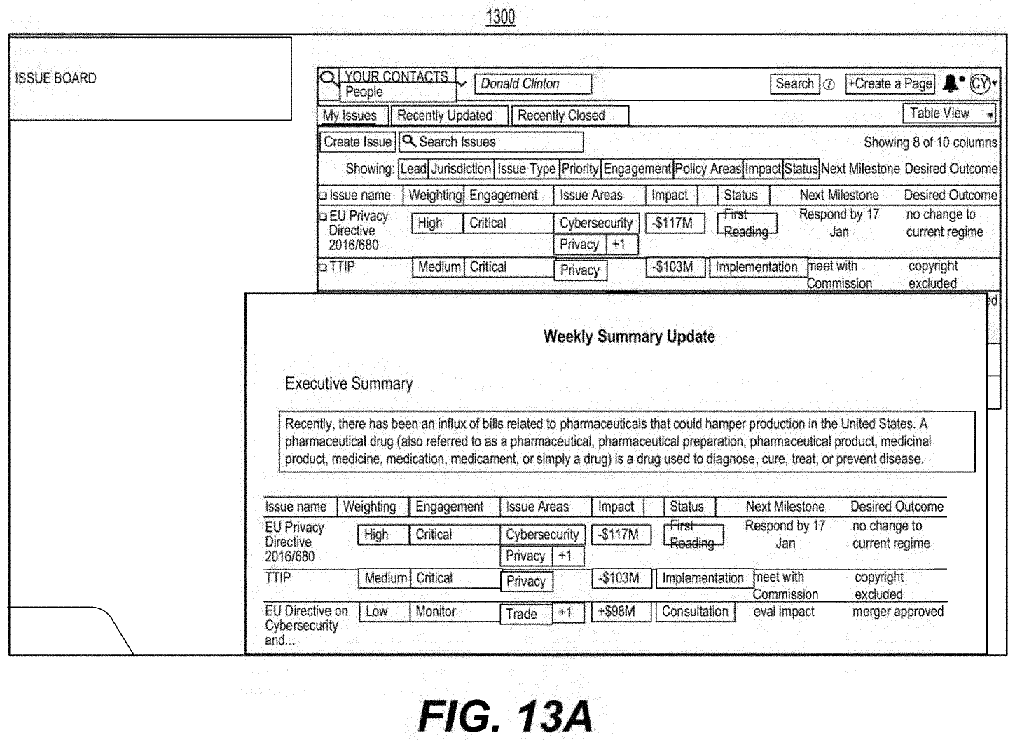

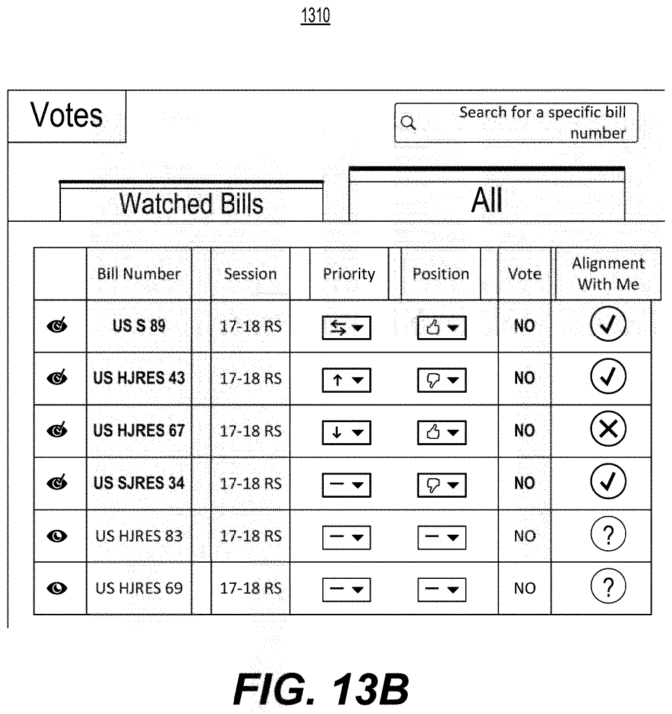

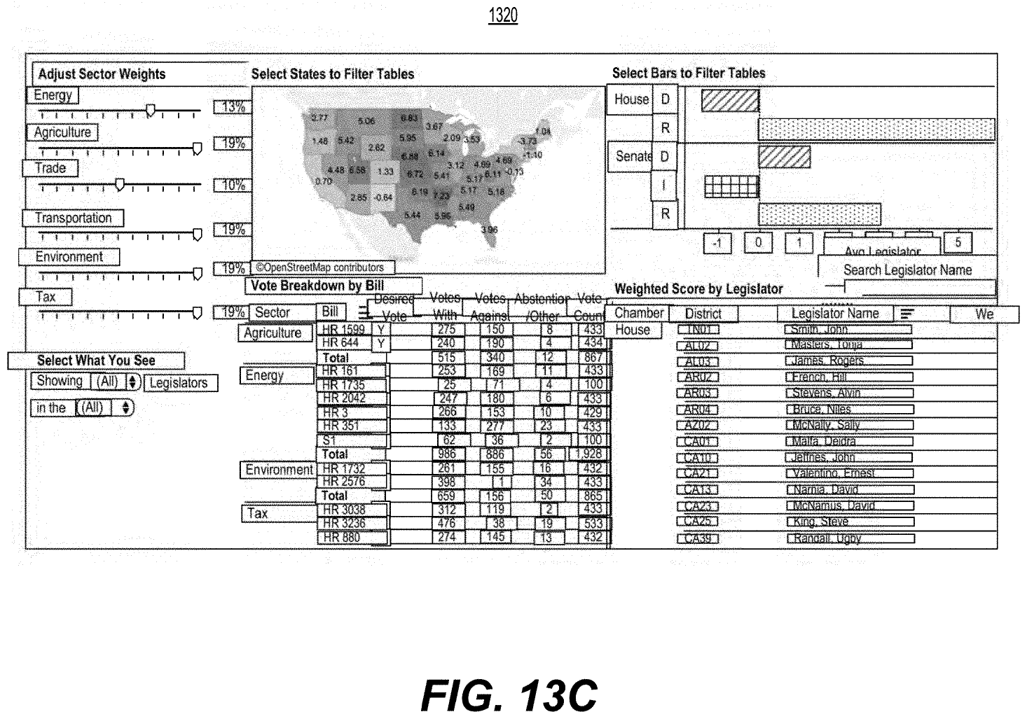

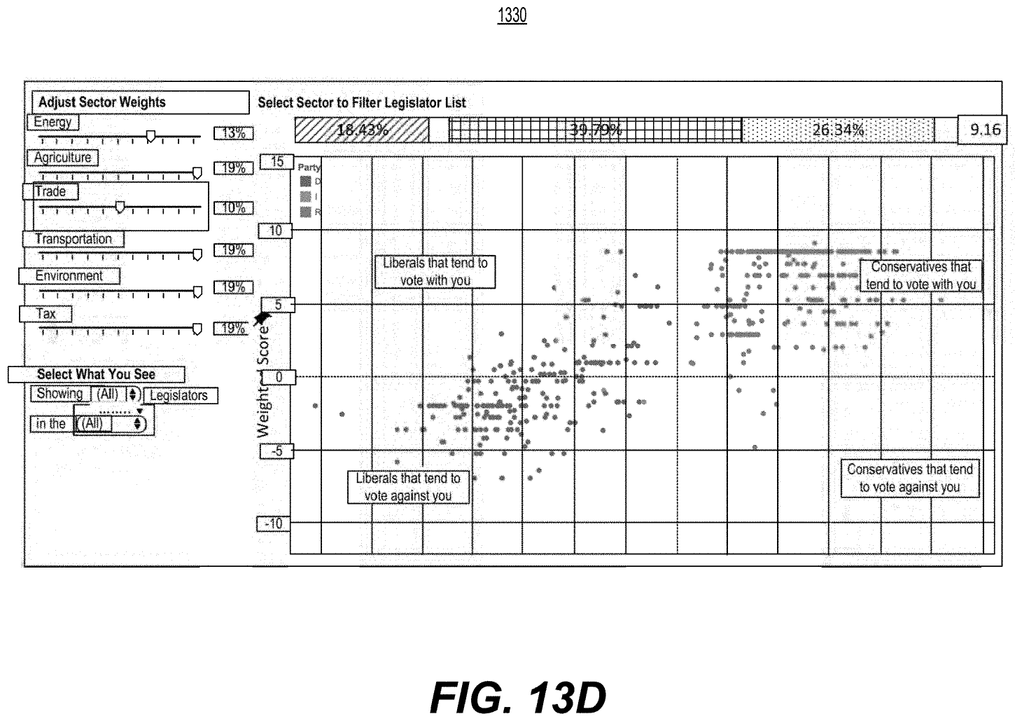

FIG. 13A is diagrammatic illustration of a GUI 1300 presenting a list of user-selectable agenda issues for performing internet-based agenda data analysis. In particular, FIG. 13A illustrates an exemplary GUI presenting a list of user-selectable agenda issues for performing an issue-based analysis of legislature alignment with organizational posture. GUI 1300 may be displayed as part of a screen executed by a software application on, for example, a personal device 300, 400. The screen may take the form of a web browser or web page consistent with the present disclosure.

GUI 1300 may include an “Issue Board” that aggregates essential information around issues in one integrated dashboard. The dashboard may allow for updates in real-time based on input or control to adjust weighting of each user-selected agenda issue. Agenda issues may include legislative agenda issues, regulatory agenda issues, and judicial agenda issues. The term “legislative agenda” includes any ideas or set of policymaking that are desired to be made more or less likely. A legislative agenda issue may be “Renewable Energy,” a regulatory agenda issue may be “Net Neutrality,” and a judicial agenda issue may be “Countervailing Duties”. The “Issue Board” may be segmented based on issues or geography, and may also be customizable. A user may be able to “Create Issue” or “Search Issues,” and may be able to filter issues that are displayed. For example, exemplary GUI 1300 may filter or segment agenda issues according to “Lead,” “Jurisdiction,” “Issue Type,” “Priority,” “Engagement,” “Policy Areas,” “Impact,” and “Status” in order to limit display to particular agenda issues. In some aspects, only “Issue Areas” relating to “Cybersecurity” and “Privacy” may be displayed. GUI 1300 may further include a “Weekly Summary Update” and “Executive Summary” or a list of user-selectable agenda issues that are presented to a user via a user interface. A “Weighting” and a “Desired Outcome” may be displayed. Agenda issues may be hyperlinked to allow for user selection. Upon selection of agenda issue, one more users may enter an indication of an organization's posture for the selected issue. User(s) 107 may select agenda issues and input organizational position or posture information to determine policymaker alignment relative to the selected agenda issues.

FIG. 13B is diagrammatic illustration of a GUI 1310 presenting a dashboard of alignment of a legislators position on bills with the users. In particular, FIG. 13B illustrates an exemplary GUI 1310 dashboard including headers such as a “Bill Number,” “Session,” “Priority,” “Position,” “Vote,” and “Alignment with Me.” There may be numerous indicators or drop down menus for users to select a “Priority” and “Position.” Based on a vote and other data, a calculation based on analysis may take place in accordance with the present disclosure in order to determine whether there is alignment with the user viewing the dashboard. “Alignment with Me” indicates whether a position defined in a particular bill aligns with the user or organization operating the dashboard.

FIG. 13C is diagrammatic illustration of a GUI 1320 presenting a dashboard where sector weights may be adjusted in order to provide a weighted score for each issue area. For example, GUI 1320 may include sections to “Adjust Section Weights,” “Select States to Filter Tables,” “Vote Breakdown by Bill,” and “Select Bars to Filter Tables.” GUI 1320 further may present a “Weighted Score by Legislator.” A user may weigh sectors or issues that are deemed most critical to the user by adjusting, clicking, or dragging a toggle. In accordance with the toggling of weight, display of other selections may be altered. In some aspects, a user may select and filter in order to allow for display of only desired information. Desired information may be displayed in graphical, tabular, and numerical form. Other types of display are contemplated. In this example, the user has weighted “Energy” at “13%” and as a result a weighted score for each legislator may be computed by alignment identification module 1204 and displayed.

FIG. 13D is a diagrammatic illustration of a GUI 1320 presenting a graphical display that includes alignment coordinates displayed in graphical form. Each displayed coordinate may represent a single policymaker's position on a single issue. In some embodiments, after alignment coordinates are displayed in graphical form, a user may adjust relative positions of the coordinates based on subsequent user manipulation of the at least one weighting control. The term “user manipulation” includes any modification by clicking, selecting, or dragging the weighting control in order to change alignment coordinates for a legislator. The term “control” includes any weighting based on user input. In other embodiments, after alignment coordinates are displayed in graphical form, a user may subsequently access updated individual policymaker data, and adjust relative positions of the coordinates based on updated individual policymaker data.

In still other embodiments, each displayed coordinate may be interactive, enabling a user who engages with the coordinate to view policymaker information. GUI 1330 may include the policymaker information that includes an identity of each policymaker. For example, the names of legislators and other legislators are displayed. On one axis, “vote with you” and “vote against you” based on a weighted score is displayed. On the other axis, ideology include liberal and conservative is presented. Liberals legislators are displayed are on the left and more conservative conservatives are on the far right. Accordingly, four quadrants may be displayed including “Liberals that tend to vote with you” in the top left, “Liberals that that tend to vote against you” in the bottom left, “Conservatives that tend to vote with you” in the top right, and “Conservatives that tend to vote against you” in the bottom right. Other alignment coordinates quadrants, axes, and displays are contemplated. Exemplary GUI 1330 allows for display of an alignment of multiple policymakers relative to a weighted organizational posture.

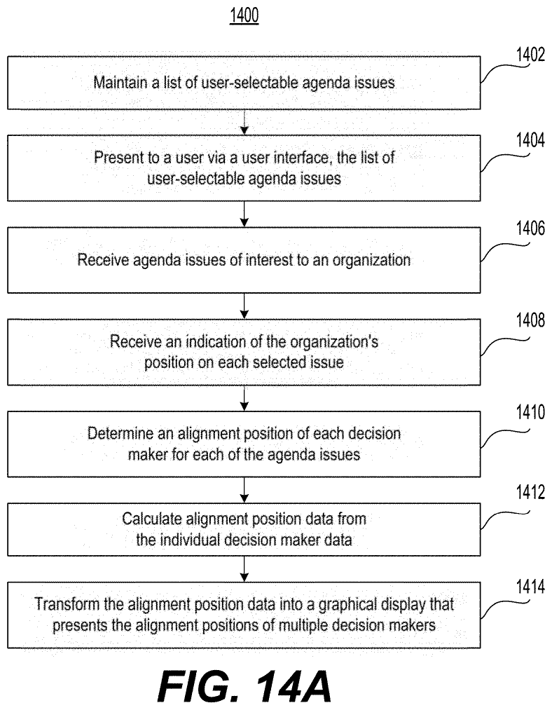

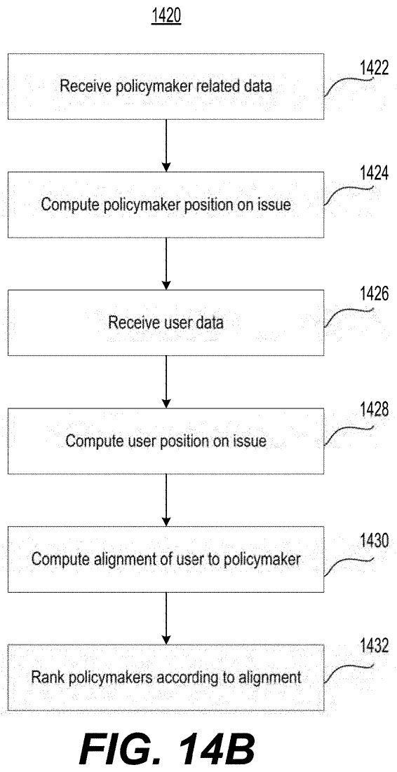

FIG. 14A illustrates an example flow chart representing an internet-based agenda data analysis method 1400 consistent with disclosed embodiments. Steps of method 1400 may be performed by one or more processors of a server (e.g., central server 105), which may receive data from user(s) 107 selecting both agenda issues of interest and an indication of an organization's position, and subsequently present alignment position data to user(s) 107 based on the selection.

At step 1402, the server may maintain a list of user-selectable agenda issues. The list of user-selectable agenda issues may be stored in modular database 1212, one or more storage servers 205a and 205b, and as part of sources 103a, 103b, and 103c comprising one or more local databases. The list of user-selectable agenda issues may be periodically updated, added, and deleted based on user input received at user input module 1208. User-selectable agenda issues may comprise any topic or subject matter as relevant to an organization, and may be specific or broad in scope. For example, as illustrated in FIG. 13A, user-selectable agenda issues may include “EU Privacy Direct 2016/680,” “TTIP,” “EU Directive on Cybersecurity” and may be related to issue areas such as “Cybersecurity,” “Privacy,” “Trade,” or government bodies, such as New York, China or Brazil. Other agenda user-selectable agenda issues corresponding to other issue areas may be contemplated.

At step 1404, the server may present to a user via a user interface, the list of user-selectable agenda issues. For example, as illustrated in FIG. 13A, the list may be presented as part of an exemplary GUI 1300 constituting an “Issue Board.” The “Issue Board” may aggregate all pertinent information relating to the list of user-selectable agenda issues in one consolidated dashboard. The list of user-selectable agenda issues and related information may be presented in tabular form and may include hyperlinks to allow for user selection and modification of agenda issues and related information. In some embodiments, the server may present to the user at least one control to adjust weighting of each user-selected agenda issue, wherein the weighting constitutes an organizational posture reflecting an overall stance of the organization. For example, “Weighting” may include “High,” “Medium,” and “Low.” However, other more precise and quantitative controls to adjust weighing of each user-selected agenda issue may be envisioned. The term “overall stance” includes the aggregate or summary of final position of an organization as it relates to a particular item.

At step 1406, the server may receive agenda issues of interest to an organization. User-selectable agenda issues may be selected by user(s) 107 and received at user input module 1208. In particular, based on a selection of user-selectable agendas from a list, system user input module 1208 may receive agenda issues of interest to an organization. In some embodiments, at step 1408, the server may receive an indication of the organization's position or posture on each selected issue. Information identification module 1202 may identify an indication of an organization's position or posture on each selected issue.

At step 1410, the server may determine an alignment position of each policymaker for each of the agenda issues. Memory 1200 may further instruct database access module 1210 to search database 1212 for policymaker data from which an alignment position on each of the agenda issues is determinable. In some aspects, if policymaker data is not available, action execution module 1206 may scrape the Internet to determine individual policymaker data including one or more alignment positions.

At step 1412, the server may calculate alignment position data from the individual policymaker data according to models in accordance with the present disclosure. The policymaker information may include an identity of each policymaker. The policymaker information includes at least one of voting history information of each of the legislators and party affiliation of each of the legislators. The policymaker information may also include at least one of regulation information of each of the regulators or government officials and party affiliation of each of the regulators or government officials. The policymaker information may also include at least one of voting history information of each of the each of the judges and nomination information or electorate demographics of each of the judges. Alignment identification module 1204 may calculate an alignment position data from individual policymaker data. In some embodiments, it may further aggregate alignment position of policymakers to compare a first plurality of policymakers to a second plurality of policymakers (e.g. the organizational posture to China's posture and Brazil's posture.) In some aspects, the alignment position data may correspond to relative positions of each of the plurality of policymakers on the plurality of selected issues.

At step 1414, the server may transform the alignment position data into a graphical display that presents the alignment positions of multiple policymakers. Action execution module 1206 may transform the alignment position data into a graphical display that presents the alignment positions of multiple policymakers. After the alignment coordinates are displayed in graphical form, a user may adjust relative positions of the coordinates based on subsequent user manipulation of the at least one weighting control. After the alignment coordinates are displayed in graphical form, a user may subsequently access updated individual policymaker data, and to adjust relative positions of the coordinates based on updated individual policymaker data as illustrated in FIGS. 13C-13D. Display in graphical form may provide useful information to determine legislator alignment with a predefined organizational posture.

FIG. 14B illustrates an example flow chart representing a second internet-based agenda data analysis method 1400 consistent with disclosed embodiments. Steps of process 1420 may be performed by one or more processors of a server (e.g., central server 105), which may receive data from user(s) 107 selecting both agenda issues of interest and, in some embodiments, an indication of an organization's position, and subsequently present alignment position data to user(s) 107 based on the selection.

At step 1422, the server may receive policymaker data. Policymaker data may be submitted by user(s) 107 and received at user input module 1208. At step 1424, the server may compute a policymaker position on an issue in accordance with the prior method. The computation may derive from the individual policymaker data. The policymaker information may include an identity of each policymaker. The policymaker information may further include at least one of voting history information of each of the legislators and party affiliation of each of the legislators. The policymaker information may also include at least one of regulation information of each of the regulators or government officials and party affiliation of each of the regulators or government officials. Alignment identification module 1204 may calculate an alignment position data from individual policymaker data to determine a policymaker position on an issue in accordance with the disclosure.

At step 1426, the server may receive user proprietary data. User data may be submitted by user(s) 107 and received at user input module 1208. At step 1428, the server may compute a user position on an issue according to models, as discussed in earlier sections. The user information may include an identity of each user. The user information may include at least one of user activity of each of the users. Alignment identification module 1204 may calculate an alignment position data from user data to determine a user's position on an issue. This may be display as shown in FIGS. 13B and 13D.

At step 1430, the server may compute alignment of a user to a policymaker. Alignment identification module 1204 may calculate an alignment of a user to a policymaker. At step 1432, the server may rank policymakers according to alignment. Alignment identification module 1204 may rank policymakers according to alignment. A policymaker with a closest alignment to a user may receive a highest score, and a policymaker with the furthest alignment may receive a lowest score. Ranking may be weighted and displayed as part of a “Weighted Score By Legislator” as shown in FIG. 13C. Other types of ranking and display are contemplated.

Virtual Whipboard

As described in more detail below, the disclosed embodiments may include systems and methods for generating and displaying a virtual whipboard to a system user. For example, in one embodiment, the virtual whipboard may include one or more groupings of legislators slated to vote on a pending legislative bill. The groupings may be based on any desired category, such as legislators likely to place a similar vote (e.g., affirmative, negative, leaning affirmative, leaning negative, etc.) on the pending legislation. An example of a graphical user interface for a virtual whipboard was discussed above in connection with FIG. 16H.

Further, in some embodiments, the virtual whipboard may include an integrated communications interface to enable the user to generate one or more communications targeted at one or more legislators slated to vote on the pending legislation. In some embodiments, the system may allow a user to communicate directly from the virtual whipboard with a selected legislator or group of legislators. This may enable, for example, a user to send a common message to personnel associated with legislators who have an aligned position on a particular bill. In some embodiments, one or more of the foregoing features may enable the system user to contact one or more legislators in a more convenient manner than existing systems allow.

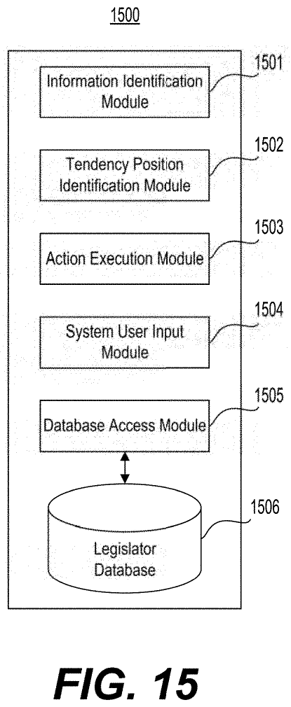

FIG. 15 is a diagram illustrating a memory 1500 storing a plurality of modules. The modules may be executable by one or more processors of a server (e.g., central server 105, discussed) above. Further, in other embodiments, the components of memory 1500 may be distributed over more than one location (e.g., stored in a plurality of servers in communication with, for example, network 101).

As illustrated in FIG. 15, memory 1500 may store software instructions to execute an information identification module 1501, a tendency position identification module 1502, an action execution module 1503, a system user input module 1504, a database access module 1505, and legislator database(s) 1506. Information identification module 1501 may include software instructions for scraping the Internet to identify pending legislative bill(s) and information about legislators slated to vote on those bill(s). Tendency position identification module 1502 may include software instructions for parsing the identified information to determine a tendency position (e.g., whether the legislator will vote for or against a bill) for each legislator. Action execution module 1503 may include software instructions to cause the occurrence of an action (e.g., display of a virtual whipboard) based on the determined tendency positions. System user input module 1504 may include software instructions for receiving a system user selection of a group of legislators selected for a communication interaction (e.g., an email) and/or for receiving a system user selection of one or more legislative function categories (e.g., a person's position or job title). Database access module 1505 may include software instructions executable to interact with legislator database(s) 1506, to store and/or retrieve information.

Information identification module 1501 may include software instructions for scraping the Internet to identify a currently pending legislative bill. For example, the software instructions may direct a processor to access publicly available information from online websites associated with government entities, non-profit corporations, private organizations, etc. The scraped information might include policymaking documents, including legislative bills in the form of proposed legislation, regulations, or judicial proceedings from various government bodies, including at the local, state, or federal level. The currently pending legislative bill may include, for example, a regulation proposed by an administrative agency (e.g., a rule promulgated by the United States Patent and Trademark Office), a federal bill proposed by a member of Congress (e.g., a health care bill), an ongoing case in the Fifth Circuit Court of Appeals, or any other type of legislative bill.

The data collection via Internet scraping may occur at any desired time interval. For example, the Internet may be scraped at preset periods (e.g., once per day), at initiated periods (e.g., in response to user input directing such scraping), in real-time (i.e., continuously throughout a given operation), etc., as described above.

Information identification module 1501 may further include software instructions for scraping the Internet to identify information about legislators slated to vote on the identified pending legislative bill. For example, the information about legislators slated to vote on the bill may include, for one or more of the legislators, party affiliation, past voting history on similar or opposing bills, written or auditory public comments (e.g., speeches, opinion pieces in newsletters, etc.), features of the represented legislative district (e.g., which industries supply jobs in the legislator's district), or any other available information about characteristics, prior actions or tendencies, or proclivities of the legislator.

Tendency position identification module 1502 may include software instructions for parsing or modeling the collected information to determine a tendency position for each legislator. The tendency position may be an indicator of a likelihood that the legislator tends toward one position and/or away from an opposite position with respect to the legislative bill. For example, the tendency position may be a percentage likelihood that the legislator will vote for a proposition set forth in the bill. For further example, the tendency position may be a percentage likelihood that the legislator will not vote for the opposite of a proposition set forth in the bill. As such, the tendency position may reflect a prediction of how each legislator is likely to vote on a pending bill. Further, the tendency position may be expressed in terms of percentages, absolute numbers, fractions, or any other suitable numerical or qualitative indicator of a likelihood that legislator will cast a vote in a given direction on the bill.

In some embodiments, the tendency position for a given legislator may be determined based on any combination of available information. For example, the tendency position may be determined based on one or more campaign contributions. For instance, if an organization (e.g., Planned Parenthood) that is a proponent of a given bill (e.g., funding for women's health needs) contributed a large sum of money to the legislator's election campaign, the tendency position for the legislator may favor a “yes” vote on the pending bill.

In one embodiment, the tendency position may be determined based on one or more prior votes of the legislator. For example, if the legislator has voted with a pro-gun inclination in the past, then the legislator may tend toward other gun owner rights bills. In other embodiments, the tendency position may be based on any additional factors that provide insight into how a legislator is likely to vote on a pending bill, including but not limited to party affiliation, public statements of the legislator or his/her staff, etc. In other embodiments, the tendency position may be the outcome of a model, as described above, whose input consists of one or more factors described above.

Action execution module 1503 may be configured to perform a specific action in response to the identified information. For example, action execution module 1403 may transmit a virtual whipboard for display to a system user. The virtual whipboard may group legislators into a plurality of groups based on the tendency positions determined by the tendency position identification module 1502. As used herein, the term “virtual whipboard” refers to a virtual representation of the likelihood that one or more legislators are likely to vote for or against a given bill. For example, in some embodiments, the outcomes and likelihoods of each legislator voting for a specific bill on the floor may be electronically presented in a table (i.e., a whipboard) in which legislators are grouped together in several buckets representative of the likelihood of their voting. For instance, all legislators likely to vote “yes” (e.g., yea) on a bill may form a first group, all legislators likely to vote “no” (e.g., nay) on a given bill may form a second group, and all legislators that are a “toss up” as to the bill may form a third group.

System user input module 1504 may include software instructions for receiving a system user selection of one or more of the plurality of groups displayed on the virtual whipboard. The system user may select one or more groups for a communication interaction based on the determined tendency position of the group. As used herein, the term “communication interaction” refers to any way or manner of exchanging information or connecting with one or more other individuals or entities. For example, the communication interaction may be emailing, calling on the phone, broadcasting a message directly to the legislator, or to a set of individuals requesting that they communicate with the legislator, sending a text message, etc.

In some embodiments, the virtual whipboard may be manipulated by the system user, for example, to filter by various attributes of legislators, such as party affiliation, voting likelihood, length of service, etc. As a further example, proprietary data may be used by the user of the system to filter legislators. Once manipulated in this manner, the user may provide the system user input module 1504 with a selection of one or more of the groups based on the tendency position of the group. For example, the user may select the “toss up” group for targeting with communications intended to sway members of the group toward a “yes” vote. The system user may provide his/her selection via any variety of suitable means, depending on implementation-specific considerations. For example, the system user may interact with a user interface displaying the virtual whipboard (e.g., by pressing a “select” button with his/her finger, or using a selector, such as a mouse, to select the desired group). For further example, the system user may select the desired group by accessing a dropdown menu in standalone software integrated with the virtual whipboard. In other embodiments, the user may provide a voice command that is recorded and/or translated into an action (e.g., determining a group selection indication) by the action execution module 1503. Indeed, the system user may provide his/her selection via any suitable interface.

Database access module 1505 may access legislator database 1506 to retrieve legislative communication addresses of legislative personnel scraped from the Internet and divided into a plurality of legislative function categories. The legislative communications addresses may be any type of address at which a person can be reached. For example, the legislative communication addresses may be email addresses, physical home addresses, physical business addresses, phone numbers, website URL's including contact forms, social media accounts, etc. A legislative function category may be a person's position or job title. For example, the legislative function category may be chief of staff, deputy chief of staff, legislative assistant, congressional aide, legislative correspondent, legislator, etc.

System user input module 1504 may receive from the system user a selection of which legislative function categories are desired for the communication interaction. For example, the system user may want to sway a given legislator to vote “yes” on a bill. However, since it is unlikely the legislator will respond to a communication directly, the system user may target a member of the legislator's staff, such as the legislator's chief of staff. Once the user has selected the legislative function categories and groups of legislators to target, action execution module 1503 exports the communication addresses of the legislative personnel associated with the user's selections to a communication platform. For example, the email addresses of the staff members of each of the legislators in the “toss up” group may be exported to the system user's email account to enable the system user to send an email to the staff members without the need to manually input each of the addresses for each of the staff members. However, it should be noted that exporting to the communication platform may include any suitable form of exporting the addresses from the legislator database, such as interfacing with a module within the system, or interfacing with a standalone email system of the system user.

Legislator database 1506 may be configured to store any type of legislator information of use to modules 1501-1505, depending on implementation-specific considerations. For example, in embodiments in which the system user desires to target the legislators personally, legislator database 1506 may store publicly available information about a given legislator. In other embodiments, legislator database 1506 may store information associated with the system user's prior selections for prior legislative bills (e.g., if the system user typically selects “toss up” groups). Indeed, legislator database 1506 may be configured to store any information associated with the functions of modules 1501-1505.

FIG. 16A illustrates an example of a virtual whipboard 1601, and FIG. 16B illustrates a communication 1602 that can be generated via use of the virtual whipboard 1601 by the system user. As illustrated, the virtual whipboard 1601 may display a first panel 1603 for a first group of legislators, a second panel 1604 for a second group of legislators, a third panel 1614 for a third group of legislators, and additional panels 1605 for any additional groups of legislators. On each panel, a graphical indication 1606 for each legislator assigned to a given group may be displayed. The graphical indication 1606 may be any indication that allows the system user to identify the legislator. For example, the graphical indication may be the legislator's name, picture, state, initials, chief of staff, etc. Further, each of panels 1603, 1604, 1614, and 1605 may include a select button 1608 that enables the system user to select that group for inclusion in the communication interaction.

As shown in FIG. 16B, communication 1602 is an email message including communication addresses 1610 corresponding to the selected group(s) of legislators and legislative function categories. In some embodiments, system user input module 1504 may further enable the system user to provide a common message for export to the legislative personnel associated with the selected group(s) of legislators. For example, the virtual whipboard 1601 may provide an option for the system user to draft a message. The message may then be exported and displayed in the message field 1612 of communication.

It should be noted that the illustrated virtual whipboard 1601 and communication 1602 are merely examples subject to a variety of implementation-specific variations. For example, the quantity of groups displayed may vary. In one embodiment, three groups corresponding to yes, no, and toss-up likelihoods of voting on the bill may be provided. In another embodiment, at least five categories of groups may be provided, including, for example, affirmative, leaning affirmative, neutral, leaning negative, and negative. Still further, in other embodiments, additional degrees of likelihood of voting for or against the bill may be provided.

Further, in some embodiments, the virtual whipboard 1601 may display one or more sorting options to the system user. For example, the virtual whipboard 1601 may enable the user to sort the legislators by party affiliation, represented district or state, or any other identifying characteristic. Still further, the virtual whipboard 1601 may enable the system user to message the legislative personnel associated with the selected group of legislators and legislative function categories directly from a messaging interface of the virtual whipboard 1601. That is, the virtual whipboard 1601 may display a “mailing list” option that enable the user to generate an email directly in the virtual whipboard 1601 interface.

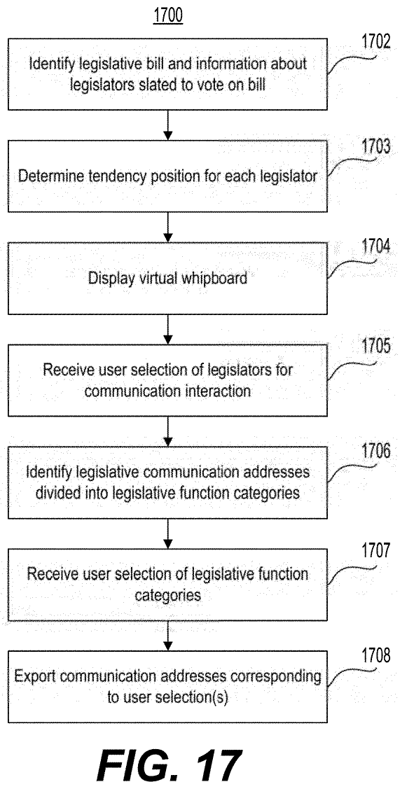

FIG. 17 illustrates a method 1700 for using the virtual whipboard 1601 in conjunction with a communication system in accordance with a disclosed embodiment. Method 1700 may, for example, be executed by one or more processors of a server (e.g., central server 105 of FIG. 1) or any other appropriate hardware and/or software. Further, when executing method 1700, the one or more processors may execute instructions stored in any one of the modules discussed above.

In accordance with the method 1700, the server may identify a legislative bill and information about legislators slated to vote on the bill at block 1702. Block 1702 may be facilitated by software instructions of information identification module 1501. Information identification module 1501 may be configured to scrape the Internet to identify a currently pending legislative bill relevant to the system user. For example, if the system user is interested in bills influencing the environment, the Internet may be scraped to identify bills being discussed on environmental blogs, or mentioned on a governmental website associated with the environment. Once the bill is identified, information identification module 1501 may identify information about the legislators slated to vote on the bill, as described in detail above.

The identified information about the legislators may be processed via software steps executed by tendency position identification module 1502. For example, at block 1703, the server may execute tendency position identification module 1502 to determine a tendency position for each legislator slated to vote on the identified bill. For further example, tendency position identification module 1502 may determine whether each legislator takes a position that is affirmative, leaning affirmative, neutral, leaning negative, or negative.

At block 1704, the server may execute action execution module 1503 to transmit for display to a system user the virtual whipboard grouping legislators into one or more groups based on the tendency positions determined in block 1703. For example, the virtual whipboard 1601 may be displayed to the system user to show which legislators were assigned to which groups. This display enables the system user to select one or more of the displayed groups for a communication interaction, and the user selection is received by the system user input module at block 1705. For example, the system user may select to target the legislators grouped in the leaning affirmative, neutral, and leaning negative groups in an attempt to sway the legislators from their current tendency positions.

At block 1706, the server may execute database access module 1505 to access legislator database 1506 to retrieve legislative communication addresses of legislative personnel scraped from the Internet and divided into a plurality of legislative function categories. At block 1707, system user may then provide a selection of one or more legislative function categories (e.g., legislative staff) for the communication 1602 via system user input module 1504. The communication addresses corresponding to the system user's selections of the legislator group(s) and legislative function categories are then exported, for example, to the system user's email system. In this way, the system user may target communication 1602 to the people associated with the legislators in the target tendency position groups.

Correlating Comments and Sentiment to Policy Document Sub-Sections

In some embodiments, the policymaking being analyzed may consist of multi-sectioned documents. For example, regulatory documents associated with a rule (or regulation) proposed in the rule-making process have multiple sections. These policies may be associated with a variety of potential outcomes. For example, the set of potential outcomes may include the likelihood of rule promulgation (i.e., the likelihood that the rule will be adopted), information related to the timeline of a rule-making process (i.e., the estimated amount of time until the rule is voted on, adopted, or denied), arguments made for or against the rule, likelihood of regulatory enforcement, the form in which the regulatory document will be finalized (i.e., what language may be included in the rule), the impact of the rule (including favorability and significance), and the factors helping or hurting the likelihood of any aforementioned potential outcome. The factors helping or hurting the likelihood may include, for example, policymakers or events.

Multi-sectioned documents may have different predicted outcomes for each section. For example, a bill is a multi-sectioned document, where a first section of a bill may be enacted, while a second section may be removed prior to enactment. The outcome of the policymaking, and the outcome of each section of the multi-sectioned policy document can be influenced by comments.

In some embodiments, comments may include those that are considered officially submitted comments, while other comments may not be officially submitted. For example, officially submitted comments may include statements of position, arguments, transcripts, scientific studies, meeting notes, financial analyses, and the like, which are sent to the policymakers directly. By contrast, a comment may also include documents not officially submitted to the policymakers, such as public statements from individuals, organizations, companies, social media, and news. As used throughout the present disclosure, a “comment” may refer to any of the above-described comments (both officially submitted and not). For example, the potential outcomes of a rule may be greatly influenced by reactions and feedback throughout the rule-making process. One of the primary forms of feedback is through the notice and comment process. Individuals and organizations, including private and public companies, government bodies, and foreign entities may submit their positions regarding the proposed rule. Regulatory agencies then review and respond to these comments made during the process prior to issuing a final rule (or obtaining additional feedback). Analysis of the submitted comments (which can often be extensive and, for example, exceed over a million comments per rule) may increase an understanding as to what the outcome of the final rule will be.

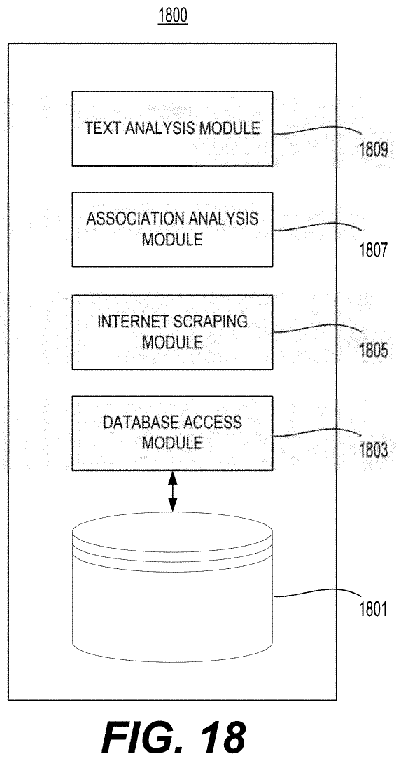

FIG. 18 is a memory 1800 consistent with the embodiments disclosed herein. In some embodiments, memory 1800 may be included in, for example, central server 105, discussed above. Further, in other embodiments, the components of memory 1800 may be distributed over more than one location (e.g., stored in a plurality of servers in communication with, for example, network 101).

Memory 1800 may include a database 1801, which may store information about multi-sectioned documents and comments. Memory 1800 may also include database access module 1803, which may be used to access information stored in database 1801 about a multi-sectioned document or comment. In some embodiments, the multi-sectioned documents stored in database 1801 may include one or more proposed policies. In some embodiments, the multi-sectioned documents stored in database 1801 may include one or more proposed bills. In some embodiments, the comments stored in database 1801 may be public comments on the one or more proposed policies. The information stored in database 1801 may be gathered through a variety of sources, for example, one or more of sources 103a-103c, as shown in FIG. 1 via, for example, network 101 (e.g., the internet).

Internet scraping module 1805 may gather information from open internet resources, such as legislative websites, regulatory websites, news websites, financial websites, and social media websites, or other data repositories provided by the user, such as proprietary data repositories, contained in repositories, including those not hosted on the internet (e.g., repositories available on internal networks, user accessed networks, and the like), which may be stored in database 1801, as described above. In general, internet scraping module 1805 may gather information about multi-sectioned documents and comments, which is stored in database 1801.

In some embodiments, the comments stored in database 1801 may be associated with certain sections of a multi-sectioned document using association analysis module 1807. For example, sections of the multi-sectioned document may be explicitly indicated in the comment (through citation, linking, and the like), or they may be implicit. Implicit mentions of the multi-sectioned document sections in the comment may be mapped from the comment to the multi-sectioned document through a mapping mechanism of association analysis module 1807.

In some embodiments, one such mapping mechanism may be in the form of a model used by association analysis module 1807. A model may represent each subsection of a comment as a feature vector, each subsection of a multi-sectioned document as a feature vector, and compute the similarity between feature vectors to map subsections of the comment to subsections of the multi-sectioned document. Many methods of computing similarity of vectors are available, including cosine similarity, kernel functions, or Euclidean distance. For example, nearest-neighbor search may be used for detection of a similar section between the comment and multi-sectioned document. Furthermore, a clustering model may be used, which automatically groups similar vectors together (either in a flat or hierarchical fashion to a specified depth). In some embodiments, the results of the mapping mechanism can be stored in an issue graph model, as described in further detail below. Accordingly, any of the embodiments described below in reference to generating and analyzing an issue graph may incorporate the methods described herein regarding the use of multi-sectioned documents and vice versa.

In some embodiments, a text analysis module 1809 may determine the sentiment of a comment stored in database 1801. The sentiment may include a stance, position, or an argument, or general disposition toward the multi-sectioned policy document, or the like, with varying degrees of stance, position, of disposition. In some embodiments, the sentiment of a comment may express support for one section and opposition towards a different section of the multi-sectioned document (or may express neither support nor opposition). In other embodiments, the sentiment of a comment may be either positive, negative, or neither. In some embodiments, there can be more than one sentiment associated with each comment. In yet further embodiments, the text analysis module 1809 may also determine the levels of influence of each comment (e.g., based on the author of the comment), and weigh each comment based on an influence level. For example, different commenters may be given a higher or lower influence level, which may then be applied to that author's comment. As a further example, a comment authored by Morgan Stanley may be deemed to have a higher influence on a proposed SEC rule than a comment from a local grocer. In some embodiments, a text analytics filter may be applied to the text data.

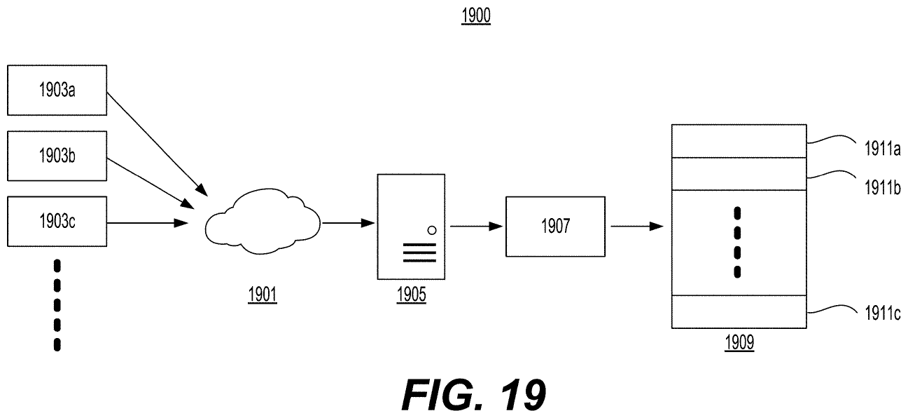

FIG. 19 is a depiction of an exemplary auto-correlation system consistent with one or more disclosed embodiments of the present disclosure. As depicted in FIG. 19, system 1900 may comprise a network 1901, a plurality of comments, e.g., comments 1903a, 1903b, and 1903c, a central server 1905, modules 1907, and at least one multi-sectioned document 1909 containing a plurality of sections, e.g., sections 1911a, 1911b, and 1911c. One skilled in the art may vary the structure and/or components of system 1900. For example, system 1900 may include additional servers—for example, central server 1905 may comprise multiple servers and/or one or more sources may be stored on a server. By way of further example, one or more comments may be distributed over a plurality or servers, and/or one or more comments may be stored on the same server.

Network 1901 may be any type of network that provides communication(s) and/or facilitates the exchange of information between two or more nodes/terminals and may correspond to network 101, discussed above. For example, network 1901 may comprise the Internet, a Local Area Network (LAN), or other suitable telecommunications network, as discussed above in connection with FIG. 1. In some embodiments, one or more nodes of system 1900 may communication with one or more additional nodes via a dedicated communications medium.

Central server 1905 may comprise a single server or a plurality of servers. In some embodiments, the plurality of servers may be connected to form one or more server racks, e.g., as depicted in FIG. 2. In some embodiments, central server 1905 may store instructions to perform one or more operations of the disclosed embodiments in one or more memory devices. In some embodiments, central server 1905 may further comprise one or more processors (e.g., CPUs, GPUs) for performing stored instructions.

In some embodiments, comments 1903a, 1903b, and 1903c may be gathered using internet scraping module 1805. For example, comments 1903a, 1903b, and 1903c may be gathered from open internet resources, such as legislative websites, regulatory websites, news websites, financial websites, and social media websites, or other data repositories provided by the user, such as proprietary data repositories, including those not hosted on the internet (e.g., repositories available on internal networks, user accessed networks, and the like). In some embodiments, central server 1905 may receive information about one or more comments, e.g., comments 1903a, 1903b, and 1903c over network 1901.

In some embodiments, additional analysis may be performed on the comments by the central server 1905 using modules 1907 (e.g., the modules 1907 may be the previously described association analysis module 1807 and/or text analysis module 1809). As a result of this analysis, a multi-sectioned document 1909 may be analyzed by the system. For example, central server 1905 may use text analysis module 1809 to determine the influence level of the comment, and apply a corresponding weight to each comment 1903a, 1903b, and 1903c.

In some embodiments, the processor located in central server 1905 may be configured to predict, based on the weighted comments, a predicted outcome for the entire multi-sectioned document or a section of it. For example, the predicted outcome may be whether a section of the multi-sectioned document will be revised prior to adoption. For example, a section of the multi-sectioned document 1909 that has many weighted comments associated with it may provide the system with information for predicting that the section may be revised prior to adoption. In other embodiments, the processor located in central server 1905 may be configured to predict, based on the weighted comments, which sections of the multi-section document 1909 may change. In yet other embodiments, the processor located in central server 1905 may be configured to predict, based on the weighted comments, how likely an agency will change at least one section of the multi-sectioned document 1909.

In some embodiments, the processor located in central server 1905 may be configured to determine that, based on the weighted comments, one or more changes will be made to at least one section of the multi-sectioned document 1909. In other embodiments, the processor located in central server 1905 may be configured to recommend, based on the weighted comments, changes in language to a section of the multi-section document 1909 in order to increase a likelihood of adoption.

In some exemplary embodiments, the sections 1911a, 1911b, and 1911c of the multi-sectioned document 1909 may include officially delineated parts of the document, syntactically defined units of text (e.g., a sentence, paragraph, page, or multiple pages), subjectively defined units of text (e.g., a chapter), where the subjectively defined units of text may share a property (e.g., relating to the same subject area or performing the same action).

For example, within multi-sectioned document 1909, section 1911a may be in the introduction part of the document, section 1911b may be the argument part of the document, and section 1911c may be the conclusion of the document. In other embodiments, within multi-sectioned document 1909, sections 1911a, 1911b, and 1911c may each be a single page or multiple pages.

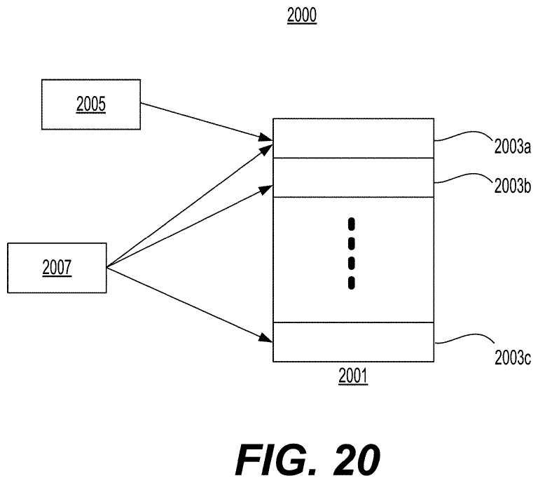

FIG. 20 is an example of a multi-sectioned document with correlated comments. For example, FIG. 20 may represent a visualization 2000, which may be displayed to a user on a user interface of a device (e.g., a display screen, a laptop, a handheld device such as a smartphone, or tablet, or a smartwatch). In some embodiments, the visualization 2000 may include a graphical depiction of sentiment relative to the one or more sections of the multi-sectioned document 2001. As shown in FIG. 20, a multi-sectioned document 2001 may have a plurality of sections, e.g., sections 2003a, 2003b, and 2003c. The visualization 2000 may also include a first comment 2005, and a second comment 2007. As shown in FIG. 20, the first comment 2005 may be auto-correlated to only one section 2003a of the multi-sectioned document 2001 using association analysis module 1807 and/or text analysis module 1809 as described above. Second comment 2007 may be associated with additional sections of multi-sectioned document 2001, i.e., sections 2003a, 2003b, and 2003c. In some embodiments, the visualization 2000 may include extracted text from the multi-sectioned document 2001 juxtaposed with textual representations of sentiment found in a comment 2005 or 2007. As described above, the sentiment of a comment 2005 or 2007 may express support for one section (i.e., 2003a, 2003b, and 2003c) and opposition towards a different section of the multi-sectioned document 2001.

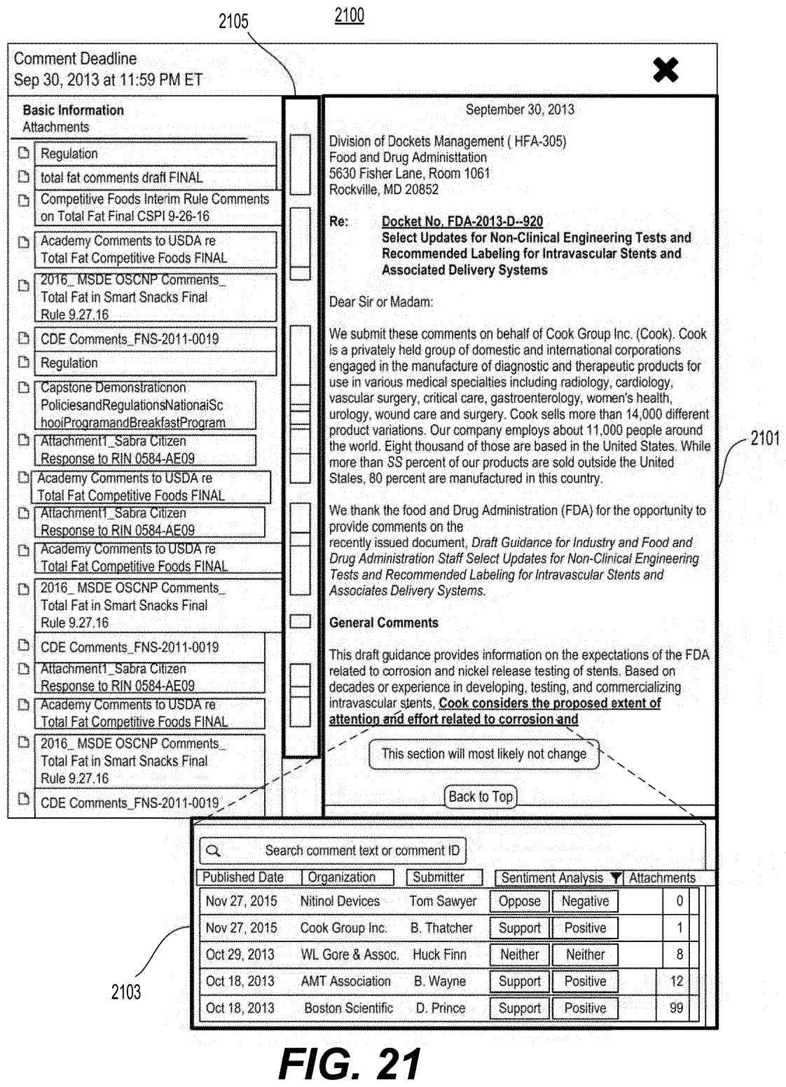

FIG. 21 is a depiction of an exemplary multi-sectioned document with correlated comments. For example, visualization 2100 may include a multi-sectioned document 2101, which may be displayed to a user on a user interface of a device (e.g., a display screen, a laptop, a handheld device such as a smartphone, or tablet, or a smartwatch). In some embodiments, the visualization 2000 may include a graphical depiction of sentiment relative to the one or more sections of the multi-sectioned document 2101. For example, a set of comments 2103 may be associated with a highlighted portion of multi-sectioned document 2101. In some embodiments, the system user may interact with a highlighted portion of multi-sectioned document 2101 to display additional information about a set of comments 2103, including the published date, organization, submitter, sentiment analysis, and attachments associated with the comments. In yet further embodiments, heatmap 2105 may highlight each section of multi-sectioned document 2101 in which positive, negative, supporting, opposing, or neutral language appears. The heatmap 2105 may display various colors associated with a section of multi-sectioned document 2101 to indicate the various language being used.

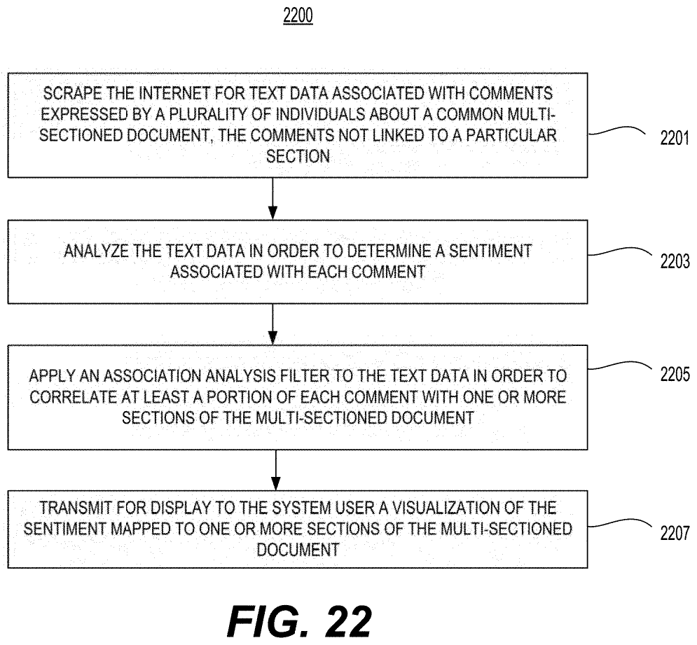

FIG. 22 is an example of an auto-correlation method 2200, consistent with the disclosed embodiments. Method 2200 may, for example, be executed by one or more processors of a server (e.g., central server 105 of FIG. 1) or any other appropriate hardware and/or software. Further, when executing method 2200, the one or more processors may execute instructions stored in any one of the modules discussed above.

In step 2201, the server may scrape the internet for text data associated with comments expressed by a plurality of individuals about a common multi-sectioned document, the comments not being linked to a particular section of the multi-sectioned document. For example, comments may be gathered from open internet resources, such as legislative websites, regulatory websites, news websites, financial websites, and social media websites, or other data repositories, such as proprietary data repositories, including those not hosted on the internet (e.g., repositories available on internal networks, user accessed networks, and the like).

In step 2203, the server may analyze the text data in order to determine a sentiment associated with each comment. The sentiment may include a stance, position, or an argument, or the like, as described above. In some embodiments, the sentiment of a comment may express support for one section and opposition towards a different section of the multi-sectioned document (or may express neither support nor opposition). In other embodiments, the sentiment of a comment may be either positive, negative, or neither. In yet further embodiments, the text analysis module 1809 may also determine the levels of influence of each comment (e.g., based on the author of the comment), and weigh each comment based on an influence level. For example, different commenters may be given a higher or lower influence level, which may then be applied to that author's comment.

In step 2205, the server may apply an association analysis filter to the text data in order to correlate at least a portion of each comment with one or more sections of the multi-sectioned document. For example, sections of the multi-sectioned document may be explicitly indicated in the comment (through citation, linking, and the like), or they may be implicit. Implicit mentions of the multi-sectioned document sections in the comment may be mapped from the comment to the multi-sectioned document through a mapping mechanism of association analysis module 1807.

In step 2207, the server may transmit for display to a system user a visualization of the sentiment mapped to one or more sections of the multi-sectioned document, as shown in FIGS. 20 and 21.

While the disclosure above has focused on primarily on predicting the outcomes for comments made in relation to a regulation, and associating comments and stances to rules, and subsections of rules, these analyses may also be performed in other policymaking areas, such as legislation. For example, comments made in support or opposition of a piece of legislation may be associated with specific sections of the legislation, the stance and arguments of those comments may be computed, and a resulting prediction made to the likelihood of a section of the legislation changing or being enacted.

Predicting Policy Adoption

Once a policy (e.g., a rule) is promulgated, a set of potential outcomes may include the likelihood of policy promulgation (e.g., the likelihood that the rule will be adopted), information related to the timeline of the policymaking process (e.g., the estimated amount of time until a rule is voted on, adopted, or denied), arguments made for or against the policy, likelihood of enforcement (e.g., regulatory enforcement), the form in which the document will be finalized (e.g., what language may be included in the rule), the impact of the policy (including favorability and significance), and the factors helping or hurting the likelihood of any aforementioned potential outcome, where these factors helping or hurting the likelihood may include people or events. In some embodiments, the same may be determined regarding a legislative bill.

As previously discussed, in some embodiments, analysis of comments, which may often number in the millions of comments per rule, may be useful for understanding what the outcome of the final rule may be.

In some embodiments, this set of potential outcomes may be predicted using a model to generate a predicted outcome. Thus, in some embodiments, predicted outcomes of a policy may be generated by analyzing the comments associated with a policy. In other embodiments, the predicted outcomes of a bill may be generated by analyzing the comments associated with a bill. Furthermore, the arguments from the comments may be aggregated to predict how the policy may change. For example, if one or more comments on a given policy suggest the policy lacks clarity, is based on bad science, or is an overreach, or the like, a predicted outcome for that policy may be that it will include modified language (e.g., additional clarifying language, additional scientific reporting, additional justifications for authority), or removal of language.

In some embodiments, various data may be used within the model constructed for predicting if a policy will take effect, when a policy will take effect, what language will be modified and retained in the final version, how likely it is to be challenged, or how likely is it to be enforced. For example, the data used may be any combination of the following: the previous timelines of policies promulgated by the authoring agency, the number of currently considered policies, the text of the policy itself, the statute or act the policy is drawing its authority from, the number of comments, the arguments determined from comments, the authoring organizations of comments, similar policies from other agencies, other unrelated data as discussed above, and the like.

The comments may be associated with portions (e.g., sections) of the policy, allowing analysis to be applied to each subsection of the document. For instance, if one or more comments against the policy and arguing for clarity may be associated with a particular section of the policy, a predicted outcome for the policy may be that the associated section will be clarified. In another embodiment, the predicted outcome of a policy may be how likely a particular section of a policy is to be challenged, or how likely a policy and/or sections of a policy are to be enforced.

In some embodiments, the server may determine the predicted outcomes of a policy and their associated likelihood based on model generated from the scraped data. The scraped data used to create this model may rely on the comments themselves, related documents, and analysis thereof, including the content (e.g., some or all of the text data, terms, and other derived linguistic analysis consistent with the disclosure above) or metadata (e.g., dates of activity, author of comment, authors organization, and the like). For example, the server may apply one or more models with some or all of the scraped data as one or more inputs. Instead of using raw scraped data, the server may extract one or more features from the data, as discussed above, to use as inputs for the model.

In some embodiments, this automated model and analysis may be carried out in various ways. As described above, a document or policy may be represented as a feature vector, and a function may be created which produces an association between the feature vector and the outcome. This function may be used to compute a score, which may be a likelihood score, or a probability, reflecting how likely a given document or policy is to result in certain predicted outcomes. For a comment, this score relays the likelihood of predicted outcomes (e.g., who and where the comment is from, does the author of the comment support the policy, the gravitas of the commenter, what arguments are being made, and the like).

In some embodiments, the comment may be represented by the identity of the author. Specifically, the feature vector representing the comment may only include the identity of the comment's author, without any further analysis of the document. In some embodiments, the scoring mechanism of the function to compute a likelihood score for a given comment document supporting the policy may then be based on a count of how many comments this author has submitted in the past that have been opposed to policies, or may be further divided by regulation on this topic, or from an agency.

The comment may also be represented by a feature vector comprised of some or all of the text, including terms and other derived linguistic analysis and metadata (e.g., dates of activity, the individual or organizational author, whether the comment is a commonly-used template or unique, and the like) associated with the comment document. Linguistic analysis used may include sentiment dictionaries, parsers for detecting various syntactic patterns, and other knowledge bases. In some embodiments, the features derived from analysis of the document may be combined with features derived from analysis of the author, forming a larger feature vector. In some embodiments, the analysis methods described herein used to generate the feature vector may use machine learning techniques.

Author related characteristics may include whether the author is an individual or an organization, where organization may be further divided into public, private, large, small, or a number of other designations. Authors may have further associated features, such as geography, previous activity, such as submitted comments, relationships to regulators, financial contributions, campaign financials, previous regulations supported, collaboration with other organizations or policymakers, public statements, news, and external information based on online social presence.

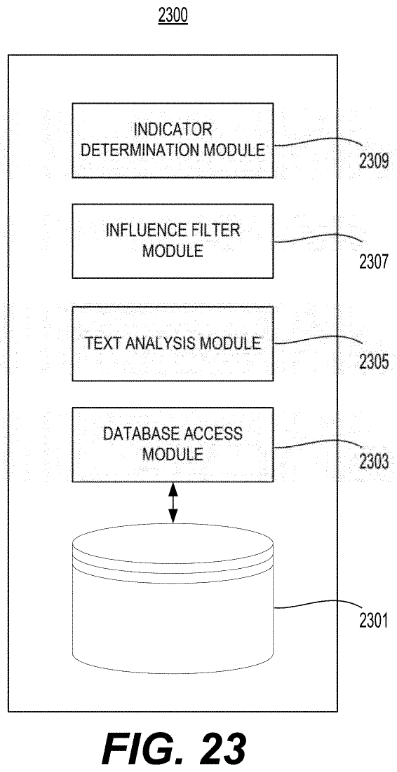

FIG. 23 is a memory 2300 consistent with the embodiments disclosed herein. In some embodiments, memory 2300 may be included in, for example, central server 105, discussed above. Further, in other embodiments, the components of memory 2300 may be distributed over more than one location (e.g., stored in a plurality of servers in communication with, for example, network 101).

Memory 2300 may include a database 2301, which may store information about the proposed policy and comments. Memory 2300 may also include database access module 2303, which may be used to access information stored in database 2301 about a proposed policy or comment. In some embodiments, the comments stored in database 2301 may be public comments on the one or more proposed policies. The information stored in database 2301 may be gathered through a variety of sources, for example, one or more of sources 103a-103c, as shown in FIG. 1 via, for example, network 101 (e.g., the internet).

In some embodiments, a text analysis module 2305 may determine the sentiment of a comment stored in database 2301. The sentiment may include a stance, position, argument, or the like, as described above. In some embodiments, the sentiment of a comment may express support for one or more sections and opposition towards a different section of the policy (or may express neither support nor opposition). In other embodiments, the sentiment of a comment may be either positive, negative, or neither. A potential outcome of text analytics filter module 2305 may be the stance that the comments author is taking regarding the proposed policy.

In some embodiments, the text analysis module 2305 may be applied to the text data in order to determine a sentiment, including matching at least one piece of text data from the comment to at least one other piece of text data stored in a database. For example, text analysis module 2305 may associate each comment with a predicted stance (e.g., where a stance may be supporting, opposing, or neutral), and the average stance may be taken as the predicted outcome of the policy, where if the average stance is negative, the predicted outcome is for the policy to not be adopted in the current form, and if the current stance is positive, the predicted outcome is for the policy to be adopted. The function to compute stance can be represented by a model derived from machine-learned algorithms or other computer-implemented policies, the model comprised of policies, weights, and the like, in accordance with other models described in the present disclosure.

In some embodiments, the comments stored in database 2301 may have their influence determined using influence filter module 2307. For example, influence filter module 2307 may also determine the levels of influence of each comment (e.g., based on the author of the comment), and weigh each comment based on an influence level. For example, different commenters may be given a higher or lower influence level, which may then be applied to that author's comment.

In some embodiments, the influence filter module 2307 may access a database of terms associated with a heightened degree of influence. For example, these terms associated with a heightened degree of influence may include zip codes, organizations names, or addresses. In some embodiments, the system may automatically assign a heightened degree of influence to specific terms, or alternatively, a user may input terms with which to assign a heightened degree of influence.

In some embodiments, an indicator determination module 2309 may generate an indicator associated with a proposed policy. In some embodiments, the indicator determined by indicator determination module 2309 is a likelihood measure reflecting a probability that the regulation will be adopted.

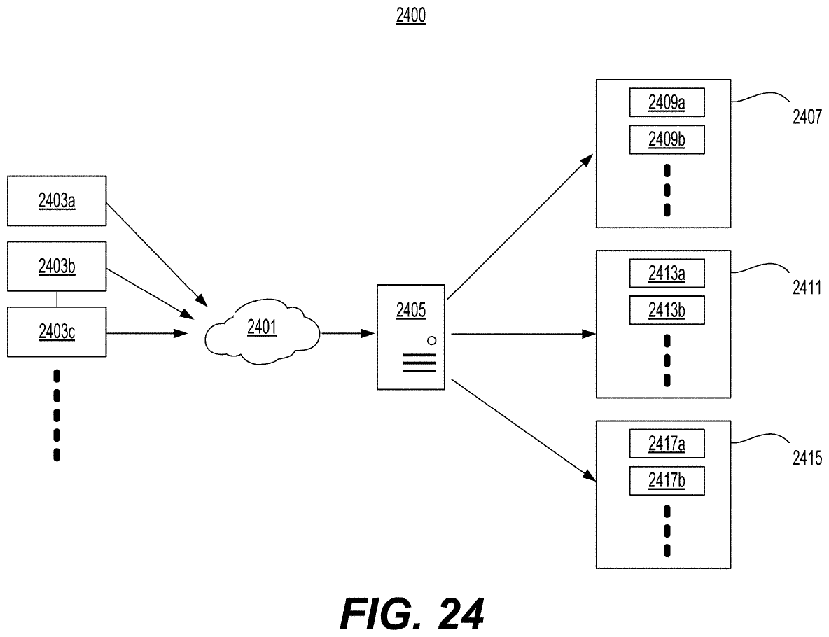

FIG. 24 is an example of a text analytics system consistent with one or more disclosed embodiments of the present disclosure. As depicted in FIG. 24, system 2400 may comprise a network 2401, a plurality of comments, e.g., comments 2403a, 2403b, and 2403c, a central server 2405, comments weighted with high influence 2407, comments weighted with average influence 2411, and comments weighted with low influence 2415. One skilled in the art may vary the structure and/or components of system 2400. For example, system 2400 may include additional servers—for example, central server 2405 may comprise multiple servers and/or one or more sources may be stored on a server. By way of further example, one or more comments may be distributed over a plurality or servers, and/or one or more comments may be stored on the same server.

Network 2401 may be any type of network that provides communication(s) and/or facilitates the exchange of information between two or more nodes/terminals and may correspond to network 101, discussed above. For example, network 2401 may comprise the Internet, a Local Area Network (LAN), or other suitable telecommunications network, as discussed above in connection with FIG. 1. In some embodiments, one or more nodes of system 2400 may communication with one or more additional nodes via a dedicated communications medium.

Central server 2405 may comprise a single server or a plurality of servers. In some embodiments, the plurality of servers may be connected to form one or more server racks, e.g., as depicted in FIG. 2. In some embodiments, central server 2405 may store instructions to perform one or more operations of the disclosed embodiments in one or more memory devices. In some embodiments, central server 2405 may further comprise one or more processors (e.g., CPUs, GPUs) for performing stored instructions.

In some embodiments, the processor located in server 2405 may be configured to apply an association analysis filter to the text data in order to correlate at least a portion of each comment with a particular section of the proposed regulation 2409.

In some embodiments, comments 2403a, 2403b, and 2403c may be stored in database 2301. In some embodiments, central server 2405 may receive information about one or more comments, e.g., comments 2403a, 2403b, and 2403c, over network 2401. Although discussed in connection with central server 2405, the preceding disclosure is exemplary in nature, and the execution of the method may be distributed across multiple devices (e.g., servers).

In some embodiments, the central server 2405 may weigh the comments 2403a, 2403b, and 2403c, into a plurality of categories. For example, central server 2405 may use text analysis module 2305 and influence filter module 2307 to weigh comments, consistent with the disclosure above. After weighing the comments, central server 2405 may categorize the comments into one or more categories. As shown in FIG. 24, comments may be categorized into comments weighted with high influence 2407 (e.g., comments 2409a, 2409b), comments weighted with average influence 2411 (e.g., comments 2413a, 2413b), and comments weighted with low influence 2415 (e.g., comments 2417a, 2417b). More comment categories can be included by central server 2405 as desired.

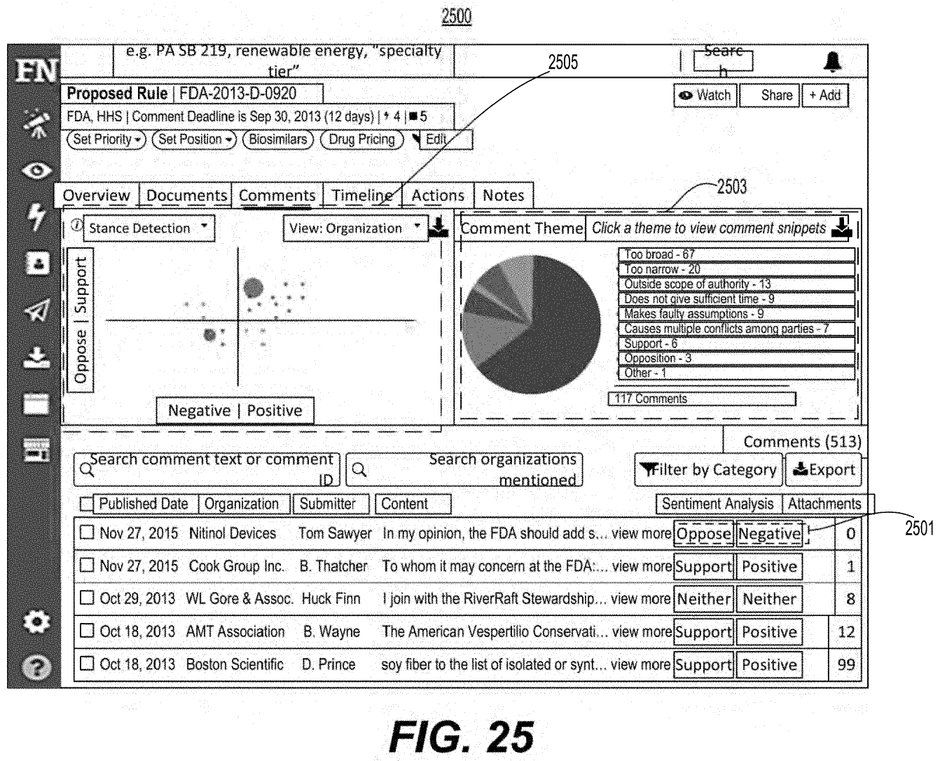

FIG. 25 is a depiction of an example of a prediction with an indicator associated with adoption of the regulation. For example, sentiment indicator 2501 may depict the sentiment associated with a particular comment, comment theme indicator 2503 may depict various arguments associated with the comments, and stance detection indicator 2505 may depict graphically various stances taken within the comments. For example, text analysis module 2305 may be applied to the text data of a comment in order to generate a sentiment indicator 2501 associated with a comment. For example, as shown in FIG. 25, the sentiment indicator 2501 generated by text analysis module 2305 may show that the comment supports or opposes the policy (or neither). Similarly, the sentiment indicator 2501 generated by text analysis module 2305 may show that the comment contains positive or negative language (or neither). The information analyzed by text analysis module 2305 may also be used to generate comment theme indicator 2503 and stance detection indicator 2505.

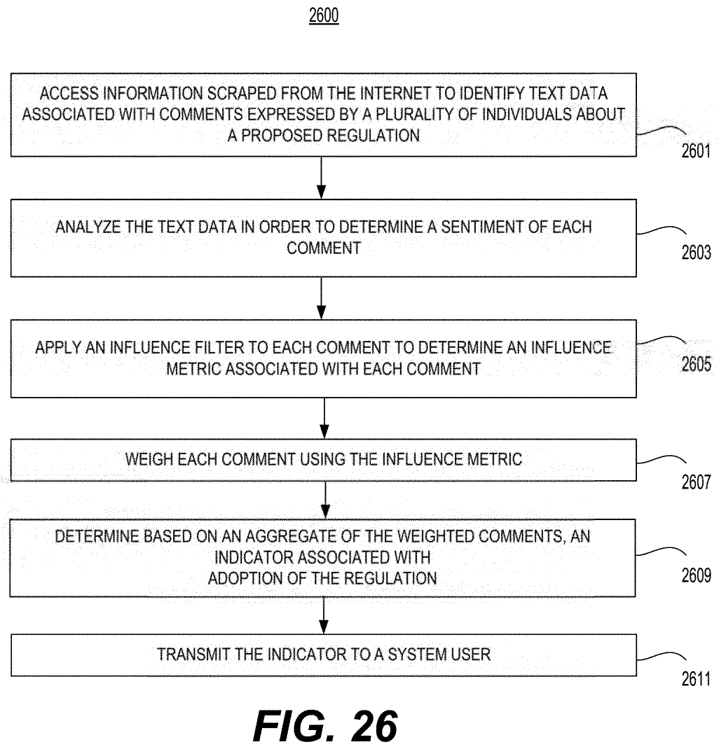

FIG. 26 is a flow diagram of an example of a method 2600 for predicting whether a regulation will be adopted. Method 2600 may, for example, be executed by one or more processors of a server (e.g., central server 105 of FIG. 1) or any other appropriate hardware and/or software. Further, when executing method 2600, the one or more processors may execute instructions stored in any one of the modules discussed above.

At step 2601, the server may access information scraped from the internet to identify text data associated with comments expressed by a plurality of individuals about a proposed regulation. For example, the text analytics system may access comments stored in database 2301, containing comments related to a specific proposed regulation.

At step 2603, the server may analyze the text data in order to determine a sentiment of each comment. For example, the server may analyze the text data of a comment in order to determine a sentiment, which may include matching at least one piece of text data from the comment to at least one other piece of text data stored in a database. Furthermore, the text analytics filter may associate each comment with a predicted stance (e.g., where a stance may be supporting, opposing, or neutral), and the average stance may be taken as the predicted outcome of the policy, where if the average stance if negative, the predicted outcome is for the policy to not be adopted in the current form, and if the current stance is positive, the predicted outcome is for the policy to be adopted.

At step 2605, the server may apply an influence filter to each comment to determine an influence metric associated with each comment. As described above, the influence metric may be determined using a variety of factors. For example, dates of activity, the individual or organizational author, whether the comment is a commonly-used template or unique, and the like.

At step 2607, the server may weigh each comment using the influence metric. For example, influence filter module 2307 may also determine the levels of influence of each comment (e.g., based on the author of the comment), and weigh each comment based on an influence level. For example, different commenters may be given a higher or lower influence level, which may then be applied to that author's comment. Other factors that may be considered may include who and where the comment is from, whether the author of the comment supports the policy, the gravitas of the commenter, what arguments are being made, and the like

At step 2609, the text analytics system determines, based on an aggregate of the weighted comments, an indicator associated with adoption of the regulation. For example, the indicator determined in this step by indicator determination module 2309 is a likelihood measure reflecting a probability that the regulation will be adopted (e.g., a percentage).

At step 2611, the server may transmit the indicator to a system user. For example, this indicator may be a comparative indicator expressed through text (e.g., whether the policy is “more likely” or “less likely” to be approved when compared to another policy), expressed as a percentage (e.g., “53.5% chance for being promulgated unchanged in this form,” “92.5% of Section 3 changing,”), or expressed in a number of votes (e.g., “43 Senators likely to vote yes”).

While the disclosure above has focused on primarily on predicting the outcomes for comments made in relation to a regulation, and associating comments and stances to policies, and subsections of policies, these analyses may also be performed in other policy areas, such as legislation. For example, comments made in support or opposition of a piece of legislation may be associated with specific sections of the legislation, the stance and arguments of those comments may be computed, and a resulting prediction made to the likelihood of a section or the entirety of the legislation changing or being enacted.

Generation of Issue Graphs and Inference Based on Generated Issue Graphs

As described in more detail below, the disclosed embodiments may include systems and methods for generating and analyzing policy, policymaker and organizational entities and relationships through construction and inference in an issue-based graph modeling framework. It is contemplated that automatically analyzing electronic structured and unstructured data related to legislative, regulatory, and judicial processes to compute entities and their relationships in a graph model and create policy, policymaker and organizational issue graphs may provide a potential technical advantage by allowing efficient storage and inference of important contextual information, even when the data is ingested from many disparate sources, which tend to be very difficult to keep track of, particularly with respect to how the data is connected and the different types of relationships that can be inferred (including, e.g., similarities, citations, key phrases, topics and the like inferred from structured and/or unstructured data). In this manner, the systems and methods disclosed herein may analyze policy, policymaker and organizational issue graphs, automatically identify connections between one or more entities, make new inferences from these connections, and display one or more connections, as will be described below.

It is also contemplated that analyzing policy, policymaker and organizational issue graphs may allow users to identify important stakeholders, organizations, and policies. For example, it may be difficult for the users to track from start to finish a policymaking process when multiple policy making bodies are involved in the process. Furthermore, a policymaking process may involve various types of news, social posts, reports, meetings, legislation, statutes, rules, administrative codes, and may use various types of terminologies, names, and citations. Therefore, the users may appreciate the systems and methods disclosed herein. For example, the disclosed systems and methods may automatically identify and infer connections between entities to generate issue graphs and identify relevant issues based on the issue graphs. Based on the information provided through the disclosed embodiments, the users may identify the relevant issues at various stages of the policymaking process more efficiently than with existing tools, as described above. For example, the systems and methods disclosed herein may enable the users to determine what issues are important when a policy is first introduced, what issues are likely to be affected later in the process, how the user may subsequently be affected from enforcement of the policy, and what issues may result in litigations and the like.

Issue graphs may also be used to help users understand how the users and/or organizations can influence decision making. Users may want to know which policymakers, stakeholders, and organizations are interested, influential, aligned, for/against their positions, how amenable the policymakers are to changing their positions, and what channels of communication/access the users have for getting to the policymakers. Furthermore, as will be described in detail below, the issue graphs disclosed herein may also include various types of metrics to suggest to users and/or organizations which policymakers, stakeholders, and organizations are relevant to an issue and how accessible these policymakers may be.

In some embodiments, a user of system 100 (including, e.g., policymaking users or non-policymakers) may maintain a list of user-selectable agenda issues. In some embodiments, the non-policymaker may include a user of an electronic system that has a position, posture, such as level of significance rating, risk rating or impact assessment rating on an issue. In some embodiments, system 100 may present to the user, via a user interface, the list of user-selectable agenda issues, wherein each of the listed user-selectable agenda issues may be configured to be selected by the user via input received from the user. System 100 may also receive, via the user interface, agenda issues of interest to an organization. In some embodiments, the agenda issues of interest to the organization may be selected from the list of user-selectable agenda issues.

In some embodiments, system 100 may also receive, via the user interface, user issue graph data. The user issue graph data may represent proprietary user data, including, e.g., one or more non-policymaker identity and one or more activity performed by a non-policymaker. System 100 may also compute an issue graph model represented as a network of connections or lack thereof between user issue graph data and policymakers on each of the agenda issues selected as being of interest to the organization, and transform the issue graph model into a graphical display that presents the issue graph of each of the agenda issues that were selected as being of interest to the organization. In some embodiments, the issue graph of each of the agenda issues selected as being of interest to the organization may be presented with the one or more calculated metrics selected by the user.

As will be described in more details below, an issue graph is a type of knowledge graph, which is a structured representation of knowledge about how entities are connected to each other by relationships. A knowledge graph may be a type of graph, G=(N,E), which can be defined as a set of nodes in the graph, N, and a set, or list, of edges, E, between nodes of the graph. A graph is often used to represent information about relationships. In some embodiments, system 100 may construct a knowledge graph in which nodes may contain an id, a version, a key and zero, one, or more properties. Each node property may contain a tuple of a node property field paired with a node value. In some embodiments system 100 may further contain a confidence score representing the robustness of the identification in the node property tuple. The confidence score may further be represented using decimals, integers, or any other appropriate scale.

Also, the nodes in the knowledge graph may be labeled with zero, one, or more labels, and they may have zero, one, or more edges creating a link to one or more other nodes. System 100 may construct a knowledge graph in which edges may have an id, a version, a key, and may be directed or undirected and may have zero, one, or more properties. Also, edges may be labeled with zero, one, or more labels, and the edges may be weighted (e.g., with numbers assigned to the edges). In some embodiments, edges may be between two distinct nodes, or self-referential to the same node, and there may be zero, one, or more edges (e.g., multiple, parallel edges) connecting any two nodes in the graph. In this manner, two nodes in the knowledge graph may be unconnected, connected by one edge, or connected by more than one edge.

Typically, entities are represented as nodes and relationships are represented as edges, or links in a knowledge graph. The entities, depicted as nodes, and relationships, depicted as links between the nodes, may be implemented using various techniques. The knowledge graph may also be implemented using various techniques, including, e.g., databases such as relational databases, non-relational databases, document-based databases, key-value databases, graph databases, triplestore databases, and the like, or flat files.

An issue graph is a knowledge graph related to a specific issue. System 100 may construct an issue graph by the inclusion of nodes representing entities within a particular issue and links representing relationships between the various entities. System 100 may carry out inference over an issue graph (and more generally, a knowledge graph) by traversing one or more paths, e.g., in real-time through nodes and links, to uncover different nodes that might be related to each other. In some embodiments, an issue graph may be a subgraph, or partial graph, from the complete graph, where the subgraph is a proper subset of the complete graph.

In some embodiments, system 100 may construct an issue graph including nodes representing one or more types of entities. An entity may be associated with, e.g., a document, a person, an organization, an event, or a data field. A document may include, e.g., a news article, a policy analysis, a press release, a regulatory filing (e.g., SEC Form 10-K), a Wikipedia™ article, a company description, a piece of legislation, an administrative rule, a section of code or regulation (e.g., United States Code or Code of Federal Regulations), an electronic content (e.g., a tweet, email, comment, or an online posting), a draft of a bill, a testimony, a draft of a testimony, a transcript, an enforcement action, a judicial opinion, and the like.

Properties of document nodes may include date(s) of publication, title, description, file format, author, language, etc. System 100 may represent documents using document vectors described above, which may be appropriately computed for machine analysis, including analysis of linguistic patterns and the like. In some embodiments, system 100 may project documents using a transformation function into a different dimensionality space suitable for machine learning. System 100 may apply a transformation function that projects documents into multidimensional vectors computed by embedding linguistic patterns (characters, tokens, words, phrases, sequences) into multidimensional embedding layers. It is contemplated that various techniques may be utilized to compute the embedding, including, e.g., word2vec, Global Vectors (GloVe), Bidirectional Encoder Representations from Transformers (BERT), ELMo, and the like.

In some embodiments, a node of the issue graph may represent an entire document. Alternatively, or additionally, a document may be split into appropriate levels of granularity (e.g., versions, titles, sections, chapters, paragraphs, etc.) and the document or a part thereof may be represented by multiple nodes in the issue graph. For example, system 100 may include a splitting module, which may be used to split a document into multiple subparts. Each subpart may then be represented as different nodes in an issue graph. Various methods may be used to identify subparts of a document. In some embodiments, the splitting module may be configured to split a document based on elements of the document. For example, the splitting module may identify a title, description, summary, individual sections, body, conclusion, or other portions of the document. These may be determined based on the document itself or based on metadata that may indicate the beginning and/or ending points of elements of the document. In some embodiments, the subparts may be determined based on syntactic breaks, such as page, paragraph, section, or other breaks, in the document. In some embodiments, the splitting module may perform a semantic analysis, which may be used to identify a change in topic, a change in author (e.g., based on changes in style or tone), or any other transitions that may be identified based on a semantic analysis of the text of a document.

Accordingly, each section of a multi-sectioned document may be represented by a different node and may have different node properties. As described above, multi-sectioned documents may have different predicted outcomes for each section. For example, a first section of a bill may be enacted, while a second section may be removed prior to enactment. Similarly, each section of a document may be associated with different individuals (e.g., authored by different policymakers, etc.), may have different associated dates, may draw support from different organizations, or the like. The issue graph may be generated to represent these differences between sections or subparts of a document. In some embodiments, these subparts may be linked in the subgraph to indicate they are within the same document (e.g., with an edge having a “same_document” label, grouping the subparts together in the graph, or the like).

The issue graph may also include one or more nodes representing one or more persons. Such persons may include, users of the system, or non-users, e.g., government staffers, legislators, regulators, governors, clerks, judges, ministers, and the like, corporate employees and officers (e.g., CEOs, VPs, Directors, etc.) and the like, and members of the public. The issue graph may further include one or more nodes representing one or more organizations. Such organizations may include, e.g., public or private companies, government agencies, policymaking committees, non-profit organizations, etc. The issue graph may further include one or more nodes representing one or more events. Such events may include, e.g., committee hearings, meetings, conferences, summits, geopolitical events, and the like. In some embodiments, the issue graph may further include one or more nodes representing one or more data fields. Such data fields may include, e.g., miscellaneous metadata such as key terms, legal citations, location information, date/time, subject areas, etc. In some embodiments, system 100 may additionally contain representations of non-document nodes, e.g., nodes corresponding to persons, organizations, or events, based on output of analysis of textual content contained in one or more properties of the node, or selected document having a relationship with the nodes corresponding to the persons, organizations, or the events. In some embodiments, nodes representing topics, key phrases, and the like may be derived from a selected set of documents. In some embodiments, a non-document node (e.g., person, organization, event, etc.) may be represented as a multidimensional vector by embedding the node. In some embodiments, a document, person, organization, or event node may be represented as a multidimensional vector computed with a graph-based method for aggregating the embedding representations(s) of the selected node(s) having a relationship with the corresponding node.

In some embodiments, system 100 may compute a first embedding by applying a transformation function that projects nodes corresponding to documents, persons, organizations, or events into multidimensional vector embeddings by computing a graph-based embedding of the nodes with a method that combines the embeddings of document nodes.

For instance, given a particular policymaker, the graph can be navigated from the legislator node to related document nodes, computing multidimensional vector embeddings of policy proposal by the policymaker, statements by the policymaker, news articles on the policymaker, and tweets by the policymaker. Further, the document embeddings may be aggregated in various ways (e.g., average, pooling, etc.) and the resulting embedding may be assigned as a multidimensional vector representing the policymaker. System 100 may employ various weighting strategies in computing the aggregation. For instance, the document embedding weight may be inversely proportional to the recency of the document node creation, thereby system 100 will assign higher weigh in the aggregation to more recent documents. As another example, the document embedding weight may be proportional to the frequency of interaction or level of activity a user has with the node, thereby system 100 will assign higher weight in the aggregation to more active nodes. In another instance, methods for computing multidimensional node embeddings with neural network architectures may be used, such as a graph attention network, a heterogenous graph attention network, and/or a graph convolutional neural network. In some embodiments, document nodes selected for embedding representation of an organization/person/event/document node may be determined by an issue graph. For example, the system may embed a person node using all the relationships the system has computed from that person to document nodes, or only to the document nodes that are documents in the specific issue graph, whether the issue graph is determined by system or user, or only document nodes of a particular one or more types of documents. As another example, the system may first embed a bill node using a contextual word embedding method, then compute a graph attention network using the other bills in the issue graph and recompute the embedding of the bill as the average of attention-based feature embeddings of bills it has relations within the issue graph. In some embodiments, document nodes may include system ingested or user-provided data (e.g., documents). In some embodiments, document and non-document nodes that correspond to a person, organization, or event may have multiple projections into multidimensional embedding vectors. For example, a person node can have different multidimensional embeddings in different issue graphs, depending on what node relationships were aggregated to create the multidimensional embedding for the node. For example, the representation of company X in user A's issue graph on an environmental protection issue may differ from the representation of company X in user A's issue graph on a bankruptcy issue, and may differ from the representation of company X and user B's issue graph on environmental protection, depending on the other nodes present in each issue graph, respectively. As another example, an organization node can have different multidimensional embeddings depending on what aggregation technique was computed on the node relationships to create the multidimensional embedding for the node. System 100 may update a multidimensional node embeddings periodically. For example, a policymakers embedding vector may be recomputed as new policy document nodes are created in an issue graph. As another example, in a weighted aggregation based on recency, an organization embedding may be recomputed at a predetermined interval, e.g. daily, to update the organization embedding with decreasing weight applied to documents with an older publication date. In some embodiments, the initial document-node embedding itself may be updated using aggregate embeddings of document and/or non-document based nodes in the issue graph.

System 100 may compute a second embedding of non-document nodes corresponding to persons, organizations, or events by applying a transformation function that projects the nodes into multidimensional vector embeddings by computing a graph-based embedding of the nodes with a method that combines the embeddings of non-document nodes. For instance, given a particular organization, multidimensional embeddings of related organization nodes with similar industry type of relationship, similar geography type of relationship, and similar size type of relation may be aggregated and assigned as the multidimensional vector representing the organization.

System 100 may similarly compute an embedding vector using a combination of document and non-document node embeddings. For example, as a weighted average of first embedding vector (using specified document nodes) and second embedding vector (using specified non-document nodes).

In some embodiments, the various nodes contained in an issue graph may form various kinds of relationships with each other. These relationships may be thought of as actions or properties of a pair of nodes that provide a semantic link between that pair of nodes. For example, relationships between a first node representing a first person and a second node representing a second person may include, e.g., <fist node> worked_with <second node>, <first node> similar_to <second node>, <first node> had_meeting_with <second node>, etc. Relationships between a first node representing a person and a second node representing a document may include, e.g., <first node> authored <second node>, <first node> voted_on <second node>, <first node> occurs_in <second node>, etc. Relationships between a first node representing a person and a second node representing an organization may include, e.g., <first node> gave_money_to <second node>, <first node > works_at <second node>, <first node > lobbied_on_behalf_of <second node>, etc. Relationships between a first node representing an organization and a second node representing a document may include, e.g., <first node> authored <second node>, <first node> occurs_in <second node>, <first node> opposed_to <second node>, <first node > impacted_by <second node>, etc. Relationships between a first node representing an organization and a second node representing an organization may include, e.g., <first node> similar_to <second node>, <first node > acquired_by <second node>, etc. Relationships between a first node representing a document and a second node representing a document may include, e.g., <first node> cited by <second node>, <first node> similar_to <second node>, <first node> modified_by <second node>, etc. Relationships between a first node representing a document and a second node representing a data field (e.g., metadata such as location, date, topics, key terms, etc) may include, e.g., <first node> locality_in <second node>, <first node> enforced <second node>, <first node> topic_area <second node>, <first node> introduced_on <second node>, <second node> occurs_in <first node>, etc. Relationships between a first node representing an organization and a second node representing a data field may include, e.g., <first node> headquartered_in <second node>, <first node> founded_on <second node>, etc. Relationships between a first node representing a person and a second node representing a data field may include, e.g., <first node> born_in <second node>, <first node> elected_on <second node>, etc. Relationships between a first node representing an event (e.g., a committee hearing or the like) and a second node representing a document may include, e.g., <first node> about <second node>, etc. Relationships between a first node representing an event and a second node representing a data field (e.g., a date) may include, e.g., <first node> occurred_on <second node>, etc. Relationships between a first node representing an event and a second node representing a person may include, e.g., <first node> attended_by <second node>, etc.

It is contemplated that the various relations described above are presented as examples and are not meant to be limiting. These relationships may be computed in various ways. For instance, in some embodiments, nodes representing persons may be programmatically compared against each other by a matching algorithm, and if they have similar name property field values (e.g., computing a Levenshtein distance between the first and last name property values results in a distance less than a predetermined threshold), or their demographics are similar (e.g., same age and geographic location, etc.), or if they have system usage activity indicating similar interest patterns, such as having favored similar bills, or if they are both deemed “similar_to” a common third node using any of the above methods, then they may be deemed “similar_to” each other and an edge may be established between the two persons with a label of “similar_to.” Alternatively, or additionally, two persons may be deemed “similar_to” each other based on the types of relations and/or node properties present, e.g., if they both have relations to data nodes that are similar, or if they hold similar positions, job titles, have similar professional backgrounds, political agendas, personal interests, political donors, etc., or if they both have relations to organization nodes that are similar, such as if they both worked at similar organizations, or were lobbied by similar organizations, etc., or if they both have relations to document nodes that are similar, such as if they both sponsored legislation on similar topics, etc., or if they both have relations to person nodes that are similar, such as if they both have relations to the same person, etc. Alternatively, or additionally, relations may be derived from a computational analysis carried out by the system. For instance, relations may be computed by computing similarity between textual content of two documents to create a “similar_to” relationship. For instance, after computing multidimensional embedding vectors representing two document nodes, system 100 may compute the cosine distance between the two vectors representing the two nodes. If the cosine distance is above a predetermined threshold, system 100 may determine the nodes are similar to each other and create a “similar_to” edge. As another example, after aggregating the specified document and non-document node embeddings to compute multidimensional embedding vectors for two organization nodes, system 100 may similarly compute the cosine distance between the two vectors representing the two nodes. If the cosine distance is below a predetermined threshold, system 100 may determine the nodes are not similar to each other and will not create a “similar_to” edge.

Relationships and properties may also be computed using available machine-trained models for named entity recognition, semantic role labeling, syntactic and semantic parsing, or relation extraction from unstructured data, i.e. from textual documents. For example, using an NER model to identify the appearance of a person name X in a Congressional transcript document, system 100 may utilize the language content surrounding the name (e.g. name followed by quoted text) to generate an edge from the document node to the person node with the label of “participated_in_meeting.” As another example, using an NER model to identify the appearance of a person name X followed by a job title Y, followed by organization name Z in a regulatory comment, system 100 may generate an edge from the person node X to organization Z with label “employed_by,” and may add a property field of “job_title” with value “Y” to the person node. As another example, using a relation extraction model to identify the occupation of businessman and inventor associated with an entity, system 100 may generate a property field of “occupation” with the values “businessman” and “inventor.” Alternatively, or additionally, users of the system may directly indicate one or more pairs of nodes and input a relation, such as “similar_to,” via a graphical user interface or an application programming interface (API, a computing interface that defines interactions between multiple software intermediaries).

Consistent with the disclosed embodiments, relationships may be computed using various methods for relation extraction. In some embodiments, relationships may be extracted from unstructured data. As used herein, unstructured data may refer to any information that is not stored according to a predefined data model or that is not organized in a predefined manner. For example, unstructured data may include data represented as text, for example, from textual documents. Unstructured data may include text but may include other information, such as numbers, graphs, tables, photos, or other information that may be analyzed. As one example of relationship that may be extracted from a text document, a person's name may be followed by quoted text from a Congressional transcript. The disclosed embodiments may infer a relationship between person and the forum for the transcript (e.g., a Congressional meeting or hearing where the person spoke). As another example, the person's name may appear in the unstructured text followed by a job title and an organization name. The system may be configured to infer a relationship of the person working for the organization. In some embodiments, this may include performing optical character recognition (OCR) on one or more documents to extract text data. This may further include semantic analysis for identifying names or other keywords or phrases identifying relationships based on surrounding text.

In some embodiments, a machine-trained model may be trained to extract relationships from unstructured data. For example, a training algorithm, such as an artificial neural network may receive training data in the form of unstructured data. The training data may be labeled such that relationships described herein are identified. As a result, a model may be trained to identify relationships within the unstructured data. Consistent with the present disclosure, various other machine learning algorithms may be used, including a logistic regression, a linear regression, a regression, a random forest, a K-Nearest Neighbor (KNN) model (for example as described above), a K-Means model, a decision tree, a cox proportional hazards regression model, a Naïve Bayes model, a Support Vector Machines (SVM) model, a gradient boosting algorithm, or any other form of machine learning model or algorithm.

In some embodiments, relationship properties may be arranged in a hierarchy, allowing the relationships to be sub-defined further. For instance, “topic_area” may include “primary_topic” and “secondary_topic”; “impact” may include “industry_impact,” “service_impact,” “product_impact,” “company_impact,” and “location_impact”; “legal_action” may include “required_to,” “repeal_of,” and “prohibition_on”; a “citation” may include “cited_by,” “references,” “modifies,” “authorizes,” “enforcement_of,” “litigation_on,” and “transformed_to_legal,” which may further include “enacted_as”; and “related” may include “same_as,” “similar_to,” “derived_from.” In some embodiments, “similar_to” may further include “similar_across_localities,” “similar_across_government_bodies,” “similar_ideologically,” “similar_geographically,” etc. It is to be understood that the relationships listed herein are provided as examples and are not meant to be limiting.

In some embodiments, a knowledge graph may be represented in the Resource Description Framework (RDF) format with (subject, predicate, object) triples, where the subject and object are represented by nodes, and the predicate is a property that is represented as the link between the subject and object nodes. In some embodiments, a knowledge graph may be represented with nodes and links in a native graph database operating on a graph data model. In some embodiments a knowledge graph may be represented as a hypergraph, where an edge may be a hyperedge, and connect any number of nodes. In some embodiments, a knowledge graph may be represented in a relational database, where the nodes are composed of data in the columns and rows of the tables, and links are relationships between the data items. It will be apparent to those skill-in-the art that while we refer to the data model as a graph, an equivalent data model could be created in a graph, non-relational, relational, key-value, and triplestore database, such as, but not limited to MySQL, PostgreSQL, Oracle, MongoDB, Amazon DynamoDB, Oracle NoSQL, Neo4J, Amazon Neptune, ArangoDB, AllegroGraph, or IBM DB2.

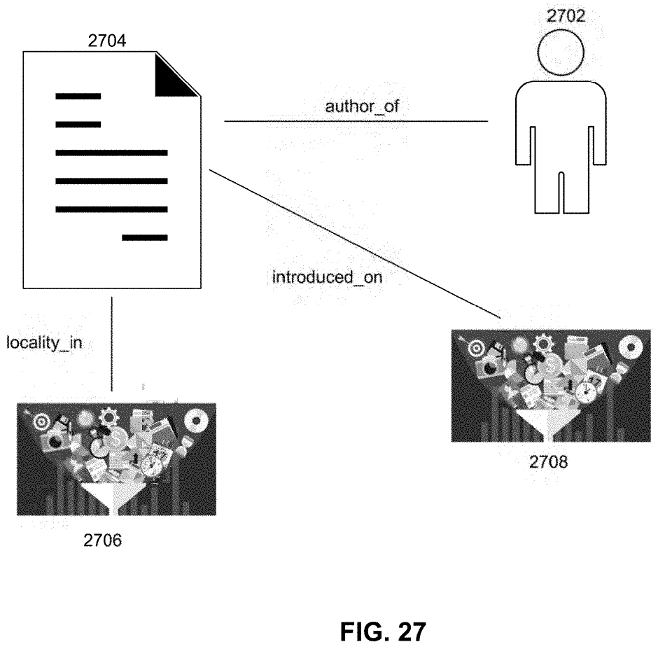

FIG. 27 illustrates an example issue graph representing knowledge about how a person 2702 is connected to a document 2704. In this example, the link connecting person 2702 and document 2704 indicates that person 2702 is the author of document 2704. In this example, document 2704 is also linked to two additional nodes 2706 and 2708, each representing a data field. In this manner, by traversing the issue graph, one can determine the locality associated with document 2704 and the date/time document 2704 was introduced.

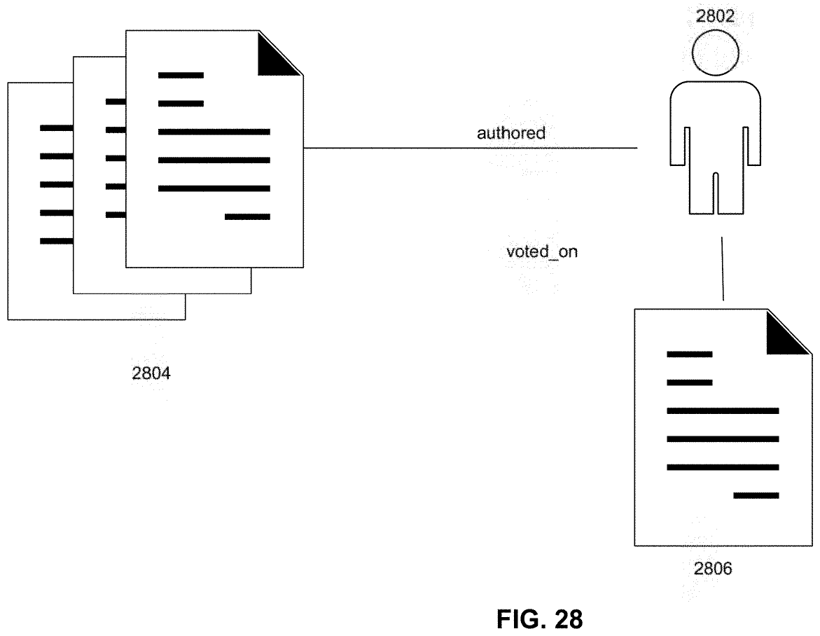

FIG. 28 illustrates another example issue graph representing knowledge about how a person 2802 is connected to various documents. In this example, the link connecting person 2802 and a plurality of documents, collectively referred to as 2804, indicates that person 2802 is the author of the plurality of documents 2804. The link connecting person 2802 and document 2806, on the other hand, indicates that person 2802 voted on document 2806.

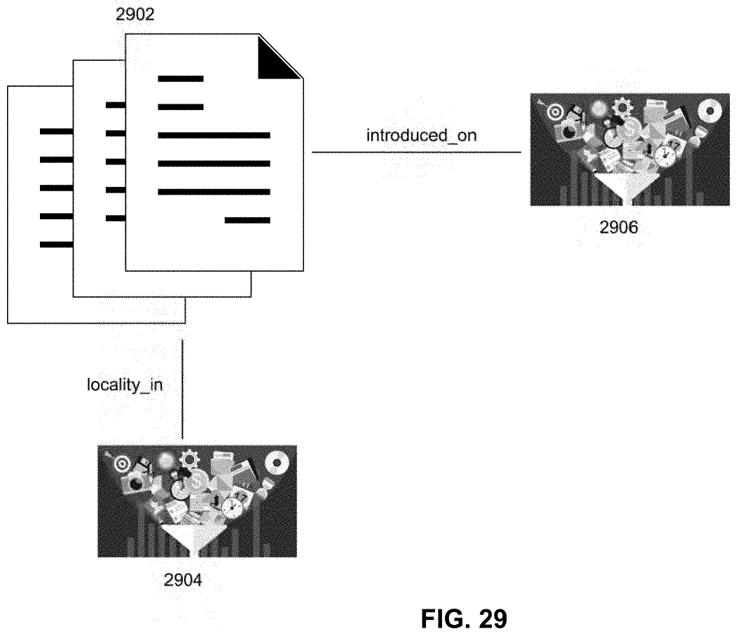

FIG. 29 illustrates another example issue graph representing knowledge about how a plurality of documents 2902 is connected to various data fields. In this example, the link connecting the plurality of documents 2902 and data field 2904 indicates the locality associated with the plurality of documents 2902. Similarly, the link connecting the plurality of documents 2902 and data field 2906 indicates the date/time the plurality of documents 2902 was introduced.

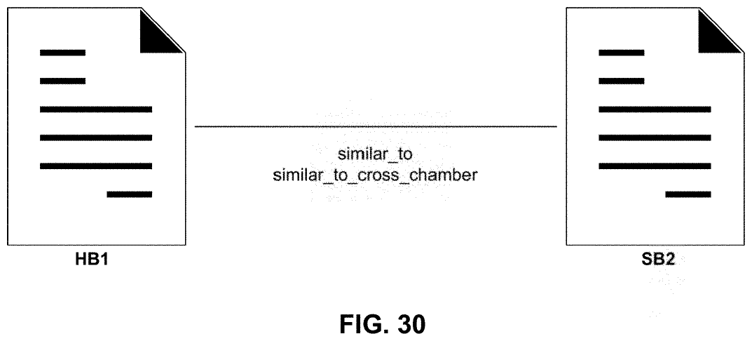

FIG. 30 illustrates another example issue graph representing knowledge about how two documents are related to each other. In this example, the link connecting a first document HB1 and a second document SB2 indicates that first document HB1 is similar to second document SB2. Additionally, in this example, the link also indicates that while first document HB1 and second document SB2 may be bills being considered in different government chambers (e.g., a house bill and a senate bill), they are nonetheless similar across the chambers.

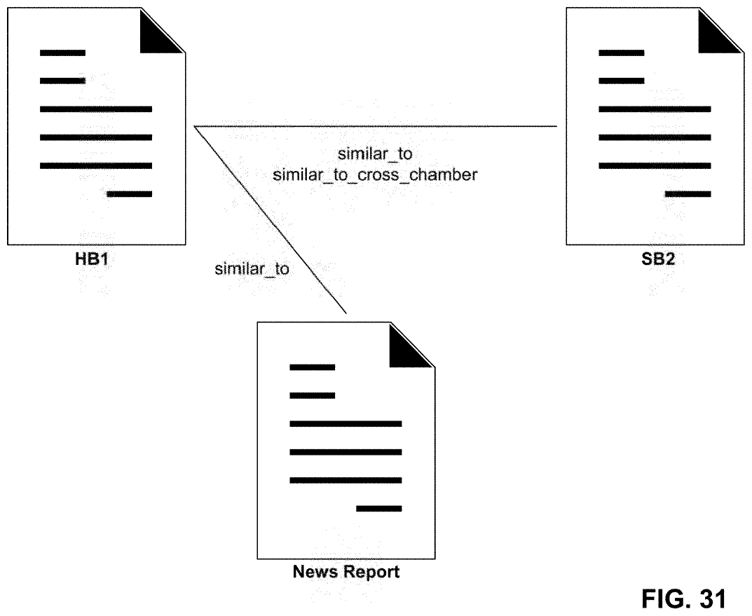

FIG. 31 illustrates another example issue graph representing knowledge about how multiple documents are related to each other. In this example, the link connecting a first document HB1 and a second document SB2 indicates that first document HB1 is similar to second document SB2 and similar across the chambers. Additionally, the link connecting first document HB1 and a third document News Report indicates that first document HB1 is similar to News Report.

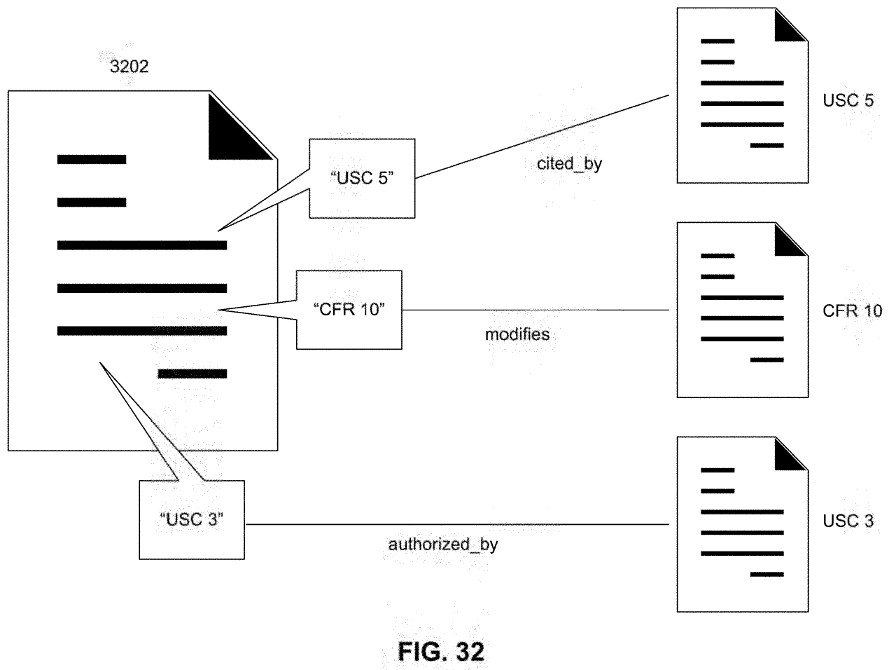

FIG. 32 illustrates another example issue graph representing knowledge about how multiple documents are related to each other. In this example, a first document 3202 may have referenced documents USC 5, CFR 10, and USC 3. In this case, the issue graph may include a link connecting first document 3202 and USC 5 to indicate that the reference to USC 5 is a citation to USC 5. The issue graph may also include a link connecting first document 3202 and CFR 10 to indicate that the reference to CFR 10 is a (proposed) modification to CFR 10. The issue graph may further include a link connecting first document 3202 and USC 3 to indicate, e.g., a proposed action stated in first document 3202 is authorized by USC 3.

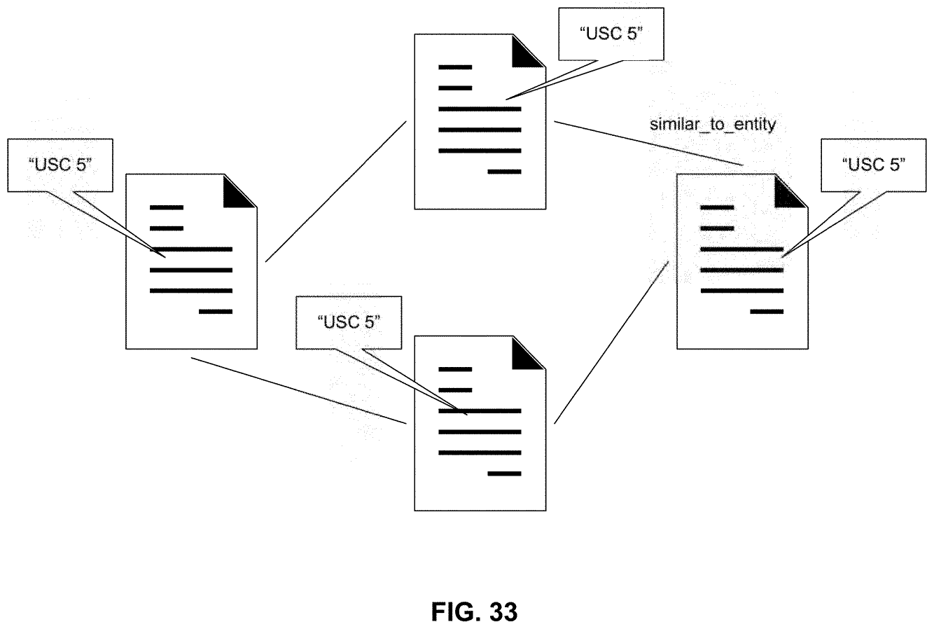

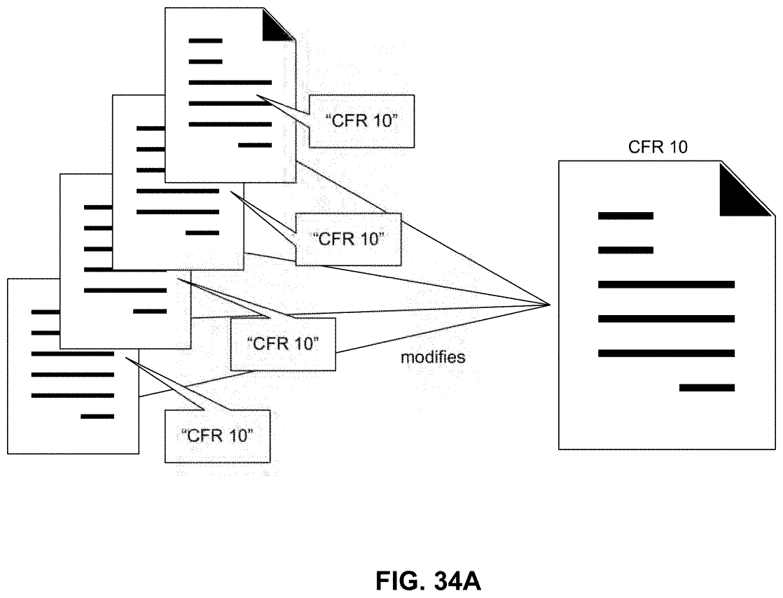

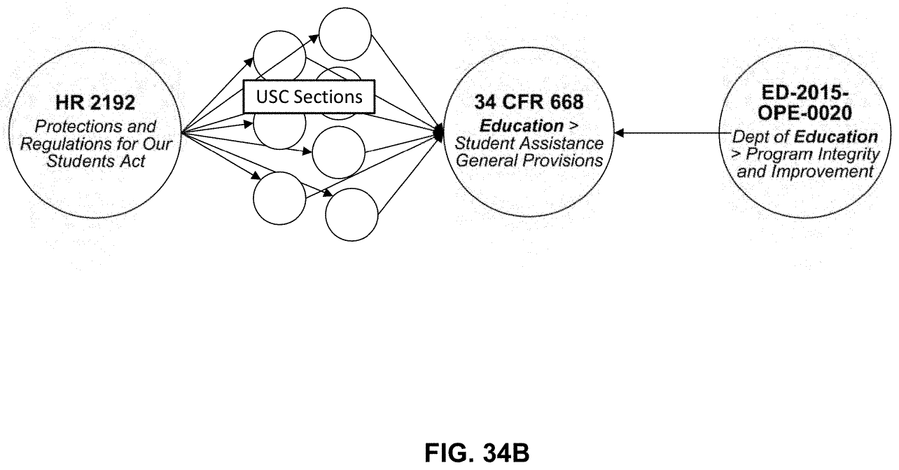

FIGS. 33, FIG. 34A, and FIG. 34B illustrate additional example issue graphs representing knowledge about how multiple documents are related to each other. For example, FIG. 33 illustrates that multiple documents may each contain a reference to USC 5. USC 5 is a citation, which is a piece of metadata, the documents all have. Based on all containing this metadata a similar to entity relation may be established between all the documents, indicating that they are all related to each other based on all containing a specific piece of metadata. In another example, FIG. 34A illustrates that multiple documents may contain sections that modify a particular document referred to as CFR 10, resulting in a modifies relationship established between each of the documents and the document referred to as CFR 10.

In still yet another example, FIG. 34B illustrates that an enforcement action, referred to as ED-2015-OPE-0020, may contain sections that cite to as a CFR, which may directly or indirectly cite one or more USC sections codified by a bill, referred to as HR 2192, resulting in an issue graph with relationships established between the bill, the USC sections, the CFR, and the enforcement action as depicted in the figure. It is to be understood that the issue graphs depicted herein are merely examples and are not meant to be limiting. It is contemplated that issue graphs may be utilized to depict various types of relationships between various types of documents.

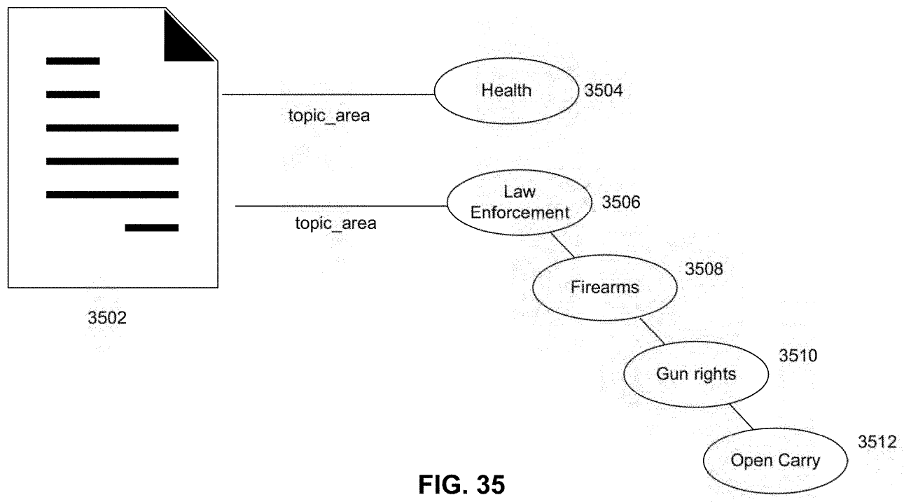

FIG. 35 illustrates another example issue graph representing knowledge about how a document 3502 is connected to various data fields. In this example, the link connecting document 3502 and data field 3504 indicates that document 3502 includes a topic related to “Health.” Similarly, the link connecting document 3502 and data field 3506 indicates that document 3502 includes a topic related to “Law Enforcement.” Furthermore, in this example, the link between data field 3506 and data field 3508 indicates that data field 3506, which identifies “Law Enforcement” as the topic area, is related to data field 3508, which identifies “Firearms” as the topic area. Similarly, the link between data field 3508 and data field 3510 indicates that data field 3508, which identifies “Firearms” as the topic area, is related to data field 3510, which identifies “Gun Rights” as the topic area. Furthermore, the link between data field 3510 and data field 3512 indicates that data field 3510, which identifies “Gun Rights” as the topic area, is related to data field 3512, which identifies “Open Carry” as the topic area.

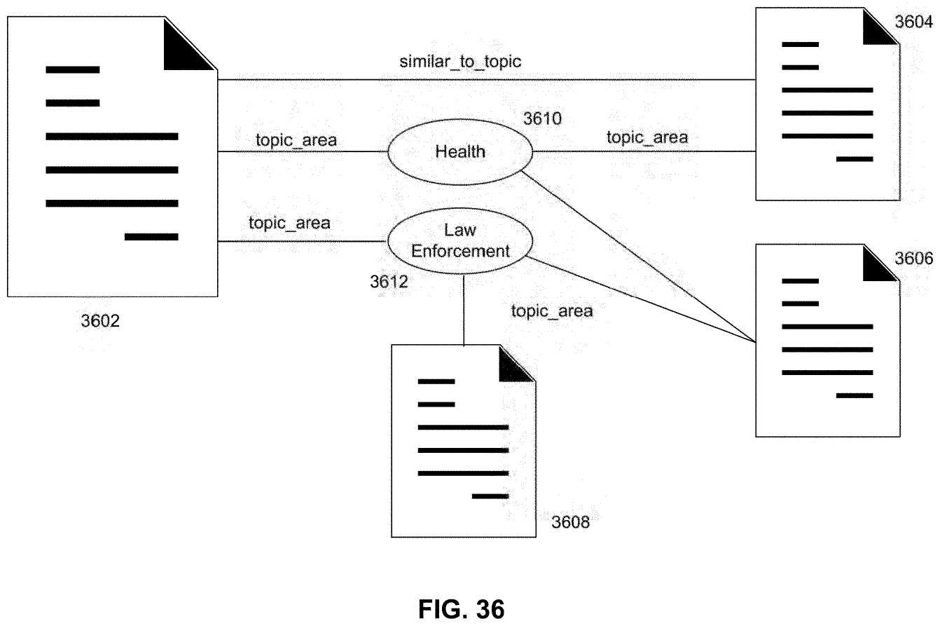

FIG. 36 illustrates another example issue graph representing knowledge about how multiple documents relate to each other and to the various data fields. In this example, the link connecting documents 3602 and 3604 indicates that they have similar to relationship, further defined as being similar based on the occurrence of the same or related topics. The links between documents 3602-3608 and data fields 3610 and 3612 indicate which documents include topics related to “Health” and “Law Enforcement.” In some embodiments, a data field may be represented separately from another type of entity that it refers to. For example, a legal citation occurring within a document can be a represented as a separate node with a label of the legal citation and a “refers_to” relationship to the document node that represents the document to which the legal citation refers.

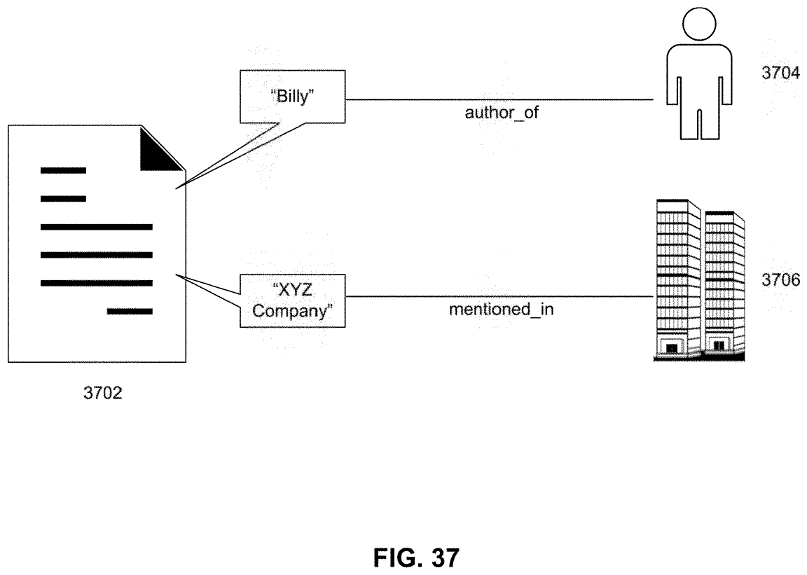

FIG. 37 illustrates another example issue graph representing knowledge about how a document 3702 is related to a person 3704 and an organization 3706. In this example, document 3702 may have referenced a person by the name of “Billy” as its author and mentioned an organization by the name of “XYZ Company.” In this case, the issue graph may include a link connecting document 3702 and person 3704 by the name of “Billy” to indicate that person 3704 is the author of document 3702. The issue graph may also include a link connecting document 3702 and organization 3706 by the name of “XYZ Company” to indicate that organization 3706 is mentioned in document 3702.

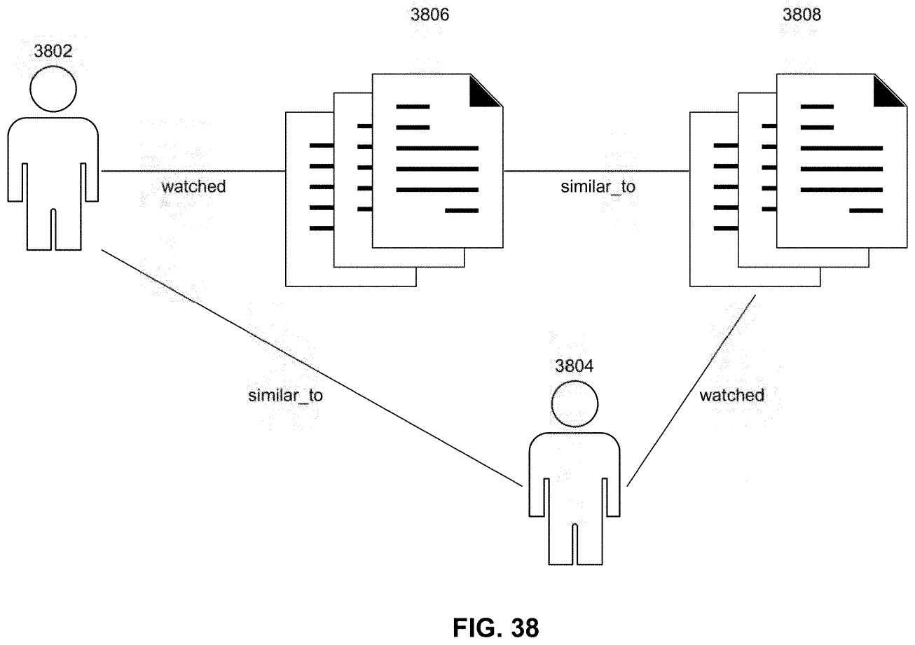

FIG. 38 illustrates another example issue graph representing knowledge about how multiple persons 3802 and 3804 and multiple documents 3806 and 3808 may relate to each other. In this example, the example issue graph indicates that a first person 3802 and a second person 3804 are similar to each other (e.g., similar position, job title, background, agenda, etc.) and a first set of documents 3806 and a second set of documents 3808 are similar to each other (e.g., in lexical content, topic distribution, authoring entity, legal citations, key phrases, position on a topic, etc.). The example issue graph also indicates that first person 3802 has viewed the first set of documents 3806 and second person 3804 has viewed the second set of documents 3808.

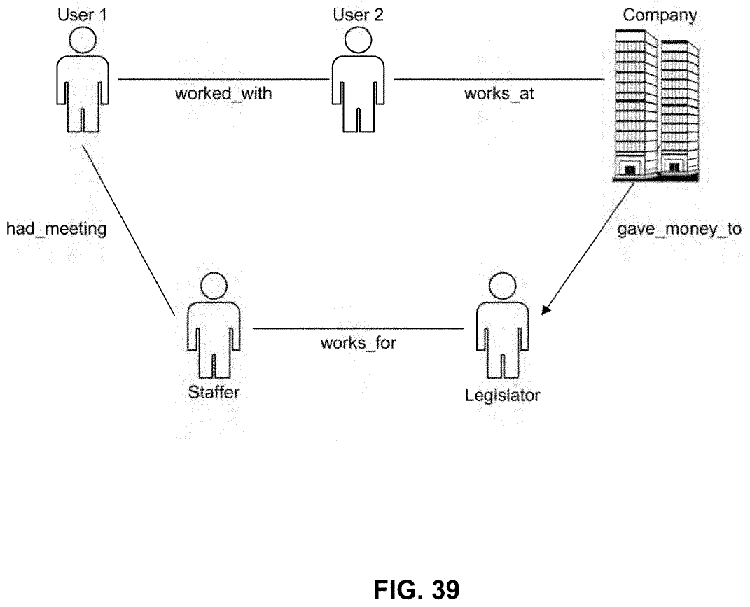

FIG. 39 illustrates another example issue graph representing knowledge about how multiple persons may relate to each other. In this example, the example issue graph indicates that a first person, User 1, worked with a second person, User 2. The first person, User 1 also had a meeting with a third person, Staffer, who works for a fourth person, Legislator. The example issue graph also indicates that User 2 now works at an organization, Company, which gave money to Legislator.

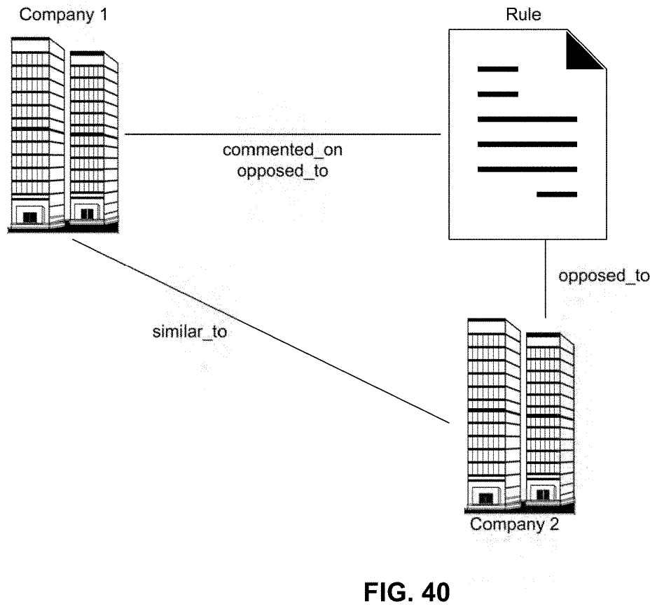

FIG. 40 illustrates another example issue graph representing knowledge about how multiple organizations may relate to each other. In this example, the example issue graph indicates that a first organization, Company 1, and a second organization, Company 2, are similar to each other (e.g., similar industries, size, GICS, NAICS, or SICS assignment, revenue, localities of operation, positions on issues, commenting activity, lobbying activity, interests, agenda, etc.). The example issue graph also indicates that Company 1 commented on a document pertaining to a Rule, and that both Company 1 and Company 2 are opposed to the passing of the Rule.

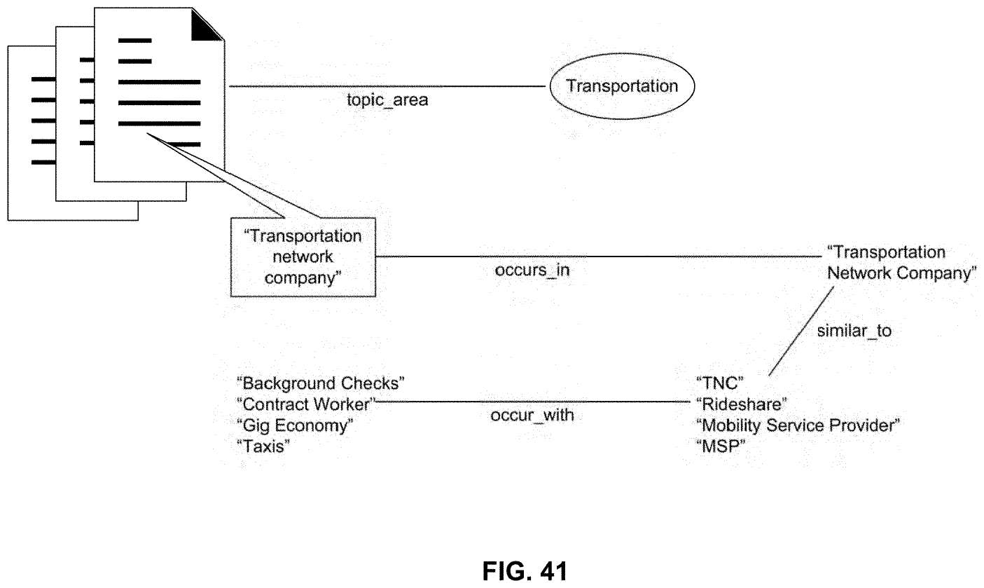

FIG. 41 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents all include a key term “Transportation Network Company,” which is similar to terms such as “Transportation Network Company,” “TNC,” “Rideshare,” “Mobility Service Provider,” or “MSP.” The issue graph may further indicate that the terms “TNC,” “Rideshare,” “Mobility Service Provider,” and “MSP” often occur with other terms, including, e.g., “Background Checks,” “Contract Worker,” “Gig Economy,” and “Taxis.” In this manner, if a user searches for documents containing the phrase “transportation network company,” the user may be presented with additional information obtained by system 100 traversing this issue graph to obtain the knowledge contained therein.

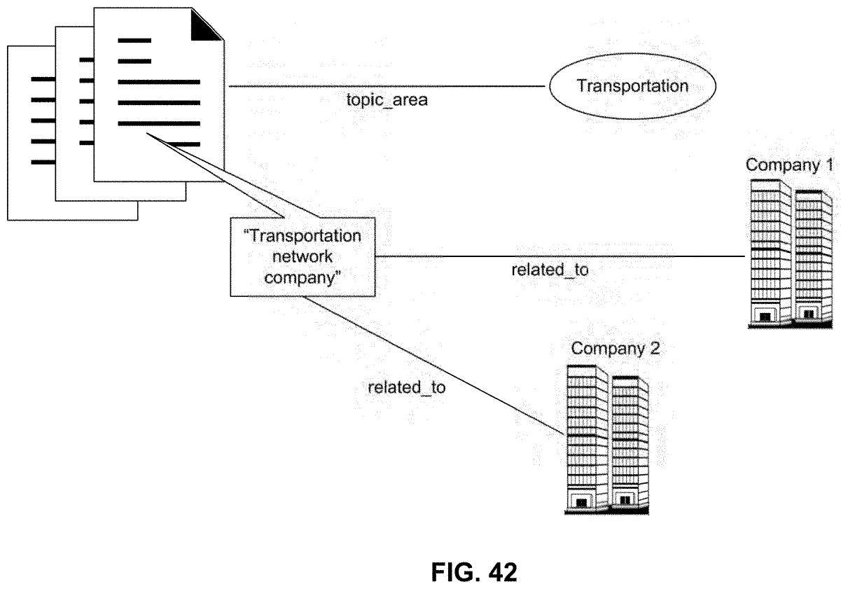

FIG. 42 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents are related to various organizations, including, e.g., Company 1 and Company 2, by virtue of the documents containing the phrase “transportation network company.” In this manner, if a user searches for documents containing the phrase “transportation network company,” the issue graph indicates that the various organizations are related to transportation network companies and the user may be presented with additional information obtained by system 100 traversing this issue graph to obtain the knowledge contained therein.

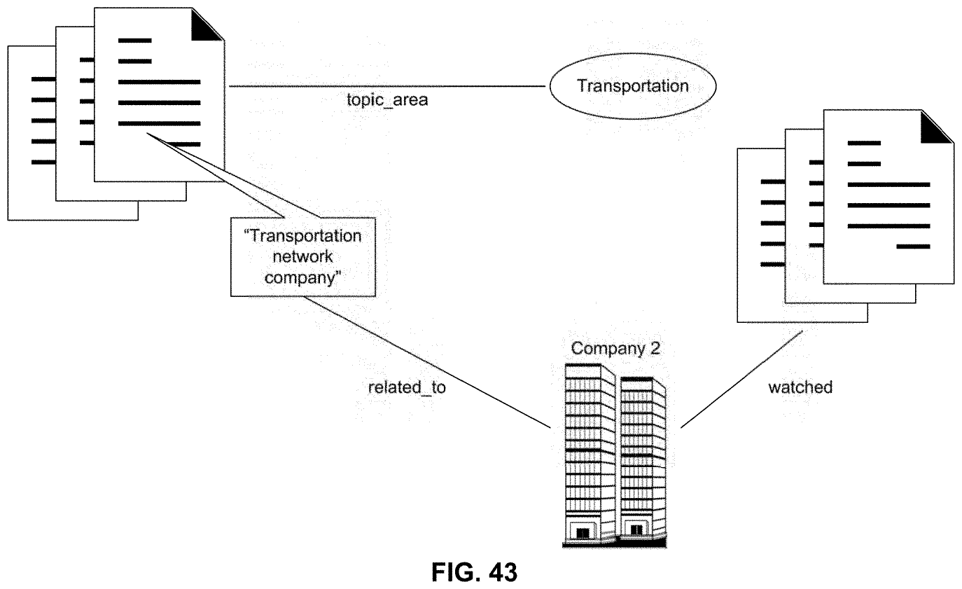

FIG. 43 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents are related to various organizations, including, e.g., Company 2, and that Company 2 has worked on various documents on the system, which may or may not be related to the set of documents containing the phrase “transportation network company.” In this manner, if a user on the system from Company 2 searches for documents containing the phrase “transportation network company,” the user may have the option to traverse this issue graph to obtain the knowledge contained therein. If a user on the system not from Company 2 searches for documents containing the phrase “transportation network company,” the user may not have access to the additional documents worked on by Company 2.

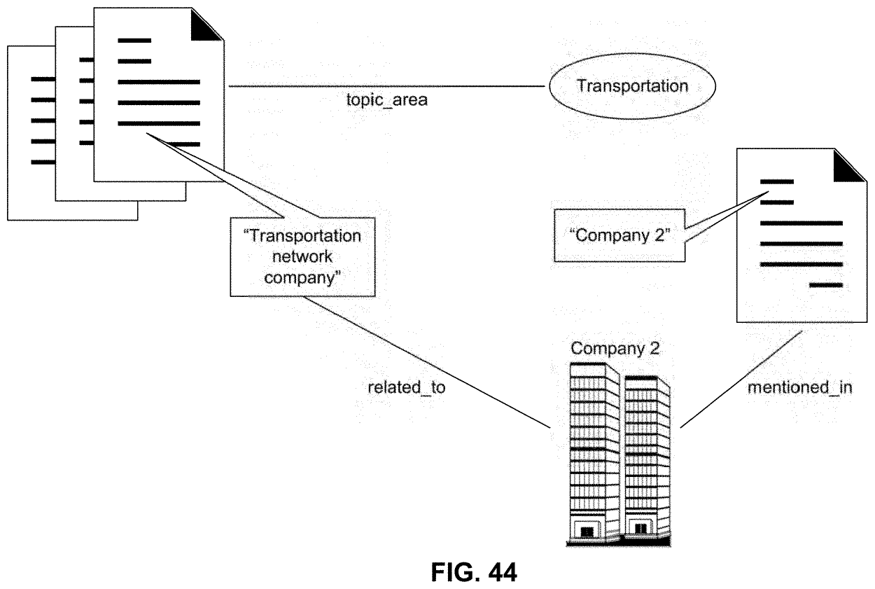

FIG. 44 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents are related to various organizations, including, e.g., Company 2, and that Company 2 was mentioned in a document that contains the name “Company 2.” In this manner, if a user searches for documents containing the phrase “transportation network company,” the user may be presented with additional information obtained by system 100 traversing this issue graph to obtain the knowledge contained therein.

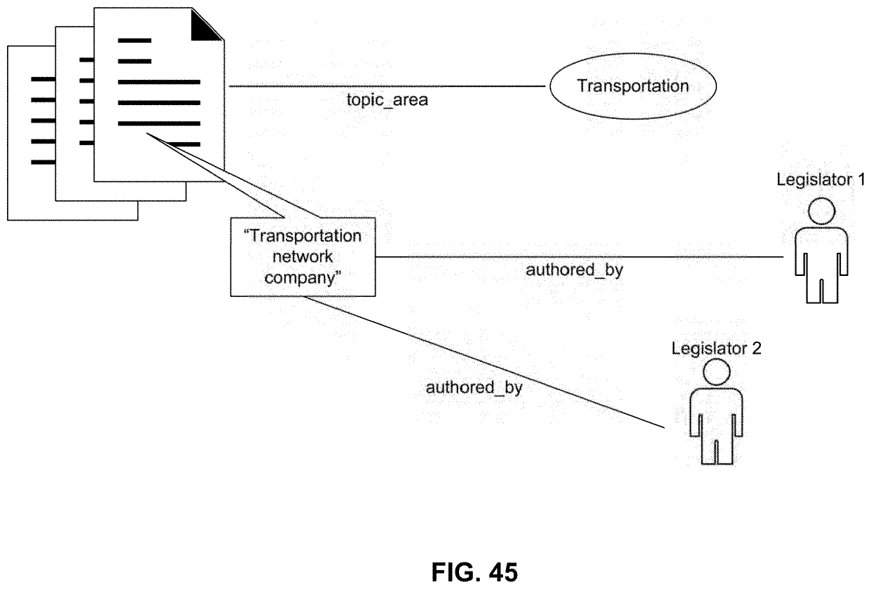

FIG. 45 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents, or a part thereof, is authored by various persons, including, e.g., Legislator 1 and Legislator 2. In this manner, if a user searches for documents containing the phrase “transportation network company,” the user may have the option to traverse this issue graph to obtain the knowledge contained therein.

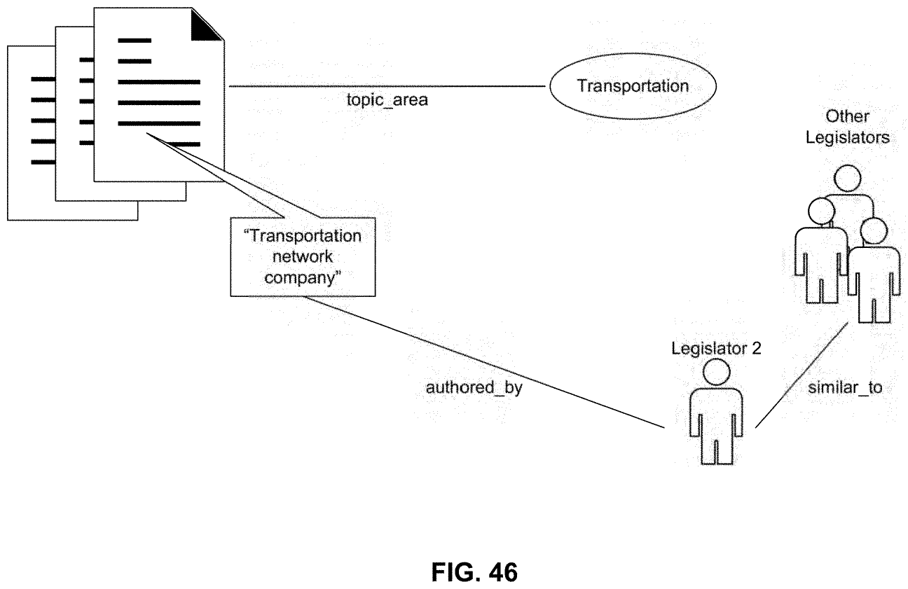

FIG. 46 illustrates another example issue graph representing knowledge about a set of documents. In this example, the documents contained in the set of documents may include the phrase “transportation network company.” The issue graph may indicate that these documents all include a topic related to “Transportation.” The issue graph may also indicate that these documents are authored by various persons, including, e.g., Legislator 2, who is considered to be similar, based on voting record, party affiliation, cosponsoring activity, professional or educational background, etc. to other persons, including, e.g., Other Legislators. Legislator 2 may be similar to one group of legislators based on one or more attributes, and similar to another group based on one or more other attributes. In this manner, if a user searches for documents containing the phrase “transportation network company,” the user may be presented with additional information obtained by system 100 traversing this issue graph to obtain the knowledge contained therein.

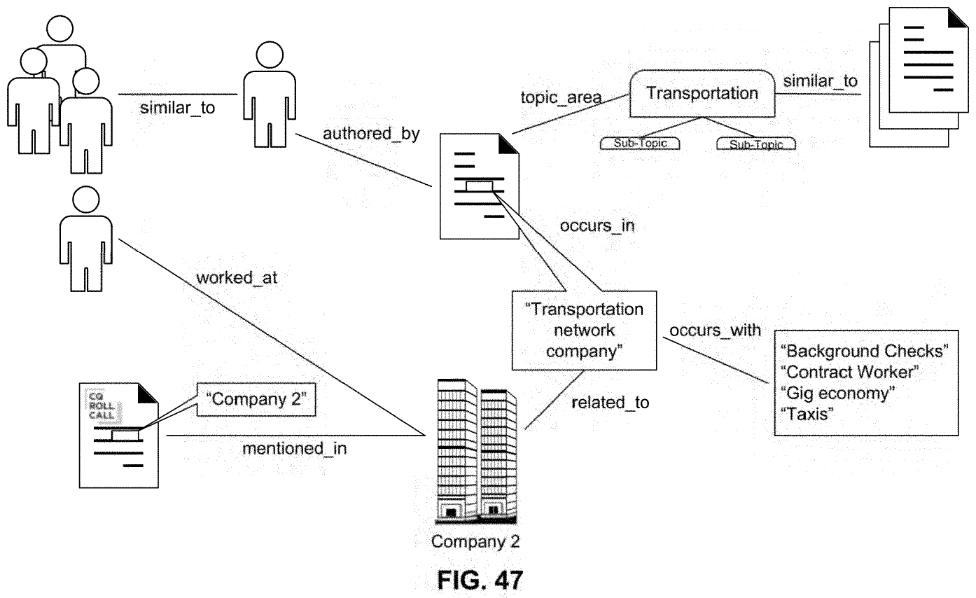

FIG. 47 illustrates another example issue graph representing knowledge about a set of documents. In this example, the documents contained in the set of documents may include the phrase “transportation network company.” The issue graph may indicate that these documents all include a topic related to “Transportation,” as well as certain sub-topics under “Transportation.” The issue graph may also indicate other documents that discuss similar topics, as well as terms that often occur with “Transportation Network Company,” including, e.g., “Background Checks,” “Contract Worker,” “Gig Economy,” and “Taxis,” as described above. The issue graph may also indicate that the documents containing the phrase “transportation network company” are related to various organizations, including, e.g., Company 2, and that Company 2 was mentioned in certain documents, as described above. The issue graph may further indicate persons who worked at Company 2 as well as persons who authored the documents containing the phrase “transportation network company.” In this manner, if a user searches for documents containing the phrase “transportation network company,” the user may be presented with additional information obtained by system 100 traversing this issue graph to obtain the knowledge contained therein.

It is to be understood that the various issue graphs depicted above are presented as examples and are not meant to be limiting. It is contemplated that issue graphs may include various types of documents, persons, organizations, events, and data fields as nodes, and may include various types of relationships as links between the nodes. It is also to be understood that the issue graphs may vary in sizes and may be implemented using various techniques, including, e.g., databases such as graph databases and the like.

Dynamic Issue Graph Generation

It is also to be understood that, as described above, an issue may be a system predefined subject area categorization, a user updated system model, or a user specified issue area, represented as a set of terms, linguistic patterns, labels, or a user initiated categorization model. In some embodiments, a user may define the scope of the issue graph by indicating to the system what nodes (e.g., policy documents, news, etc.) are present, and the system may compute the relationships and related nodes (e.g., people nodes for sponsor of bills, topics on document nodes, etc.), and create the issue graph accordingly. In some embodiments, the issue graph may be created collaboratively by the user and system. For example, in some embodiments, a system user may create an issue graph by specifying an issue area, name it “Covid 19”, associate terms with it, e.g., “coronavirus”, and associate legislation, regulations, and stakeholders, etc. with the graph. Accordingly, the system may display one or more user controls for selecting an issue area. This may include displaying a text entry field, a drop-down list, a checkbox, a button, or various other control elements. The system may include a graph generator module configured to create the graph from the selected nodes and relationships, or compute the nodes and relations accordingly (e.g., compute the relationships between nodes in user defined graph). In another example, the system may create an issue graph by automatically categorizing legislation, regulation, stakeholders, etc. into a predefined subject area. In some embodiments, the system may categorize documents based on one or more rule-based or machine trained models. For example, a “Financial” subject area/topic based issue graph may be created by creating a subgraph including all nodes with a topic_area relationship to “Finance,” and all relationships between the selected nodes. In still another example, a “Financial” subject area/topic based issue graph may be created by creating a subgraph including the first set of nodes with a topic_area relationship to “Finance,” and expanding to include a second set of nodes based on relationships in the first set, where the first set may include legislation, and the second set may include sponsors of the legislation. Likewise, first set may include regulatory comments, and the second set may include authoring organization.

In some embodiments, the system may create an issue graph by automatically classifying legislation, regulation, stakeholders, etc. into a dynamically generated issue. For example, the system may create the issue graph by selecting a first set of one or more nodes, and creating the graph by traversing relationships from the first set of node(s) to augment with a second set, a third set, etc. Relationships used in traversal can be of one type, or of two or more different types, as illustrated in FIG. 41 and described above. In another example, a citation-based issue graph may be created by starting with a first node, representing a document that has at least one citation relationship, traversing the relationship to a second set of document nodes, and continuing to include a third set, etc., by including additional documents related with a citation relationship from the second set, third set, etc. The process may likewise start with a citation metadata node as the first node, traverse to a second set of document nodes that have a citation relationship to first node, and so on. In some embodiments, other relationships from the first set of nodes may be used to expand to the second node set, from the second set to the third set, and so on. For example, the second set of nodes can include those that are related with a citation relationship and similarity relationship to the first set.

In some embodiments, system users may initiate creation of either static or dynamic issue graph by specifying one or more first set of nodes. For instance, a user may specify an issue area as described above. Alternatively, or additionally, in some embodiments, a user may initiate creation of a first set of nodes by specifying a relation type, e.g., “worked_at,” to create an issue graph including all people nodes and organization nodes they have a work_at relationship with, or “authorized_by,” to create an issue graph including all document nodes that have an authorized_by relationship to another document node. The user may further specify a combination of a relationship and a node, e.g. organization node “FiscalNote” and relationship “worked_at,” to create an issue graph including people nodes who also have a worked_at relationship with FiscalNote. It is to be understood that the descriptions above are examples and are not meant to be limiting. It is contemplated that users may specify any number of nodes and relationships to create issue graphs.

As issue graphs are generated, they may be displayed dynamically to the user. For example, the system may display an issue graph including dynamically generated nodes and edges as shown in FIGS. 27-47 and described above. In some embodiments, the issue graph may be interactive such that the user may update and/or modify the issue graph. For example, the user may select and edge which may allow a user to change the type of edge. As one example, a user may select a “worked_at” edge connecting a person and an organization and may change it to “donated_to” Accordingly, the system may update one or more nodes in the issue graph to reflect the updated selection.

In some embodiments, the system may determine the first set of nodes and relationships. In some embodiments, the system may make the determination based on predefined criteria, such as subject area. In some embodiments, the determination may be calculated dynamically based on an analysis module. The analysis module may use different metrics to determine what to add, based on previous user data. For example, when a new bill is received, the system may extract one or more citations from the new bill and connect the bill to cited documents already extant in the graph. The system may also determine, e.g., based on user history, that another node (e.g., one of the CFR sections) is usually modified by rules authorized by a document (e.g., a USC section) being modified by this bill, and construct an issue graph to include the various documents identified. Furthermore, the system may automatically construct an issue graph from this bill, using nodes for sponsors of bills that have similar relationships and nodes of the sponsors of those bills. For example, the system may detect more frequent occurrence of a key phrase in documents that a user has indicated as important, construct an issue graph by adding other documents that have key phrases that the user has not seen, as well as organizations or people who have authored such documents. In another example, the system may create issue graphs based on information not related to user interactions. For instance, in some embodiments, the system may ingest organization locations (or may receive the information from the users), and create an issue graph with all policymakers that have the organization locations in their district.

In some embodiments, the creation of issue graphs may be performed collaboratively between multiple system users, and/or the system and one or more system users. For example, a user may initiate a first set of nodes/relationships and the system may expand the issue graph to include a second set of nodes/relationships. The user may also provide feedback to the system, including, e.g., adding/removing specific nodes, specific relationships, or all nodes or relationships of a certain type, and the system may then iteratively construct a third set of nodes/relationships, and so on.

Furthermore, in some embodiments, the system may freeze an issue graph (i.e., the issue graph may remain fixed) once the issue graph has been created. In other embodiments, the issue graph may evolve over time. For example, an issue graph created in the subject area of finance may automatically incorporate newly ingested document/user provided documents that are categorized with financial topics. In another example, if an issue graph includes similarity relationships, when a similarity relationship is computed from a document node in the issue graph to a document node not in the issue graph, the second node may be added. Likewise, when a person/organization node is added to the system they/it may be added with corresponding relationships to the issue graph. New relationships and properties may also be added to existing nodes in the issue graph.

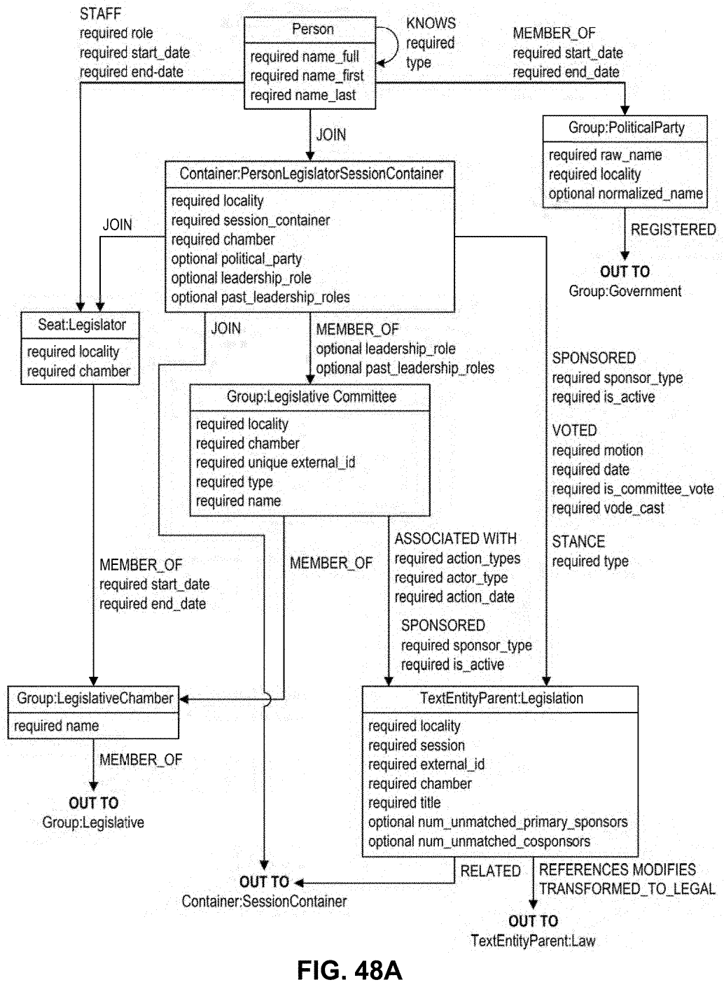

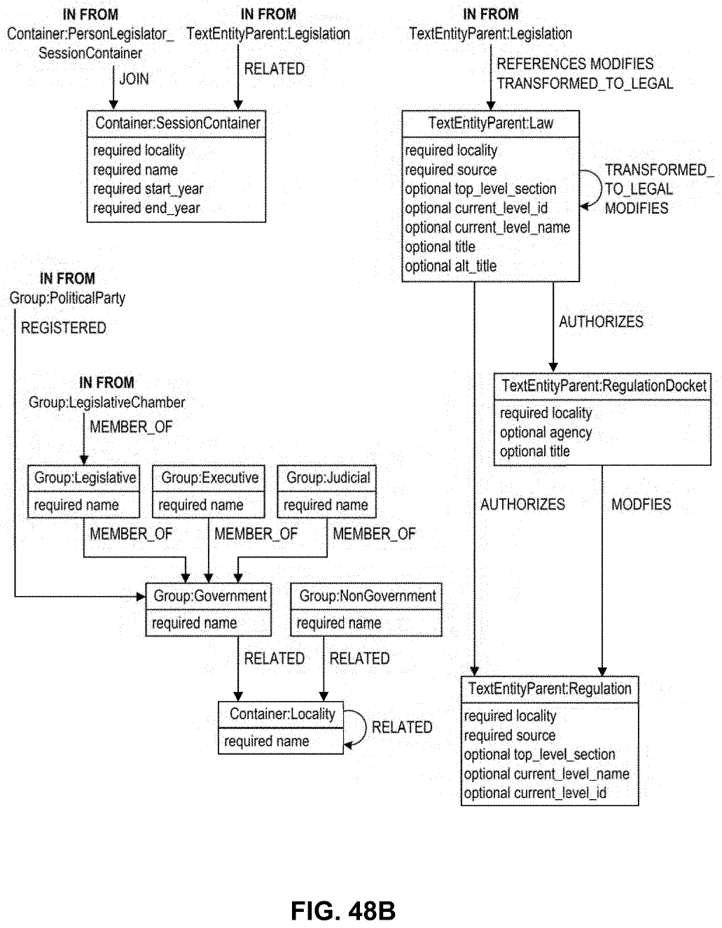

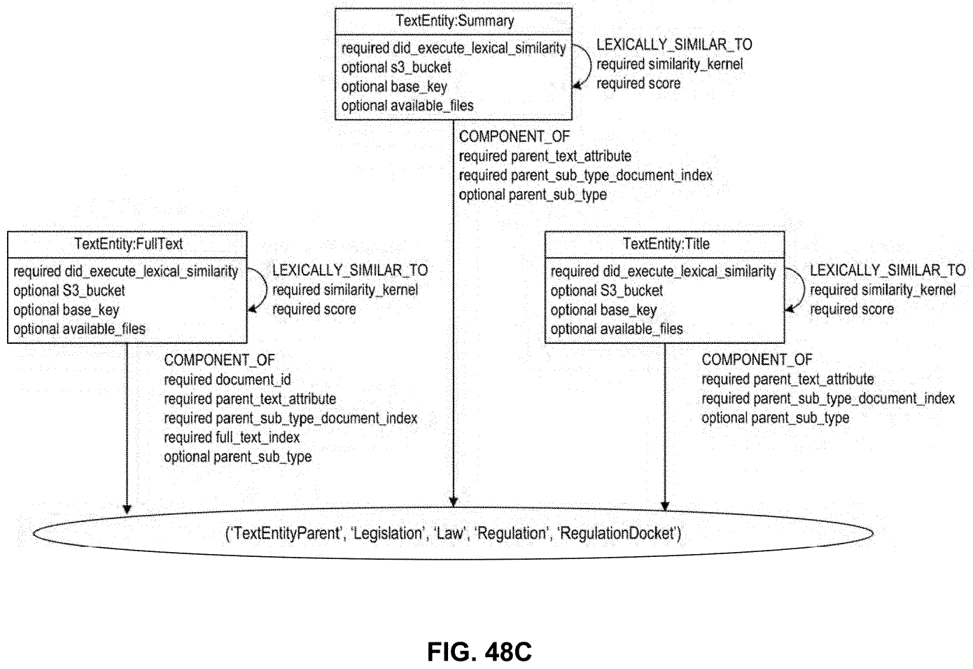

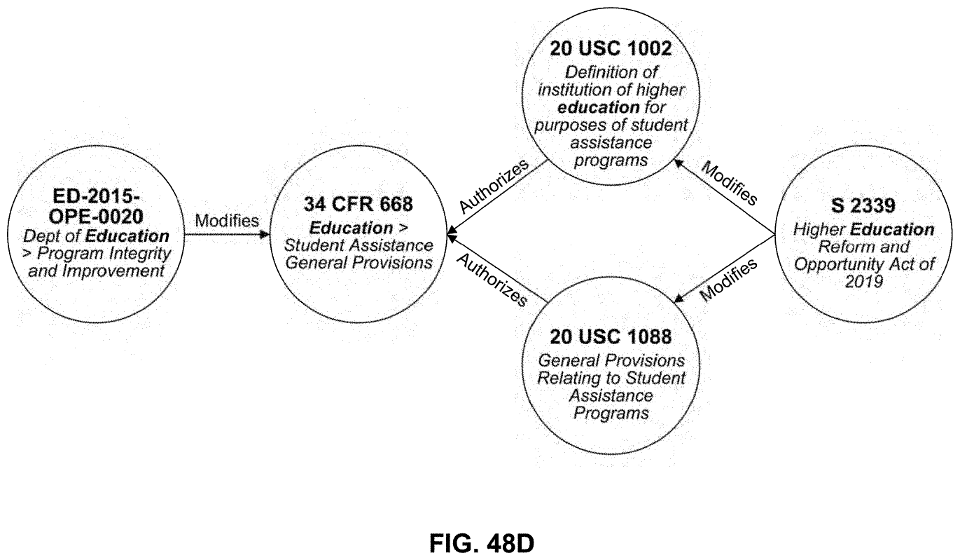

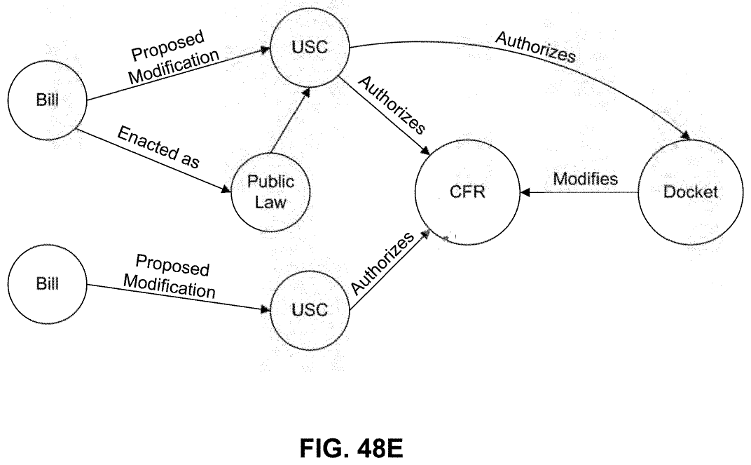

FIGS. 48A, 48B, and 48C illustrate an example schema from a graph database, showing nodes representing documents, persons, organizations, and data attributes in boxes, with fields defining each node provided inside the box corresponding to that node. The links between boxes represents relations between the nodes. For instance, a person node may be required to have a field for the full name, first name, and last name. The person may be a “member of” an organization, such as a political party, represented in the “Group:PoliticalParty” node. The organization node may be required to have a name and locality. The “Group:PoliticalParty” node may have a “registered” relationship with another node representing an organization, “Group:Government,” a legal jurisdiction. Other organization nodes, such as “Group:Executive,” representing an Executive branch of the government, and “Group:Judicial,” representing the judicial branch of the government, may have a “member_of” relationship with the “Group:Government” node, representing a legal jurisdiction. The “Group:Government” node may have a related relationship to a metadata node, “Container:Locality,” representing the locality of the legal jurisdiction. Another organization node “Group:NonGovernment” may represent a private sector organization, and also have a “related” relationships to a locality metadata node.

The person node may have a “knows” relationship with one or more other person nodes. The “knows” relationship may further include a specification of the nature and extent of the relationship, including “worked_with”, “worked_for”, “met_with”, “donated_to”, etc. other specifications of a “knows” relationship are contemplated.

The person may be serving or have served as an elected official, such as a legislator elected to a particular session of a legislature. This may be represented by a relationship between a first person node, Person, and a second person node, Container:PersonLegislatorSessionContainer node. In some embodiments, the Container:PersonLegislatorSessionContainer node may be required to have a locality, and optionally a political_party affiliation for the person during that session, and one or more leadership roles held by the person during that session. A person may have relationships with one or more session container nodes. For instance, a person may have served as state senator for one or more sessions, then as a federal Congressional representative for one or more sessions. Each separate service may be represented by a separate person node for the respective service. It is to be understood that other person session container nodes are contemplated, such as a Regulatory Session, or Executive Session container, representing a person serving in a role regulatory or executive capacity, respectively. In another example, a person may have “sponsored” a policy proposal, which may be represented by a “sponsored” relationship between the person session container node and a TextEntityParent:Legislation node, representing a document. In some embodiments, the policy document node may be required to have an external identifier and title. In still another example, a person may have “voted” on a policy proposal, which may be represented by a “voting” relationship with a TextEntityParent:Legislation node. In some embodiments, there may be multiple relationships of the same between the same nodes. For example, a person may have several distinct votes on a bill, (e.g., one vote for each version of a bill). Each relation may be a voting relationship between the bill nodes and legislator node. To disambiguate relationships may be keyed, indicating a unique instance of the same relationship between the same nodes.

Likewise, a person may have a stance on a policy proposal, which may be represented a “stance” relationship. The stance relationship may be recorded in the database based on parsing from external data ingested by the system, computations by the system to predict a stance, or input directly by the user. The stance relationship may further include “for,” “against,” or a likelihood on a distribution between “for” and “against.”

In some embodiments, the TextEntity:FullText node, representing a document has a “component_of” relationship with the TextEntityParent:Legislation node, may be configured to indicate that a document is composed of one or more documents. For instance, there may be a TextEntity:FullText node representing a first version of a legislative bill, a TextEntity:FullText node representing a second version of a legislative bill, and a TextEntity:FullText representing an amendment of the legislative bill, all with a “component_of” relationship to the same TextEntityParent:Legislation node, representing a legislative bill. Other examples of a component_of relationship between a document node representing a portion or section of a document and another document node may include TextEntity:Summary and TextEntity:Title. Likewise, the TextEntityParent:Regulation, TextEntityParent:Law, and TextEntityParent:RegulationDocket may have component_of relationships coming from promulgated rules, final rules, public comments, public laws, or sections thereof, and the like. Other types of document nodes representing portions or sections of a document are contemplated.

In some embodiments, an organization node may have commented_on relationship with a text entity or regulation, and the property of the relationship may indicate whether the comment has a stance, including, e.g., support or oppose. In some embodiments, the stance may be directly represented as a relationship, for example “opposed_to.” It is to be understood that the commented_on relationship depicted here is merely an example. Other relationships may include, e.g., lobbied_for, lobbied_against, advocated_for, contributed_to, authored_by, submitted_by, impacted_by, aligned_with, and the like.

In some embodiments, the TextEntityParent:Legislation entity may have an “authorizes,” “parent_of,” “references,” “modifies,” or “transform_to_legal,” relationship with other nodes, including TextEntityParent:Legislation, TextEntityParent:Law, TextEntityParent:Regulation, or TextEntityParent:RegulationDocket, indicating that the legislative bill has one of several types of relationships with such nodes. For example, FIG. 48D shows a TextEntityParent:Legislation node, referred to as “S 2239,” with a “modifies” relationship to two TextEntityParent:Law nodes, referred to as “20 USC 1002” and “20 USC 1088,” each of which may have an “authorizes” relationship with another TextEntityParent:Law node, referred to as “34 CFR 668,” which in turn is modified by a TextEntityParent:RegulationDocket node, referred to as “ED-2015-OPE-0020.” In some embodiments, “authorizes” may represent giving legal authority to an entity, “parent_of” may represent having a hierarchical relationship, such as Title to Chapter, “transformed_to_legal” may represent transformations between legal bodies, such as US Public Law into USC, “modifies” may represent proposing or enacting modifications to an entity, and “references” may represent a generic mention or citation to an entity.

In some embodiments, the TextEntityParent:Law node may represent extant statutory law, administrative law, or judicial decisions, such as the Federal USC, CFR, Public Laws, Statutes at Large, or Supreme Court opinions. In some embodiments, the TextEntityParent:Law node may have a “modifies,” “transform_to_legal,” or “parent_of,” relationship with other TextEntityParent:Law nodes. In some embodiments, the TextEntityParent:Law node may also have an “authorizes” relationship to other TextEntityParent nodes.

In some embodiments, the relationship to a node may be associated with the node directly. In some embodiments, the relationship to a node may be associated through the node to one or more nodes through further relationships. For example, a relationship to a TextEntityParent node may be associated with the TextEntityParent node directly, or associated through the TextEntityParent to a component. For instance, a person may have a “sponsor” relationship to a TextEntityParent:Legislation node, or a person may have a “sponsor” relationship to a TextEntity:FullText node, which has a “component_of” relationship with the TextEntityParent:Legislation node. Likewise, a person may be considered to have a “member_of” relationship to a Group:Government node through the “member_of” relationship of the person to the Group:PoliticalParty node. Similarly, a person may be considered to a have a “member_of” relationship to the Group:Legislature, .e.g., members of Congress, through the person's relationships with Seat:Legislator and Group:LegislativeChamber. In examples, a TextEntityParent:Legislation node may have a “references” relationship with a TextEntityParent:Law node, a TextEntity:FullText “component_of” the TextEntityParent:Legislation node may reference the TextEntityParent:Law node, and a TextEntity:FullText “component_of” the TextEntityParent:Legislation node may reference a TextEntity:FullText “component_of” the TEP:Law node. In still another example, a section of a proposed bill version may reference a section of the USC.

In some embodiments, document nodes may have a relationship to each other based on similarity. For instance, the “lexically_similar_to” relationship for the “TextEntity:Title” box means that the title of every document is stored in a database and a textual similarity between any two document titles are computed. Two titles with a textual similarity above a certain threshold may be deemed lexically similar, and a “lexically_similar_to” relationship may be established between the two documents and recorded in the database.

In some embodiments, the nodes representing the various entities in an issue graph and the relationships between them may be created based on ingesting data or metadata scraped from the Internet. In some embodiments, the nodes representing the various entities in an issue graph and the relationships between them may be created based on ingesting data or metadata provided by users of the system. In some embodiments, the nodes representing the various entities in an issue graph and the relationships between them may be created based on users interacting directly with the system.

In some embodiments, the nodes representing the various entities in an issue graph and the relationships between them may be generated based on automated analysis and extraction from data (either system ingested or user provided/entered). For example, in some embodiments, the system may parse names of authoring companies from regulatory comments using machine-trained entity recognition models and determine their stance on proposed regulation(s) based on content analysis using machine-trained stance detection models. In some embodiments, the system may parse and ingest data from a data source external to the system, including, e.g., websites, publications, databases, and various other types of data sources accessible to the system. In some embodiments, the ingested data may be unstructured policy data or people data. In some embodiments, the system may compute the issue graph (e.g., create nodes and compute relationships) based on the ingested data without user instructions. In some embodiments, the system may compute the issue graph based on the ingested data as well as user provided data, such as proprietary documents, policy data, people data, positions, actions taken, and the like.

In some embodiments, the system may recognize named entities (e.g. performing named entity recognition) by parsing out proper names, including people names, organization names, and policy names, from document content using various techniques, including off-the-shelf machine-trained parsing and NER models. The system may compute a match score of an extracted potential entity to existing node properties in a graph. The match score may be computed by system 100 using an algorithm to calculate the string edit distance between the identified entity and extant node properties, or the distance between the phonetic projection of the identified string and extant node properties, or a distance between a multidimensional embedding of the identified entity and extant node properties. If a match score is above a threshold, the system may create a relationship (e.g. from an extant person to the document wherein they are mentioned); otherwise, the system may create a new entity. As another example, the system may parse names of organizations from lobbying disclosures, parse bill, act, or regulation names from SEC filings, parse names of people speaking during committee hearings from transcripts, parse names of legislators from legislative election results, or parse names of associated entities out of user entered text (e.g., speakers from calls transcript, attendees from meeting notes, impacted from impact analysis). Similar automated processes may be carried out by system 100 for generating relationships and properties associated with relationships, using machine-trained semantic role labeling, dependency parsers, or relation extraction models. For example, the system may parse types of interaction from user input action text (e.g. call, meeting).

In some embodiments, the system may also compute document similarity, topic assignment, stance, and the like, as described above. And in some embodiments, the system may assign different weights to various sub-types of relationships. For example, in an “interaction” relationship, the system may assign twice the weight to a meeting compared to a call between a user/organization and a policymaker.

In some embodiments, the data may be publicly available, proprietary, or licensed. In some embodiments, data ingested for legislation may include, e.g., bill identifier, title, summary, text versions, amendments, sponsorship, voting, legislative actions, committee assignments, hearings, financial analyses, impact statements, lobbying activities, advocacy activities, and the like. In some embodiments, data ingested for regulations may include, e.g., rule identifier, title, text versions, regulatory response comments, agency data, impact analysis, data for organizations, data for agency enforcement actions and cases, as well as data from various sources. In some embodiments, certain data ingested may be made available only to certain users while other data may be made available to all users.

Similarly, data ingested for a legislator may include, e.g., sponsorship, voting, committee assignments, chamber information, lobbying disclosures, financial disclosures, professional and biographical background, and contact information. Likewise, data ingested for staffers may include, e.g., professional histories and biographical information (e.g., school attended, hometown, etc.)

In some embodiments, data ingested for organizations may include regulatory disclosures (e.g., SEC 10K, SEC 8K, FDA disclosures), lobbying disclosures, analyst reports, financial reports, product descriptions, business operation locations, employee information, industry classifications, corporate filings, earning statements, company profiles, and the like.

Other types of data ingested may include, e.g., news, lobbying disclosure forms, or political donations (individual donations can be matched to individuals). For example, in some embodiments, system 100 may retrieve a set of bills that are all part of a specific issue, generate bill nodes and connect bill nodes to legislator nodes through sponsorship relationships, connect bills to committee nodes by committee assignment relationship, connect legislator nodes to committees by committee assignments relationship, augment the issue graph with people nodes generated from a user's uploaded contacts to legislator's staffs, connect legislator staff nodes to legislator nodes, and add data fields about votes on bills in the issue. It is to be understood that the issue graphs are flexible. For example, the issue graph described above can be expanded to include topics by connecting the bills to their relevant topic nodes. The connected topics may also be assigned importance score, such as a weight on the edge from bill to topic, where the weight is a representation of the score given by a model of the relevance of the topic to the bill. In some embodiments, an issue graph may include a plurality of policymakers represented as a network with each node representing a policymaker. In some embodiments, one or more edges of the network may represent a connection (e.g., a link) or lack of connection between the nodes. In some embodiments, the system may also compute the topics and similarities of bills based on data ingested.

In some embodiments, a link may have a property associated with it. For example, the property may include a score indicating the strength, confidence, or likelihood assigned to the relationship. For instance, a “knows” relationship between two person nodes may be associated with a score ranging between 0 and 10, indicating a range from no relationship (e.g., score equals 0), very weak relationship (e.g., score equals 1), or very strong relationship (e.g., score equals 10). Similarly, a lexical similarity relationship between two document nodes may be associated with a score ranging between 0 and 100, indicating no similarity (e.g., score equals 0), to completely similar (e.g., score equals 100). Likewise, a stance relationship between an organization and proposed regulation may be associated with a score ranging between −1.0 and 1.0, indicating highly opposed (e.g., score equals −0.99) or highly supporting (e.g., 0.98).

In some embodiments, both the nodes and the links are part of a graph stored in the graph database. In some embodiments, system 100 may precompute certain queries and store the results in another database/file for easy retrieval. For instance, in some embodiments, system 100 may query the graph database on demand in response to a user request and then cache the results so that the cached results can be used to respond to the same request in the future.

In some embodiments, the graph database may be centralized on one physical machine. In some embodiments, the graph database may be implemented in a distributed manner (e.g., distributed across several physical machines). In some embodiments, system 100 may utilize separate instances of the graph with different node types (e.g., one instance with just document-document relationships, one with just people-people, etc.), and by having all of these separate instances of the graph with different node types, system 100 can access to all the different permutations of relations. In some embodiments, system 100 may utilize a separate instance of the graph to maintain a knowledge graph with entities and relationships available to all system users, and an instance of the graph with additional system user information available to a subset of system users. In some embodiments, the separate graph instances may be stored in separate databases, as a single tenant application. In some embodiments, the separate graph instances may be stored in the same database, as a multitenant application. In some embodiments, the separate graph instances may be stored in a single graph. In some embodiments, the additional system user information may be used in real time to perform necessary computations and not stored in the graph. In this manner, system 100 may allow a user to simulate what having a legislator as a cosponsor of a bill would do to the other issue graph relationships (e.g., if it would create a better influence/accessibility measure) without storing that as a permanent relationship.

Subgraph Merging

In some embodiments, graph generator module may utilize a subgraph merging module to “upsert” (insert or update) a first set of nodes and relations, which may constitute a first issue graph, with a second issue graph, to generate a third issue graph representing a composition of the first and second issue graphs. A subgraph is defined as a list of paths, where the path is defined by a pair of nodes, a relationship between them, and associated key, ID, properties, labels, version, etc.

The first set of nodes may have zero, one, or more nodes that are also present in the second issue graph. The first set of relations may have zero, one, or more relations that are also present in the second issue graph. The subgraph merging module may determine at least one anchor node in the first set of nodes, indicating a node that is present in both the first set of nodes and second issue graph. The anchor node may be used as the initial merging point in the merging strategy described below. For example, if first set of nodes contains a newly introduced bill node and legislator node with a sponsor relationship, and the second issue graph contains the same legislator node, the merging logic would attempt to match the bill node to an existing bill node in the second issue graph without success, match the first legislator node to the second legislator in the second issue graph successfully, and create a new sponsor relationship between the bill and legislator nodes in the resulting third issue graph.

In some embodiments, the identification (ID) system of the first set of nodes may be distinct from the ID system of the second issue graph node (i.e. the nodes may represent the same entities, but do not have the same IDs representing those entities). For instance, the first set of nodes may be generated by an external system with a distinct ID system from the second issue graph. In some embodiments, the ID system of the first set of nodes may be the same as the ID system of the second issue graph.

In some embodiments, the subgraph merging module may receive a merging strategy, indicating the merging logic and constraints for merging first set of nodes and relations into second issue graph. The subgraph merging module may compute matching nodes (i.e., nodes representing the same real-world entities) in the first set of nodes to nodes in the second issue graph. In some embodiments, subgraph merging module may use the node ID in the first set and node ID in the second issue graph to identify common nodes in both first set of nodes and second issue graph. In some embodiments, subgraph merging module may use the node label in the first set and node label in the second issue graph to identify common nodes. In some embodiments, subgraph merging module may use the node properties in the first set and node properties in the second issue graph to identify common nodes. In some embodiments, subgraph merging module may use the node type (e.g. person, document, etc.) in the first set and node type in the second issue graph to identify common. In some embodiments, subgraph merging module may use the node relationship(s) in the first set and node relationship(s) in the second issue graph to identify common nodes. In some embodiments subgraph merging module may use a combination of one or more of ID, label, type, relationships and properties to create a key. In some embodiments, a key may have different types (e.g., relative, internal, and external). For example, an external key type may represent a node with a natural ID of an entity, such as a bill. “keyType:external, type:legislation, source:natural, id:US1234.” As another example, an internal key type may represent node with a system generated ID of an entity, e.g. a vote: “keyType:internal, source:data,type:vote,id:1234567”. As another example, a relative key type may represent a node with a relative relationship to another node, e.g. a title node relative to the document body node: “keyType:relative,type:title,id:1234”. In some embodiments, subgraph merging module may use the generated key to identify nodes and relationship(s) in common in the first set of nodes and in the second issue graph.

If the ID system of the first set of nodes is distinct from the ID system of the second issue graph nodes, subgraph merging module may generate temporary IDs representing the first set of nodes in the ID system of the issue graph nodes for the execution of the merging logic. This allows an external system to make updates to the graph without known the internal ID system of the knowledge graph. For instance, the temporary IDs may be the keys generated above. Temporary IDs may be output to the external system that generated the first set of nodes.

In some embodiments for matched common nodes, properties and/or relations in the second issue graph may be overwritten by properties and relations in first set. In some embodiments for matched common nodes, existing properties and/or relations may remain as in the second issue graph and new properties and/or relations are inserted. When upserting keyed relationships between nodes, existing instances of the relationship in the second issue graph may be modified, or remain and a new keyed instance between the nodes is inserted. When upserting non-keyed relationships that exists in the second issue graph (i.e. existing unique relationship between nodes), merging logic may indicate that relationship and associated properties are to be updated in second issue graph to reflect the relationship and associated properties as indicated in the first issue graph, or for existing relationship and properties to remain as they exists, and only new properties be added. Subgraph merging module may create a subgraph with a mix of keyed and non-keyed nodes and keyed and non-keyed relationships.

In some embodiments, subgraph merging module may execute the merging logic as an atomic operation, in that either all of the node and relationship upserting operations are performed successfully on the second issue graph to generate the third issue graph, or the operation does not generate a third issue graph.

In some embodiments, the subgraph merging module may check the version of node properties or relation properties. For instance, if the current version in the first set of nodes is below the version in second issue graph, the merging logic may indicate not to perform an update. In other cases, the merging logic may indicate a specific version to be used, such as a previous version to rollback updates to.

In some embodiments, the subgraph for two users may have the same nodes and edges (e.g., system provided data). In some embodiments, the subgraph for two users may have same nodes but different edges (e.g., system provided data and user added a relationship between two people). In some embodiments, the subgraph may have different nodes and edges including zero, one, or more system provided nodes/relationships and zero, one, or more user provided nodes/relationships. In some embodiments all system and user information may be stored in one graph, with access permissions for users to access subset of graph. In some embodiments, subset of users may have graph with system and user content. In this manner, a first user may have all the system data they have access to plus the first user's own data in a first graph, and a second user may have all system data they have access to plus the second user's own data in a second graph.

In some embodiments, system 100 may implement the distributed graph database by conducting computations over multiple subgraphs, which jointly form one complete graph. In some embodiments, the system 100 may also impose a limit on the size of the graph or perform certain pruning operations at inference time to retrieve the relevant set of results in a reasonable amount of time. For instance, pruning may be carried out based on a threshold value of the score associated with a relationship. Score may be provided by the model/system that extracted/assigned the relationship, and can indicate a likelihood score assigned by the system/model, or confidence value in the assignment/extraction.

Citation Issue Graphs

In some embodiments, information such as citations (e.g., references to legislative, statutory, regulatory and other legal documents) and the like may be extracted from unstructured document content. In some embodiments, system 100 may extract the citations by using a citation parsing module. In some embodiments, the citation parsing module may include rule-based linguistic parsers, machine-trained syntactic parsers or sequence labelers (e.g., CRF or neural network sequence to sequence models) or and combination thereof trained to extract legal citations, and the like, and may be utilized to identify sequence of characters that indicates a citation. The citation parsing module may further be trained to utilize document content to classify the extracted citation into various citation types (e.g., modify, reference, authorize, etc.). System 100 may use the classified citation type to create links with the respective type property value (e.g. a “proposed_modification” relationship). It is to be understood that the system may be configured to support various citations styles, including, but not limited to, legal citations.

In some embodiments, the system may normalize the extracted sequence of characters to a standard format (e.g., extracted 12 USC Chapter 1-5 may be normalized to individual 12 USC 1, 12 USC 2, etc.). In some embodiments, the system may store the normalized citations as separate relationships/nodes. In some embodiments, the system may compare the extracted citations against extant law (e.g., for Federal matters, the system may compare against Public Laws, USC and/or CFR). In such embodiments, the system may check the citations and determine whether or not the citations are legitimate.

In some embodiments, the system may construct the knowledge graph with citations. For example, the system may add nodes for each legitimate citation. In some embodiments, the system may also add nodes for citations that cannot be verified. The system may also add relationships by connecting cited documents citation nodes with cited/references type of relationships. The system may also add more specific relationships, including, e.g., authorizes/modifies relationships. In some embodiments, the system may create relationships between a citation data node and document node with text of the actual citations. In other embodiments, the system may connect cited document to document node representing citations directly.

In some embodiments, the system may compute likelihood scores or confidence scores for the extracted citations. In some embodiments, the system may compute likelihood scores or confidence scores to the type of citation categorized. The system may use the likelihood scores individually, or in combination to indicate a level of confidence of a determined relationship. In some embodiments, the system may store the scores as properties of the relationships or of the edges. For example, the scores may be stored as in a confidence property associated with the edges or relationships. The system may display the scores in various ways. For example, a user may select a relationship or edge to view the scores. In some embodiments, the scores may be represented graphically. For example, the edges may have varying widths, colors, dash types, or other visual properties that may correlate to a degree of confidence.

In some embodiments, the system can compute additional types of citation relationships, including similarity relationships intra- (e.g. from one USC section to another) and inter- (e.g., from bill to USC) documents that may create edges between documents/sub-sections of documents that were not linked by explicit/extracted citations. In some embodiments, similarity relationships may be based on lexical similarity or embedding-based similarity (e.g., cosine distance of embedded node representations). For example, a news article may refer to a policy document using a description or plain text title of the policy without an explicit citation format. The system may compute multidimensional representations of the news article and policy document, then compute distance between them, and if above a threshold generate a link between the news article and the policy document with the similarity score represented as a confidence property on the edge.

Likewise, the system may apply topic categorization, key phrases, organizations commenting on regulations, parts of litigation/enforcement actions, and other relation types. In some embodiments, the system may expand the graph to include document nodes with relationships including explicit, extracted, and additional relationship types.

In some embodiments, the system may utilize a citation prediction module to construct citation prediction models and impact models using the knowledge graphs with citations. For example, in some embodiments, the citation prediction module may use existing connections determined from explicit citations in metadata and extracted through parsing as described above to form an initial training set. This training set may represent, for example, what administrative sections or documents, statute sections or documents, authority enforcement actions, or rules the citations were based on; what bills were codified (and codified into what statutory code); what bills modified what statutory code; what rules modified what administrative code; what litigation was based off of which administrative/statutory sections; what news articles were referencing what policy, and so on. For example, as shown in FIG. 48E, multiple documents, including, e.g., bills, US code, public law, and various dockets may cite, authorize, or modify a section of CFR, directly or indirectly, resulting in an issue graph with relationships established between the documents and the CFR as depicted in the figure. In some embodiments, the “modifies” relationship may be a proposed modification, which may be indicated as “proposed_modification.” It is to be understood that the various relationships depicted in FIG. 48E are examples and are not meant to be limiting.

In some embodiments, the citation prediction module may compute probabilities/correlations of each set of links, e.g., how often bill cites which sections of other legal document types, how often sections modified together, how often enforcement from section, how often litigation from document/section, etc. In some embodiments, the system can add additional types of relationships to the training data. The system may expand the training data to include document nodes with relationships including explicit, extracted, and additional relationship types described above, including similarity, topic categorization, key phrases, commenting, etc.

In some embodiments, the system may build a prediction model for formulating predictions based on the training data. For example, the system may utilize the prediction model to predict when a policy is introduced what nodes (e.g., documents, persons, organizations) are likely to be related, what nodes (e.g., documents, persons, organizations) are likely to be affected, how certain policies may be implemented and enforced, and what may result in litigations and the like. For example, when a new bill is introduced, the system may predict what existing law, e.g., USC or CFR, the new bill may affect. The system may also predict which entities, agencies (who may issue rules based on the new bill), organizations (who may comment on, or be affected by, the new bill) are likely to be affected.

In some embodiments, the system may build a prediction model that produces a single predicted outcome. Alternatively, in some embodiments, the system may build separate models for formulating predictions. In some embodiments, features used from training data for training prediction models may include text of each document involved and/or extracted/parsed relationships (e.g., citations, topics, etc.). In some embodiments, the prediction models may also produce a likelihood or confidence score for each predicted relationship. For example, the prediction model may produce a likelihood score indicating the likelihood that a bill will modify a certain US code, a likelihood that a change to a particular US code will result in modifications to a certain CFR, a likelihood that an agency will promulgate rule based on authorization resulting from the enactment of a bill, or a likelihood resulting that an issue may result in litigation.

In some embodiments, the system may also use the prediction model to predict whether a new policy document is relevant to an existing litigation, code, or regulations. For example, a user working on a new bill may be interested in learning what existing litigation(s), code, or regulations are related to the new bill so that the user can make informed decisions. In some embodiments, the model predictions may be added to the knowledge graph as a relationship between entities. In some embodiments, the system may use a new relationship type such as “predicted_modification” or the like (to indicate that such relationships are predicted). Alternatively, the system may use an existing relationship such as “modified by” along with a likelihood/confidence score set in it properties.

Issue Gravitas Measures

In some embodiments, users of system 100 may use one or more issue graphs constructed by system 100 to compute various types of metrics, including: “Interest,” “Influence,” “Agreement,” “Accessibility,” and “Ideology.”

In some embodiments, system 100 may use a graph algorithm to perform graph analysis to compute various types of metrics. In some embodiments, the graph algorithm may calculate one or more known centrality measures. The centrality measure may be one of degree centrality, in-degree centrality, out-degree centrality, closeness centrality, betweenness centrality, eigenvector centrality, Katz centrality, PageRank centrality, Percolation centrality, Cross-clique centrality, and the like. In some embodiments, the graph algorithm may calculate other node and edge measures, including accessibility measures and expected force measures. The use of other known measures to analyze node and edge relations to identify influential nodes is contemplated. In some embodiments, the graph algorithm can be directly computed by computations performed on a matrix representation of the graph.

In some embodiments, system 100 may utilize an interest module to calculate “interest” to measure how likely a person entity (e.g., a stakeholder, a legislator, a policymaker, a system user, etc.) is to be interested in an issue based on the entity's observable (e.g., sponsorship, voting, lobbying, donating, biographical, historical) activity. In some embodiments, “interest” may indicate whether an entity appears to be interested in an issue based on the person's observable activity. In some embodiments, the interest module may compute the interest metric by evaluating an issue graph. For example, the interest module may compute the interest metric as a centrality metric, calculated based on a network of bills and sponsors with machine-tuned weights. The interest module may take various factors into consideration, including, e.g., how interested that person is in a topic or an issue, whether that person works in this area of legislation, etc. In some embodiments, the interest module may analyze the bills related to a particular issue and synthesize a combination of the attributes to compute an interest metric. In some embodiments, the attributes considered may include, e.g., how many bills related to this particular issue did this person sponsor, how many committee hearings regarding this issue did this person participate in, whether the sponsored bills attracted many cosponsors, whether this person cosponsored many other bills in this issue, etc. In some embodiments, the attributes considered may include, e.g., whether this person has raised money for, or advocated/lobbied on behalf of policy related to this issue, or received contributions for, or been lobbied related to policy on this issue. In some embodiments, the attributes considered may include, e.g., whether this person is employed at an organization interested in this issue, has organizations interested in this issue operating in, having personnel in, or otherwise interested in the locality they represent. In some embodiments, the attributes considered may include how many bills related to this particular issue the person has interacted with (e.g., indicated a relevance/priority/position).

In some embodiments, system 100 may utilize a graph generator module to create an issue graph that includes all bills related to a certain issue and their legislative sponsors. Links (or edges) in the graph may be weighted to reflect how “close” a legislator is to a bill. For example, in some embodiments, weights may be assigned based on observable data. In some embodiments, the graph generator module may weigh one or more edges of the graph with a weight having a value indicating a relationship between nodes. In some embodiments, system 100 may calculate the weights using a plurality of factors. For instance, the graph generator module may assign higher weights to primary sponsors and lower weights to cosponsors. In some embodiments, weights may be assigned based on the inverse of the total number of sponsors. For instance, a legislator may have a strong connection to a bill where the legislator is the only sponsor, and a relatively weaker connection to a bill where the legislator is one of many sponsors. In some embodiments, weights may be estimated and tuned using algorithms that incorporate additional data about legislators and bills. The graph generator module may take various factors into consideration, including, e.g., whether the legislator has sponsored other bills on this topic, whether the bill has been introduced in a previous legislative session, and the like.

In some embodiments, the graph generator module may calculate the weights based on the number of times two or more policymakers have voted together, sponsored together, received donations from similar organizations, or attended the same school or schools. In some embodiments, the graph generator module may create an issue graph that includes all bills related to a certain issue and stakeholders. Links may be created as described above between people and bills. For example, the issue graph may indicate whether the person has a relationship with the bill (lobbied for/against, indicated relevance/position, mentioned in etc.). In some embodiments, the graph generator module may weigh one or more edges of the graph with a weight having a value indicating a relationship between nodes. In some embodiments, the graph generator module may calculate the weights using a plurality of factors. For instance, the graph generator module may assign higher weight based on higher number of interactions. In some embodiments, weights may be assigned based on the type of interaction. For instance, the graph generator module may assign a higher weight for person having a committee hearing testimony relationship with the bill, than lobbying relationship with the bill, than bill relevant to relationship.

In some embodiments, system 100 may utilize an interest module to calculate “interest” based on an issue graph as described above. For example, the interest module may use a graph algorithm to find an importance score for all nodes in the “interest” graph. In some embodiments, system 100 may identify the highest scoring nodes as the most interested and the lowest scoring nodes the least interested. In some embodiments, the actual scores may not be directly interpretable but can be used to rank all legislators in a chamber or directly compare two legislators (e.g. “twice as interested”). In some embodiments, attributes of the issue graph associated with high interest scores (because the issue graph is created with these connections, all of these graph attributes aspects influence the algorithms used to estimate interest) may include, e.g., sponsoring many bills on an issue means that a legislator has more connections in the issue graph, sponsoring bills that attract many cosponsors indicates that other legislators look to this legislator for guidance on an issue, cosponsoring other legislators' bills indicates interest, even if the legislator does not sponsor the bill themselves, sponsoring bills that attract high advocacy or lobbying interest, and the like.

It is to be understood that the descriptions of “interest” above are presented as examples and are not meant to be limiting. While the examples above deal primarily with legislators and bills, it is to be understood that system 100 may also calculate metrics for other entities involved in policy using a similar approach (e.g., regulators, judges, NGOs, trade associations, organizations, stakeholders, non-policymakers, system users). For example, attributes of system users that can be computed by the system in an issue graph and associated with high interest scores may include, e.g., indicating many bills are relevant in an issue, indicating many bills are high priority in an issue, high lobbying amount or on many bills in an issue, running large advocacy campaigns or many advocacy campaigns on bills in an issue, and the like. For example, an organization's history of offering comments on regulations or an individual's campaign donations could be used by the system to generate additional relations and weights between organization and individual nodes to policy and policymaker nodes in an issue graph and be used by the system in computing interest scores for these entities as well. In some embodiments, an organizational interest in a bill may be calculated by generating a relation based on the organizations public statements on a bill (e.g. press release, testimony, etc.); comment on a regulation, for example, if a relationship indicates that the organization has commented on a regulation proposing a modification to a part of the CFR that was authorized by a USC section that was modified by the bill; has a lobbying or contributing relationship to a sponsor; has a similarity relationship to another organization with interest; has relationship to sponsors; is mentioned in the bill, belongs to an industry impacted by the bill, or has employees/offices/business operations in a district represented by a sponsor. In some embodiments, an individual non-policymaker stakeholders interest on an issue may be calculated from their donations to a political entity that has an interest in this issue, their biographical information (e.g. work history), or demographical information (party affiliation). In some embodiments, an individual or organization system user interest on an issue may be calculated from their system activity, including interaction with, labeling, discussing policy documents associated with an issue.

In some embodiments, system 100 may utilize an entity influence module to calculate “influence” (may also be referred to as “power,” “centrality,” or “importance”) to measure how likely a person or organization entity is to influence a plurality of people or organizations on an issue. In some embodiments, “influence” may qualify a person's influence on others on an issue. In some embodiments, an entity influence module may compute the influence metric for a policymaker by taking various factors into consideration, including, e.g., how much influence that person had on bills of a given topic in the past, the relationships between legislators and committees, the relationships between bills and committees, that person's sponsorship of bills (successful bills may receive higher weights), and other leadership positions. Other factors taken into consideration may include, e.g., how important is that person to the issue (in contrast to “interest,” where system 100 computes the person's work related to an issue, this metric encompasses the person's ability to enact a change), is that person sponsoring or cosponsoring successful legislation on this issue, whether that person sits on relevant committees, whether that person has a large, active, or influential social media following, whether that person has a high popularity (e.g., as measured by press coverage, political capital), whether that person has significant financial resources as their disposal, whether advocacy campaigns conducted by the person produced a desired outcome, biographical information (e.g., previous or current employment or membership in influential organizations), level of computed interest, etc. In some embodiments, legislators belonging to a majority party or a party in power for the given session may have more influence. Additionally, committee positions and leadership roles may change during sessions, so the influence metric may change with respect to a given snapshot in time.

In some embodiments, the influence metric may encompass a person's ability to enact a change. To that end, the entity influence module may analyze a broader issue graph including committee assignments for both bills and legislators. Bills that have passed may be upweighted, giving additional importance to successful sponsors. Committee, chamber, or party leadership may also be upweighted, indicative of their increased importance for gatekeeping. In some embodiments, the entity influence module may analyze the issue graph and synthesize a combination of the attributes to compute an influence metric of a policymaker. In some embodiments, the attributes considered may include, e.g., whether the person is on committees relevant to an issue, whether the person has leadership positions on committees relevant to the issue, whether the person has sponsored successful legislation relevant to the issue. In some embodiments, the entity influence module may compute a higher influence metric for legislators belonging to the majority party or the party in power for the given session. In some embodiments, the entity influence module may also account for committee positions and leadership roles change during sessions and recompute the influence metric periodically and respective to a given snapshot in time. In some embodiments, the attributes considered may include, e.g., whether the person was previously employed or affiliated with organizations relevant to the issue, whether the person appears or is referenced in research, or media reporting on the issue, or whether the person is active on social related to this issue. In some embodiments, the entity influence module may calculate the influence metric in similar manners for other entities, including, e.g., staffers, lobbyists, policymaker stakeholders, non-policymaker stakeholders, organizations, system users, bills, etc. In some embodiments, the entity influence module may also rank the entities within a node type.

In some embodiments, system 100 may utilize an entity influence module to calculate “influence” based on an issue graph as described above. For example, the entity influence module may compute a broad issue graph including relationships between legislator nodes and committee nodes, bill nodes and committee nodes, sponsorship of bills relationships, and other leadership position properties on legislator nodes. Links/connections may be weighted to reflect how important a bill or individual is. For example, legislators with a committee chair property may receive higher weights than other membership because of their importance for gatekeeping, and bills receive an incremental weight for each successive stage in the legislative process, thus bills that passed are weighted higher than bills that have not progressed through the legislative process. In some embodiments, the exact magnitude of these weights may be chosen prior to the calculation of the influence metric, through expert judgement entered into the system by the user, system settings, and hyperparameter optimization, or a combination thereof. Weights can be uniform (e.g., each relation has weight=1, a introduced bill has a weight of 5, a passed bill has a weight of 100), system-wide (e.g. weight Z for all legislators with leadership position, or user-specific (e.g. same relation for different system users has different weight).

In some embodiments, given an issue graph as described above, the entity influence module may use a graph algorithm to find an importance score for all nodes in the “influence” graph. In some embodiments, the graph algorithm may treat each relation as equally weighted, and calculate the score of each node as its degree, i.e., a type of degree centrality, the number of relations incident on each node. In some embodiments, the graph algorithm may sum the weights of the edges of relevant nodes to compute a score for each node. In some embodiments, the graph algorithm may compute the importance scores by calculating one or more centrality measures.

In some embodiments, the graph algorithm may compute a probability distribution. For instance, to calculate the influence scores for legislators on a bill, the algorithm may start on that bill and randomly select one of its related nodes based on each edges importance weights and follow it to the selected node. From that node, the algorithm may randomly select one of the new nodes relations with probability (1-p) or reset to the initial node with probability p. This process may then be repeated at the next node. The reset probability can be set by the system, or tuned and estimated as part of this process. The algorithm may be personalized because it may reset to the initial node in question, as standard PageRank may reset to a randomly selected node. In this manner, the legislator that is most visited during this process may be identified as the most important legislator in the graph.

In some embodiments, the entity influence module may identify the highest scoring nodes as the most influential and the lowest scoring nodes the least influential. In some embodiments, the actual scores may not be directly interpretable but can be used to rank all nodes, such as legislators in a chamber or directly compare two policymakers (e.g., “twice as influential”). In some embodiments, attributes of the graph associated with high influence scores may include, being on one or more committees relevant to an issue, having leadership positions on committees relevant to an issue, having sponsored successful legislations relevant to an issue, having served in positions in organizations related to the issue, and the like. In some embodiments, the entity influence module may be utilized to calculate a statistical model aggregating the importance scores computed by the graph algorithm. For example, the statistical model may compute that an organization has twice as many relationships as another organization to a particular policymaker, or has fewer highly weighted relationships than another organization, or has donated, in aggregate, more than 30% of what organizations in a similar industry have to policymakers on a particular issue, or has more relationships to a particular policymaker than 95% of organizations in the graph. In some embodiment, the entity influence module may have a threshold to determine influence level. The threshold may be determined by the system, or input to the system by the user.

In some embodiments, the graph algorithm may utilize a user-defined set of people nodes, including policymakers and non-policymaker stakeholders, identified as influential and compute the weights, as described above. Identification can be binary (e.g., influential or not), ranked, or specific scores associated with each person node. In some embodiments, the graph algorithm may calculate the weights using a machine learning algorithm, and in some embodiments, the graph algorithm may learn to weigh relations so that a user-defined set of people in the training data is scored highly by the model. In some embodiments, the training set of people nodes may be determined by the system, and in some embodiments, the training set of people nodes may be determined by a combination of system user and system.

In some embodiments, the graph algorithm may calculate the influence scores for organizations in a similar manner. In some embodiments the influence score may represent the influence of the organization on policymakers. In some embodiments the influence score may represent the influence of members of an organization on policymakers. In some embodiments the influence score may represent the influence of the organization on other organizations. In some embodiments, the influence scores may be calculated by taking into account the organizational posture, ideology, gravitas, influence, and the effectiveness in achieving their agenda. For example, an issue graph may be generated by the graph generator module including entity nodes for all organizations that have submitted a lobbying disclosure, including an edge to the policy or policymaker lobbied, weighted by the monetary amount lobbied; organization that submitted comments on a Federal regulation, including an edge to the regulation commented on, and to the agency promulgating the regulation, weighted by the absolute value of the stance calculated by the stance detection model based on the comment content; and organizations that have offices in a legislative district, including an edge to the policymaker representing the district, weighted by the revenue of the organization. Influence model may compute influence scores using the graph algorithm for one or more organizations on one or more policymaker as described above, where organization that has many high monetary amount lobbying relations, many highly stance bearing comments, and many office locations in legislative districts, may be computed to have a higher influence score than an organization that has fewer or lesser weight relations.

In some embodiments, a machine-trained model may be built using machine learning to compute an influence score for one or more organizations on one or more policymakers (e.g. legislators, regulators, agencies) based on the issue graph. For example, the organizational issue graph with relations described above may represent the input training data, paired with the desired output of an influence score or ranking of one or more organizations. The desired output influence score may be input to the system by the user, or determined by the system. The machine-trained model learns a weighting for each relation (e.g., lobbying, commenting, office locations, etc.), based on computing correlation between relation and desired output influence score/ranking of an organization. In some embodiments, the desired output influence score/ranking is associated with a particular organization and policymaker pair, in some embodiments it is associated with a particular organization and issue pair. The machine-trained model may also produce a confidence score associated with the influence score.

It is to be understood that the descriptions of “influence” above are presented as examples and are note meant to be limiting. While the examples above deal primarily with legislators and legislation, it is to be understood that the entity influence module may also calculate metrics for other entities, including, e.g. staffers/legislators, organizations, industries/bills, firms/industries, and the like.

In some embodiments, system 100 may utilize an entity agreement module to calculate “agreement” (may also be referred to as “alignment”) to measure how likely an entity is to agree with a system user on an issue. For example, system 100 may include an agreement score module configured to generate an agreement score indicating degree of how likely an entity is to be in agreement. In some embodiments, the agreement calculation may be based on a policymaker voting history (and forecasted votes) and the user's own position (and/or forecasted position). A user may use an “agreement” measure or score to determine, e.g., whether a policymaker shares the user's views on an issue and given a user's position on bills in an issue, how frequently a legislator's views may align with the user. In some embodiments, the agreement metric may be expressed as a percentage of time that a given legislator agrees with a user's position on a bill. In some embodiments, entity agreement module may apply a normalization to the metric, where entity agreement module may account for the fact that some legislators have had more opportunities to agree than others. In some embodiments, for votes on bills that have not yet occurred, entity agreement module may calculate an imputed agreement metric based on the forecasted vote (as described in a virtual whipboard, as discussed above) for a given legislator. In some embodiments, entity agreement module may take various factors into consideration for calculating the agreement metric for a person, including, e.g., whether that person shares the user's views on the issue, how frequently does that person's views align with the user, etc. In some embodiments, entity agreement module may analyze the issue graph to determine an agreement percentage through votes on bills where the user's position is known or using predicted votes and ideology. In some embodiments, document content may be analyzed using known natural language processing algorithms to compute a stance on a given issue. In some embodiments, document content may be analyzed to determine a policymaker's position. For example, entity agreement module may parse a transcript statement from a floor debate, apply named entity recognition model to identify policymaker speaking events and policy name mentions, parse the text of those speaking events related to the policymaker, apply a topic identification model to identify the issue(s) the policymaker is speaking about, with associated confidence score for issue identification, apply a sentiment/stance detection model to determine stance policymaker is expressing on the one or more issue(s), with associated confidence score for sentiment/stance, and store the policymaker position based on the computed sentiment/stance as a relation of one or more of these policymaker, policy, or floor debate document in the issue graph. Other content by the policymaker (i.e., committee hearing transcripts, social media posts, press releases, dear colleague letters, etc.) may similarly be input to entity agreement module to extract policymaker position. In some embodiments, document content may be analyzed to determine a user's position. For example, entity agreement module may parse the text of a user uploaded document, apply named entity recognition model to identify policymaker and policy name mentions, apply topic identification model to identify the issue(s) contained therein, with associated confidence score for issue identification, apply a sentiment/stance detection model to determine stance user is expressing on the one or more issue(s) or one or more policies, with associated confidence score for sentiment/stance, and store user position as a relation of one or more of the user, policy or user document in the issue graph. In some embodiments, content may be analyzed to determine an organization's position. For example, entity agreement module may parse the text of a news, use named entity recognition model to identify organization name and policy name mentions, parse the text of those spans associated with the organization, apply a topic identification model to identify the issue(s) the organization is speaking about, with associated confidence score for issue identification, apply a sentiment/stance detection model to determine stance organization is expressing on the one or more issue(s), with associated confidence score for sentiment/stance, and store the organization position(s) based on the computed sentiment/stance as a relation of one or more of the organization, policy, or news document in the issue graph. Other text content by the user (i.e., a press release, regulatory comment, committee testimony, etc.) may similarly be input to entity agreement module to extract organization position.

In some embodiments, the entity agreement module may extract the set of vote data (e.g., legislator, bill, vote, etc.) from an issue graph. In some embodiments the entity agreement module may augment the extracted vote data with forecasted votes (e.g., using a virtual whipboard described above) if desired. In some embodiments the entity agreement module may augment the extracted vote data with positions computed from other text documents as described above. In some embodiments, entity agreement module may calculate “agreement” as the percentage of time that a given legislator position agrees with a user's position on a bill. In some embodiments, the percentage may be normalized to account for the fact that some legislators have had more opportunities to agree than others. In some embodiments, the entity agreement module may add in the forecasted votes, yielding an imputed agreement score which may be useful where vote data is sparse or nonexistent. It is to be understood that the entity agreement module may also use algorithmic ideology calculations along with bill content to calculate agreement scores for bill content in advance of being voted on. Additionally, “agreement” scores can be calculated for any entity that has expressed a stance on a bill or other legislative/regulatory text. It is also to be understood that the “agreement” described above is not limited to measure how likely a policymaker is to agree with a user. For example, in some embodiments, “agreement” may also measure how likely an organization is to agree with a user on an issue based on their positions, or an organization is to agree with another organization based on their positions.

In some embodiments, system 100 may utilize an accessibility score module to calculate “accessibility” to identify paths in the issue graph that allow a user to be connected with another entity. A user may use “agreement” measure to determine whether a path exists, e.g., whether the users has access to another person (e.g., a stakeholder). In some embodiments, the accessibility module may identify paths with one edge, e.g. whether the user has a direct contact to the entity. In some embodiments, the accessibility module may identify paths with two edges, e.g. whether the user has a direct connection to someone who has a direct connection to the entity, e.g. the user has a connection to a staffer on the policymakers staff. In some embodiments, the accessibility module may analyze the issue graph to obtain connections through the user's contacts. In some embodiments, the accessibility module may match a user's contacts against the contacts of people entities connected with the user. Based on the matched list, the accessibility module may identify legislators who have direct connections with the user, legislators' staffers who have direct connections with the user, and legislators with do not have direct connections with the user. In some embodiments, the accessibility module may also cross reference the identified contacts against certain issues selected by the user, allowing the user to identify the contacts who are most important to the selected issue. This also allows the user to identify non-contacts who are important to the selected issue, effectively providing the user with a list of outreach targets. In some embodiments, the accessibility module may also provide information regarding additional relationships. The additional relationships may include, e.g., relationships between organizations and policymakers (computed as described above from for example, campaign financing, lobbying disclosures, professional history), relationships between contacts and policymakers (e.g., through lobbying disclosure forms, professional history), etc. In some embodiments, the accessibility module may identify multiple paths between a user and an entity and rank the multiple paths. In some embodiments, paths may be ranked by number of edges. In some embodiments, paths may be ranked by using importance ranking of person nodes in the path (described above). It is to be understood that the “accessibility” described above is not limited to how easy is it for a user to connect with another person. For example, in some embodiments, “accessibility” may also measure how easy is it for a user to connect with an organization, or how easy is it for one organization to connect with another organization. In some embodiments, the system may display accessibilities of user specified non-policymaker identities and relationships to policymakers.

In some embodiments, system 100 may utilize an ideology module to calculate “ideology” to scale policymakers relative to each other on a real-valued numerical scale (e.g., line up the policymakers on an ideological spectrum) using known ideal point modeling methods. For example, in some embodiments, the ideology module may extract a set of vote data (e.g., legislator, bill, vote, etc.) from an issue graph. In some embodiments, the ideology module may implement a scaling algorithm to place legislators in an ideology space. The system may then compare legislators to one another, estimate distances between them, and determine likelihood of support for a piece of legislation by placing them into this same space. In some embodiments, the ideology module may also use bill content instead of bill indicators to perform the calculations. In some embodiments, “ideology” may also scale organizations relative to each other. For example, the organization stance can be treated as a binary vote in favor or opposition to a policy. The system may use organization stance on policy (e.g., regulations or legislations) computed from comments on regulations, statements on policy, lobbying disclosure, etc., to implement scaling to place organizations in an ideology space so that they can be compared against each other.

In some embodiments, system 100 may be implemented around the ability to add stakeholders to the issues workflow and record information about the stakeholders. Such information may include, e.g., stakeholder professional/educational history, logging actions taken with respect to a specific stakeholder and labeling stakeholder attributes such as issue expertise/relevance, importance, alignment, and accessibility. In some embodiments, system 100 may also provide users with one or more suggestions (e.g., through a user interface). The suggestions may include, e.g., an outreach target suggestion (e.g., “This contact seems important to this issue, would you like to arrange a meeting with them?”), a contact suggestion (e.g., “This person is important on this issue and you don't seem to know them, would you like to reach out?”), a mutual connection suggestion (e.g., “You and this stakeholder both know this staffer.”), an issue suggestion (e.g., “You should reach out to more people in this committee/agency/caucus that is relevant to the issue.”), etc. In some embodiments, system 100 may be implemented around the ability to add organizations to the issues workflow and record information about the organizations in similar manners.

In some embodiments, system 100 may further generate a gravitas score for one or more person nodes. For example, a gravitas score for a policymaker may represent how likely that policymaker is to sway or influence other policymakers. In some embodiments, system 100 may generate the gravitas score based on one or more metrics described above, including, e.g., the interest metric, the influence metric, the agreement metric, the accessibility metric, and the ideology metric. In some embodiments, system 100 may generated the gravitas score based on one or more metrics selected by the user, and in some embodiments, the selected metrics may include one or more aggregated or composite metrics. In some embodiments, system 100 may calculate the gravitas score based on an issue graph. In some embodiments, system 100 may further generate a gravitas score for one or more organization nodes. For example, a gravitas score for a organization may represent how likely that organization is to sway or influence policymakers. As another example, a gravitas score for an organization may represent how likely that organization is to sway or influence other organizations. In some embodiments, system 100 may generate the organization gravitas score based on one or more metrics described above, including, e.g., the interest metric, the influence metric, the agreement metric, the accessibility metric, and the ideology metric.

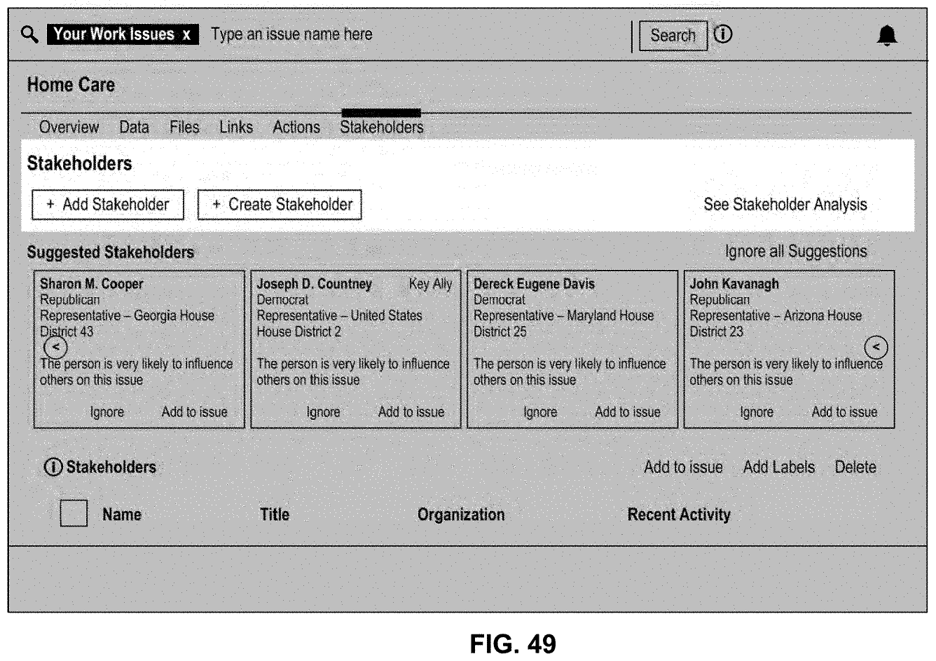

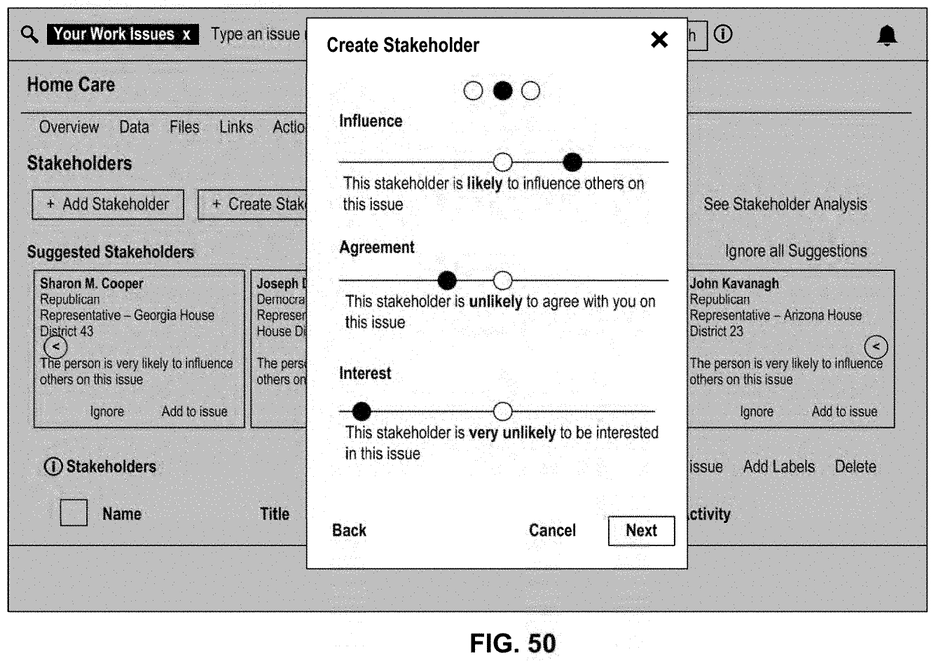

In some embodiments, system 100 may allow the user to enter proprietary data concerning certain entities. For example, if a user knows a particular stakeholder (e.g., a legislator, a policymaker, a non-policymaker, etc.) is influential, is unlikely to agree with the user on a particular issue, and is very unlikely to be interested in the particular issue, then the user may enter that information through an user interface provided by system 100. FIG. 49 is diagrammatic illustration of a GUI presenting an interface for a user to enter proprietary stakeholder data. FIG. 50 is a diagrammatic illustration of a GUI presenting an interface for the user to adjust the various metrics described above.

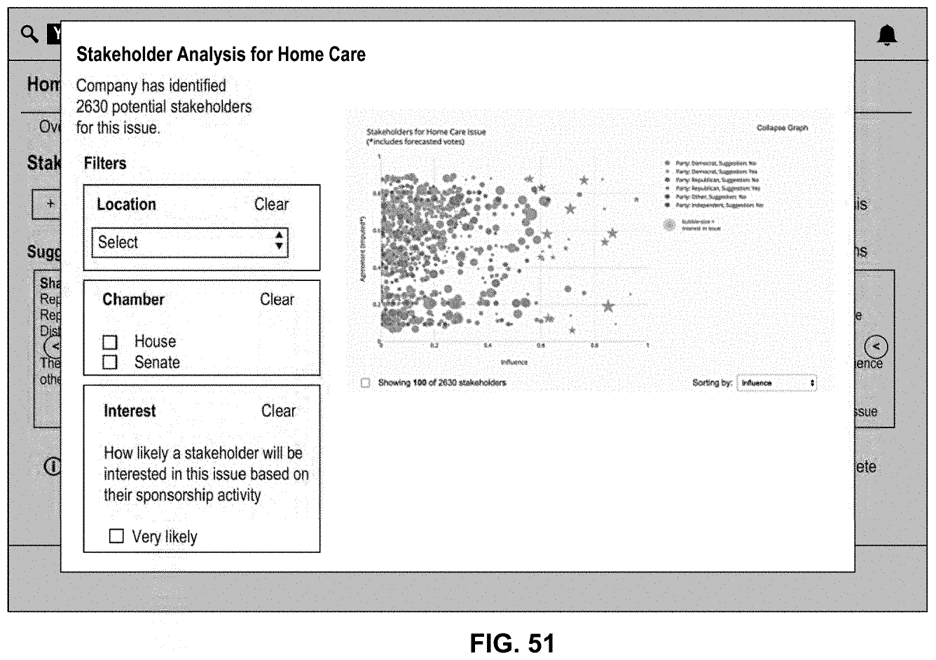

FIG. 51 is diagrammatic illustration of a GUI presenting a graphical display generated by system 100 that presents the issue graph of a particular agenda issue selected as being of interest to an organization. In this example, 1740 potential stakeholders are identified, and the user may interact with GUI to view the identified stakeholders.

FIG. 52 is diagrammatic illustration of a GUI presenting another graphical display generated by system 100 that presents the issue graph of a particular agenda issue selected as being of interest to an organization. In this example, more detailed information concerning each stakeholder may be displayed.

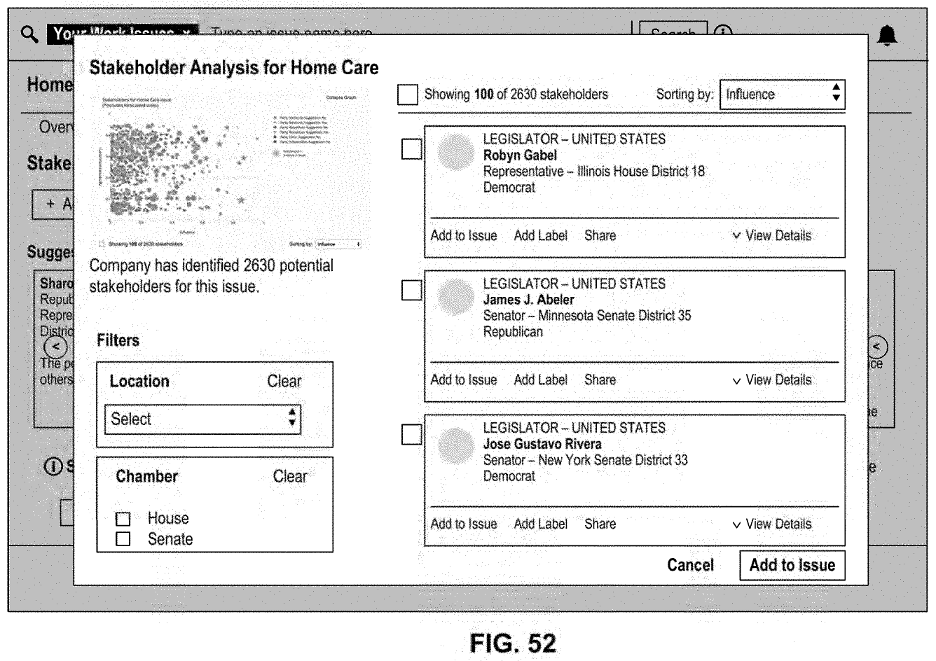

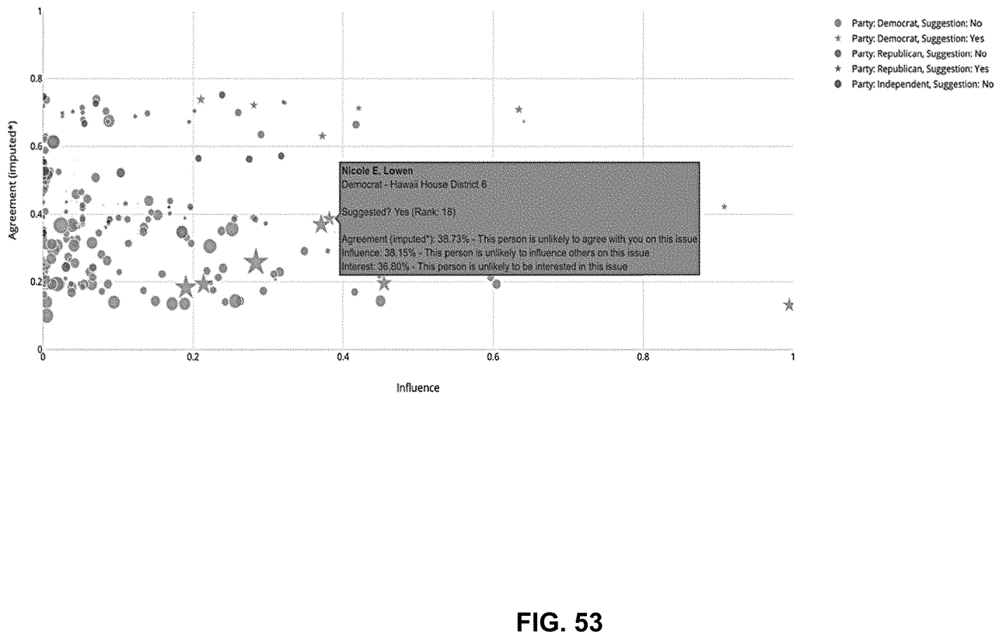

FIG. 53 is diagrammatic illustration of a GUI presenting still another graphical display generated by system 100 that presents the issue graph of a particular agenda issue selected as being of interest to an organization. In this example, more detailed information concerning a particular stakeholder and the relative position of this stakeholder compared to other stakeholders may be displayed.

In some embodiments, system may also provide the user with one or more suggestions (e.g., through a user interface). The suggestions may include, e.g., an outreach target suggestion (e.g., “This contact seems important to this issue, would you like to arrange a meeting with them?”), a contact suggestion (e.g., “This person is important on this issue and you don't seem to know them, would you like to reach out?”), a mutual connection suggestion (e.g., “You and this stakeholder both know this staffer.”), an issue suggestion (e.g., “You should reach out to more people in this committee/agency/caucus that is relevant to the issue.”), etc.

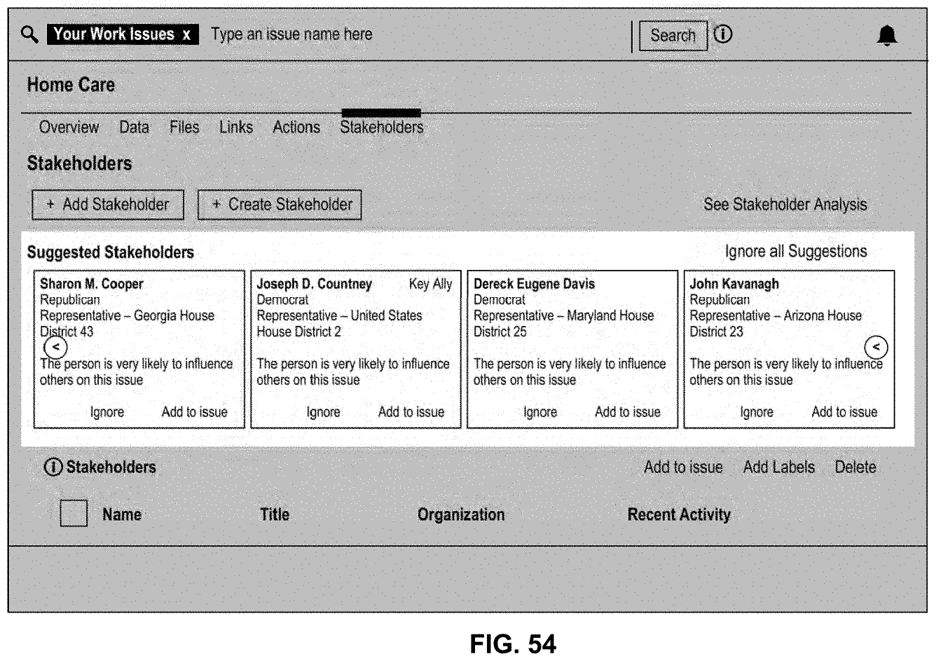

FIG. 54 is diagrammatic illustration of a GUI presenting a list of suggested stakeholders identified by system 100. The user may choose to ignore these suggestions, or selectively add one or more suggested stakeholders as relevant to the issue of interest.

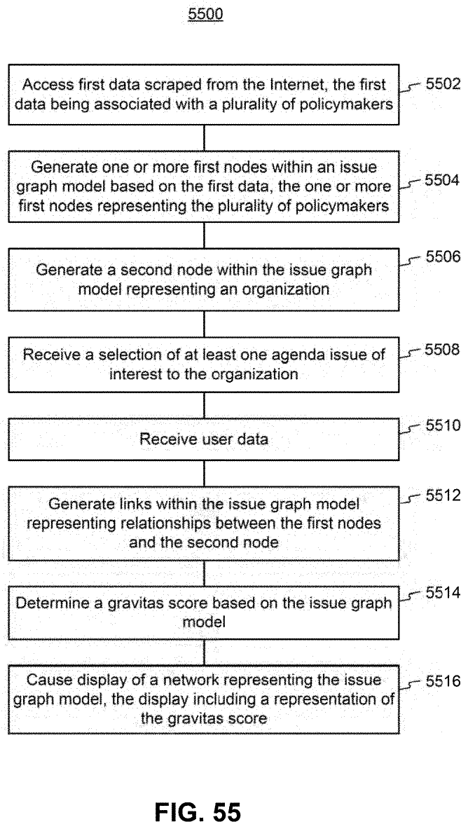

FIG. 55 illustrates an example flow chart representing a process 5500 for analyzing organizational interconnectedness consistent with disclosed embodiments. Steps of method 5500 may be performed by one or more processors of a server (e.g., central server 105), which may receive data from user(s) 107 selecting both agenda issues of interest and an indication of an organization's position, and subsequently present alignment position data to user(s) 107 based on the selection.

At step 5502, process 5500 may include accessing first data scraped from the Internet. The first data may be data associated with a plurality of policymakers, as described herein. For example, the first data may include demographic information for one or more policymakers, a voting history for one or more policymakers, or a party affiliation for one or more policymakers, or any other information pertaining to policymakers that may be obtained from the Internet or other publicly available electronic sources. In some embodiments, step 5502 may be performed using one or more applications configured to function as web scrapers, as described above.

At step 5504, process 5500 may include generating one or more first nodes within an issue graph model based at least in part on the first data. The one or more first nodes may be generated to represent the plurality of policymakers. In some embodiments, each policymaker may be represented by a first node within the issue graph model. For example, a policymaker may be represented as a node in an issue graph similar to person 3704, as shown in FIG. 37. In some embodiments, the issue graph may be generated using a machine-trained model, as described above. For example, the model may be trained to analyze information scraped from the Internet in step 5502 (i.e., the first data) and automatically generate nodes for different policymakers based on the information.

At step 5506, process 5500 may include generating a second node within the issue graph model representing an organization. For example, this may include generating a node similar to the node representing organization 3706, as described above with respect to FIG. 37. The organization may be identified in various ways. In some embodiments, the organization may be defined by a user. For example, a user may select or otherwise identify the organization through a user interface. As another example, the organization may be prestored in the system. For example, process 5500 may be performed for one or more organizations that have been identified previously. As another example, the organization may be identified based on the first data. For example, the organization may be associated with one or more of the policymakers or otherwise identified in the first data. In some embodiments, the second node may be generated using a machine-trained model, similar to with step 5504.

At step 5508, process 5500 may include receiving a selection of at least one agenda issue of interest to the organization. In some embodiments, the selection may be received through a user interface, which may be similar to the various user interfaces described above with respect to FIGS. 49-54. For example, step 5508 may include receiving a selection by user(s) 107 received at user input module 1208.

In some embodiments, the server may maintain a list of user-selectable agenda issues, from which the user may select the at least one agenda issue of interest in step 5508. The list of user-selectable agenda issues may be stored in modular database 1212, one or more storage servers 205a and 205b, and as part of sources 103a, 103b, and 103c comprising one or more local databases. The list of user-selectable agenda issues may be periodically updated, added, and deleted based on user input received at user input module 1208. User-selectable agenda issues may include legislative agenda issues or regulator agenda issues. User-selectable agenda issues may comprise any topic or subject matter as relevant to an organization and may be specific or broad in scope. In some embodiments, the at least one selected agenda issue may include at least one of a legislative agenda issue or a regulator agenda issue. As another example, the at least one selected agenda issue may be related to one or more government bodies. For example, as illustrated in FIG. 13A, user-selectable agenda issues may include “EU Privacy Direct 2016/680,” “TTIP,” “EU Directive on Cybersecurity” and may be related to issue areas such as “Cybersecurity,” “Privacy,” “Trade,” or government bodies, such as New York, China or Brazil. Other agenda user-selectable agenda issues corresponding to other issue areas may be contemplated.

In some embodiments, step 5508 may include presenting to the user, via the user interface, the list of user-selectable agenda issues. In some embodiments, each of the listed user-selectable agenda issues may be configured to be selected by the user via input received from the user. For example, as illustrated in FIG. 13A, the list may be presented as part of an exemplary GUI 1300 constituting an “Issue Board.” The “Issue Board” may aggregate all pertinent information relating to the list of user-selectable agenda issues in one consolidated dashboard. The list of user-selectable agenda issues and related information may be presented in tabular form and may include hyperlinks to allow for user selection and modification of agenda issues and related information.

In some embodiments, the server may present to the user at least one control to adjust weighting of each user-selected agenda issue, wherein the weighting constitutes an organizational posture reflecting an overall stance of the organization. For example, “Weighting” may include “High,” “Medium,” and “Low.” However, other more precise and quantitative controls to adjust weighing of each user-selected agenda issue may be envisioned. The term “overall stance” includes the aggregate or summary of final position of an organization as it relates to a particular item.

At step 5510, process 5500 may include receiving user data via the user interface. For example, the user data may be provided by user(s) 107 and received at user input module 1208. In some embodiments, the user data may be proprietary user data, as described herein. For example, the user data may include notes or outcomes from a private meeting, information obtained from a subscription news service or other service behind a paywall, calculations, notes, or other information generated by a user, or any other information that may not be readily available to the general public. In some embodiments, the user data may include an identity of at least one non-policymaker individual. For example, this may include a user of an electronic system that has a position or posture on the selected issue or another issue. Similarly, the user data may include at least one activity performed by a non-policymaker. For example, this may include, a voting history, a decision (e.g., a management decision, etc.), an opinion stated by the non-policymaker, a donation by or to the non-policymaker, or any other actions that may be performed by a non-policymaker that may have some indication or bearing on a posture of the non-policymaker or an associated organization.

At step 5512, process 5500 may include generating links within the issue graph model representing relationships between the first nodes and the second node. For example, this may include generating edges linking nodes to one or more other nodes within an issue graph model. As described herein, the issue graph model may be represented as a network of connections or lack thereof, between the first nodes (e.g., policymakers) and the second node or nodes (e.g., the organization) on each of the agenda issues. The relationships may be identified based at least in part on the first data, the user data, and the selected agenda issue. In some embodiments, the links may be generated using the machine-trained model, as described herein. For example, the machine-trained model may be trained to analyze structured or unstructured data and identify links between policymakers and organizations, as described above.

In some embodiments, process 5500 may further include calculating a weight for the one or more links within the issue graph model, as described herein. The weight may have a value indicating a relationship between nodes. For example, a greater weight between two nodes may indicate a stronger or closer relationship between the nodes. In some embodiments, weights may be calculated using a plurality of factors. For example, this may include a number of times two or more policymakers have voted together, a number of times two or more policymakers have sponsored together, a number of times two or more policymakers have received donations from similar organizations, whether two or more policymakers have attended the same school or schools, or various other factors that may indicate a weight of a relationship between nodes.

In some embodiments, process 5500 may include generating the issue graph model to include at least one policymaker on at least one additional agenda issue not selected as being of interest to the organization. For example, if the server determines that an additional agenda issue is relevant to an issue selected as being of interest to the organization, the server may include the additional agenda issue and the policymakers relevant to the additional agenda issue in the issue graph model. In another example, if a user has a particular interest in an issue in US, with associated US policymakers, US bill, user actions, but not in other countries, the server may determine, based on client-independent system computed relationships (e.g., similarities found in the US bill compared to a bill in a foreign country, or similarities found in a US legislator compared to a legislator in a foreign country), the server may generate an issue graph of policy/policymakers user has not interacted with before and compute the issue graph measures described above. Memory 1200 may further instruct database access module 1210 to search database 1212 for issue graph data stored therein. In some aspects, if issue graph data is not available, action execution module 1206 may scrape the Internet to obtain information for graph generator module to generate one or more issue graphs.

At step 5514, process 5500 may include determining a gravitas score based on the issue graph model. For example, the gravitas score may be calculated using a graph algorithm, as described herein. The gravitas score may represent a degree of influence one or more nodes may have over another node or nodes. For example, a gravitas score for a policymaker may represent how likely that policymaker is to sway or influence other policymakers. In some embodiments, system 100 may generate the gravitas score based on one or more metrics described above, including, e.g., the interest metric, the influence metric, the agreement metric, the accessibility metric, and the ideology metric. In some embodiments, system 100 may generated the gravitas score based on one or more calculation metrics selected by the user, and in some embodiments, the selected metrics may include one or more aggregated or composite metrics. In some embodiments, step 5514 may include generating the gravitas score based on a closeness of connections within the issue graph model.

At step 5516, process 5500 may include causing display of a network representing the issue graph model. Consistent with the disclosed embodiments, the issue graph model may be transformed into a graphical display that presents the issue graph of each of the agenda issues selected by the user as being of interest to the organization. In other words, the displayed network may be specific to the at least one selected agenda issue. The graphical display may be displayed as illustrated in FIGS. 49-54. Display in graphical form may provide useful information to visualize various metrics calculated using the issue graph model, as described above. In some embodiments, the display may include a representation of the gravitas score. In embodiments, where the gravitas score is determined based on at least one calculated metric selected by the user, the at least one calculated metric may also be presented in the display.

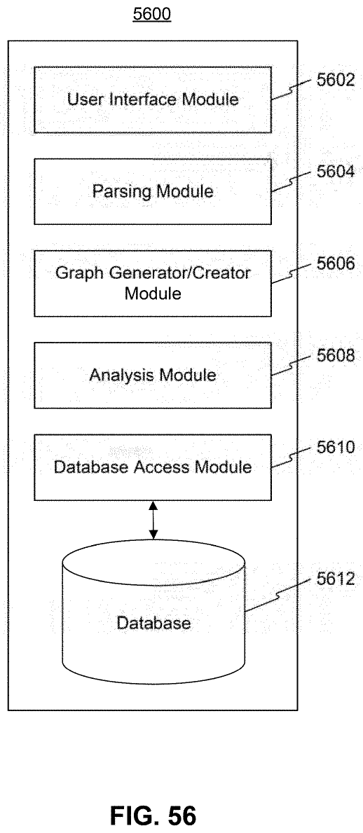

FIG. 56 is a memory 5600 consistent with the embodiments disclosed herein. Memory 5600 may include a user interface module 5602, a parsing module 5604, a graph generator module 5606, an analysis module 5608, a database access module 5610, and a database 5612. In some embodiments, memory 5600 may be included in, for example, central server 105, discussed above. Further, in other embodiments, the components of memory 5600 may be distributed over more than one location (e.g., stored in a plurality of servers in communication with, for example, network 101).

Based on a selection of user-selectable agendas from a list, user interface module 5602 may present to a user, via a user interface, the list of user-selectable agenda issues, wherein each of the listed user-selectable agenda issues is configured to be selected by the user via input received from the user. User interface module 5602 may also receive, via the user interface, based on the input received from the user, agenda issues of interest to an organization, the agenda issues having been selected from the list of user-selectable agenda issues. User interface module 5602 may further receive, via the user interface, based on the input received from the user, user issue graph data representing proprietary user data.

In some embodiments, memory 5600 may instruct parsing module 5604 to parse and ingest data from one or more data sources, as described above. For example, parsing module 5604 may parse names from text using various techniques, including off-the-shelf parsing techniques. Parsing module 5604 may also parse names of organizations from lobbying disclosures, parsing bills, acts, or regulation names from SEC filings, or parse names of people speaking during committee hearings from transcripts, parse names of legislators from legislative election results, parse names of meeting attendees out of user entered text, compute type of interaction (e.g., calls, meeting, and the like). In some embodiments, parsing module 5604 may include rule-based linguistic parsers, machine-trained models to extract legal citations, and may be used to identify sequence of characters that indicates a citation, and utilize language around the identified citation to classify the citation into various types (e.g., modify, reference, authorize, etc.).

In some embodiments, memory 5600 may instruct graph generator module 5606 to compute an issue graph model represented as a network of connections or lack thereof, between user issue graph data and policymakers on each of the agenda issues selected as being of interest to the organization. Memory 5600 may also instruct analysis module 5608 to calculate a gravitas score based on the issue graph network. In some embodiments, analysis module 5608 may calculate the gravitas score based on at least one of: an influence metric, an interest metric, an agreement metric, and an accessibility metric determined based on the issue graph network, which may be selected by a user. In some embodiments, analysis module 5608 may compute the issue graph model based on user provided data or the ingested data, and in some embodiments, analysis module 5608 may compute the issue graph model to include at least one policymaker on at least one additional agenda issue not selected as being of interest to the organization. Furthermore, in some embodiments, analysis module 5608 may calculate the gravitas score based on the number of connections and the closeness of those connections within the network. In some embodiments, analysis module 5608 may weigh the one or more edges of the network with a weight having a value indicating a relationship between nodes, and in some embodiments, analysis module 5608 may calculate the weights based on the number of times two or more policymakers have voted together, sponsored together, received donations from similar organizations, or attended the same school or schools, as described above.

In some embodiments, memory 5600 may instruct database access module 5610 to access database 5612 to retrieve or record the user provided data or the ingested data. Memory 5600 may also instruct database access module 5610 to access database 5612 to retrieve or record issue graph models created by graph generator module 5606. Memory 5600 may also instruct database access module 5610 to access database 5612 to support operations of analysis module 5608.

As noted above, a machine-trained model may compute an organizational influence factor for organizations based on the issue graph. Similar to the “influence factor” described throughout the present disclosure, the organizational influence factor may be a value, score, or metric indicating the extent or magnitude to which an organization will affect an outcome of one or more policymakers. The organizational influence factor may be associated with a particular pair of organization and policymaker, or may be for a plurality of policymakers. The influence factor may be specific to a particular issue or set of issues, or may be a more general indicator of influence an organization has on a policymaker or plurality of policymakers.

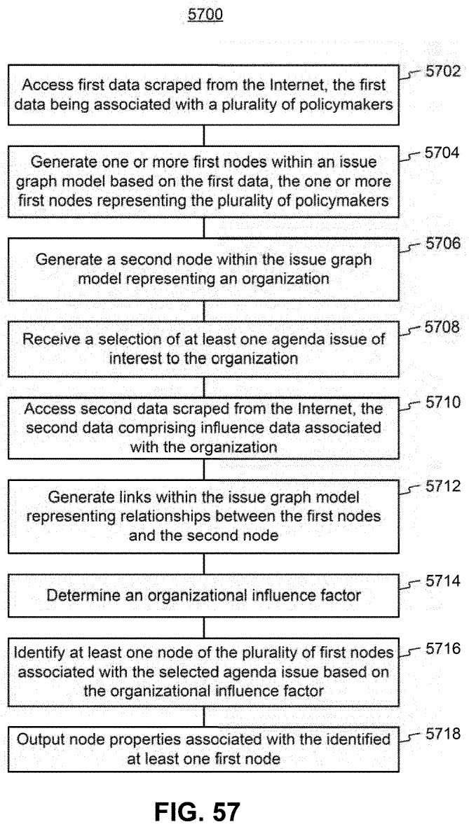

FIG. 57 illustrates a flow chart of an example process 5700 for assessing an influence of an organization, consistent with the disclosed embodiments. Process 5700 may be performed by at least one processing device of a server (e.g., central server 105 of FIG. 1) or any other appropriate hardware and/or software. In some embodiments, some or all of process 5700 may be performed by a different device associated with system 100. In some embodiments, a non-transitory computer readable medium may contain instructions that when executed by a processor cause the processor to perform process 5700. Further, process 5700 is not necessarily limited to the steps shown in FIG. 57, and any steps or processes of the various embodiments described throughout the present disclosure may also be included in process 5700, including those described above with respect to FIG. 55.

At step 5702, process 5700 may include accessing first data scraped from the Internet. The first data may be data associated with a plurality of policymakers, as described above. For example, the first data may include demographic information for one or more policymakers, a voting history for one or more policymakers, or a party affiliation for one or more policymakers, or any other information pertaining to policymakers that may be obtained from the Internet or other publicly available electronic sources. In some embodiments, step 5702 may be performed using one or more applications configured to function as web scrapers, as described above.

At step 5704, process 5700 may include generating one or more first nodes within an issue graph model based at least in part on the first data. The one or more first nodes may be generated to represent the plurality of policymakers. In some embodiments, each policymaker may be represented by a first node within the issue graph model. For example, a policymaker may be represented as a node in an issue graph similar to person 3704, as shown in FIG. 37. In some embodiments, the issue graph may be generated using a machine-trained model, as described above. For example, the model may be trained to analyze information scraped from the Internet in step 5702 (i.e., the first data) and automatically generate nodes for different policymakers based on the information.

At step 5706, process 5700 may include generating a second node within the issue graph model representing an organization. For example, this may include generating a node similar to the node representing organization 3706, as described above with respect to FIG. 37. The organization may be identified in various ways. In some embodiments, the organization may be defined by a user. For example, a user may select or otherwise identify the organization through a user interface. As another example, the organization may be prestored in the system. For example, process 5700 may be performed for one or more organizations that have been identified previously. As another example, the organization may be identified based on the first data. For example, the organization may be associated with one or more of the policymakers or otherwise identified in the first data. In some embodiments, the second node may be generated using a machine-trained model, similar to with step 5704.

At step 5708, process 5700 may include receiving a selection of at least one agenda issue of interest to the organization. In some embodiments, the selection may be received through a user interface, which may be similar to the various user interfaces described above with respect to FIGS. 49-54. For example, step 5708 may include receiving a selection by user(s) 107 received at user input module 1208.

In some embodiments, step 5708 may include maintaining a list of user-selectable agenda issues. As described above, the list of user-selectable agenda issues may be stored in modular database 1212, one or more storage servers 205a and 205b, as part of sources 103a, 103b, and 103c comprising one or more local databases, or various other storage locations. The list of user-selectable agenda issues may be periodically updated, added, and deleted based on user input received at user input module 1208. User-selectable agenda issues may include any topic or subject matter as relevant to an organization and may be specific or broad in scope. In some embodiments, the user-selectable agenda issues include legislative agenda issues.

Step 5708 may further include presenting to a user, via a user interface, the list of user-selectable agenda issues, wherein each of the listed user-selectable agenda issues is configured to be selected by the user via input received from the user. In some embodiments, each of the listed user-selectable agenda issues may be configured to be selected by the user via input received from the user. Step 5708 may then include receiving, via the user interface, based on the input received from the user, one or more agenda issues of interest to an organization.

At step 5710, process 5700 may include accessing second data scraped from the Internet. The second data may comprise data associated with the organization. The second data may include any data or information associated with an organization. For example, the information about the organization may include an organizational posture indicating posture of the organization. The posture may be with respect to a particular topic, or may be an overall posture or position an organization maintains. As another example, the information about the organization may include an effectiveness of the organization. As with effectiveness scores for other entities described throughout the present disclosure, the organizational effectiveness may indicate how likely an organization is to take an action or how effective the action may be. The second data may include other information, such as a number of employees, donations or contributions made by the organization, funding received by the organization, location information (e.g., headquarters location, incorporation location, office or branch locations), a founding data, individuals associated with the organization (e.g., a CEO, board members, etc.), a monetary lobbying amount, a sentiment of a comment made by or otherwise associated with the organization, financial data such as a revenue of the organization, or any other information about an organization that may be accessed electronically. In some embodiments, step 5710 may be performed using one or more applications configured to function as web scrapers, as described above.

At step 5712, process 5700 may include generating links within the issue graph model representing relationships between the first nodes and the second node. For example, this may include generating edges linking nodes to one or more other nodes within an issue graph model. As described herein, the issue graph model may be represented as a network of connections or lack thereof, between the first nodes (e.g., policymakers) and the second node or nodes (e.g., the organization) on each of the agenda issues. The relationships may be identified based at least in part on the first data, the second data, and the selected agenda issue. In some embodiments, the links may be generated using the machine-trained model, as described herein. For example, the machine-trained model may be trained to analyze structured or unstructured data and identify links between policymakers and organizations, as described above. In some embodiments, the issue graph model may be generated using additional information.

At step 5714, process 5700 may include determining an organizational influence factor, which may be based on the issue graph model. As described above, the organizational influence factor may comprise a measure of how likely the second node is to affect a property of each of the plurality of first nodes. In some embodiments, the property may include position of each of the plurality of policymakers on the at least one selected agenda issue. In some embodiments, the position may not necessarily be an indicator of an outcome of a particular policymaking. For example, the position may include a stance or political position of a policymaker on the at least one selected agenda issue.

In some embodiments, the organizational influence factor is determined based on application of a graph algorithm to the issue graph model (e.g., a subgraph including the first nodes and second node). The organizational influence factor may be determined based on various factors associated with the issue graph. In some embodiments, the organizational influence factor may be determined based on a number of relationships between the first nodes and the second node. For example, this may include a number of links between the first nodes and the second node, either directly or indirectly. As another example, the organizational influence factor may be determined based on the presence of at least one type of relationship between the first nodes and the second node. For example, this may be reflected based on a type of edge linking two or more nodes.

At step 5716, process 5700 may include identifying at least one node of the plurality of first nodes associated with the at least one selected agenda issue based on the organizational influence factor. For example, this may include identifying a node associated with the highest organizational influence factor in relation to the organization. In some embodiments, this may include identifying nodes associated with an organizational influence factor that exceeds a predetermine threshold.

In step 5718, process 5700 may include outputting node properties associated with the identified at least one first node. The node properties may include any information associated with the first node. For example, this may include a name, demographic information, an address, or other information associated with a policymaker represented by the node. In some embodiments, the node properties may include data scraped from the internet in step 5702.

In some embodiments, process 5700 may include additional steps beyond the steps shown in FIG. 57. For example, process 5700 may include transforming the organizational influence factor into a graphical display that presents the influence factors of the organization on each of the plurality of policymakers on each of the agenda issues selected as being of interest to the organization. For example, outputting the node properties associated with the identified at least one first node may include displaying a network representing the issue graph model, similar to the network described above with respect to FIG. 55. The displayed network may be interactive, thus enabling a user who engages with the network to view information about the organization. The displayed network may further allow a user to visualize the various nodes described above and their relationships. For example, the organization may be graphically represented as a node in the network. As another example, the selected agenda issue may similarly represented as a node in the network. In some embodiments, displaying the network may include highlighting the at least one first node. This highlighting may indicate the identified at least one first node is likely to be associated with the selected agenda issue.

In some embodiments, the at least one selected agenda issue may be associated with one or more weighting values, as described above. Accordingly, process 5700 may include causing the display of at least one control to adjust weighting of the at least one selected agenda issue and adjusting the displayed network based on subsequent user manipulation of the at least one weighting control. For example, this may include a slider element to allow a user to adjust the weight associated with a selected agenda issue, or various other interactive elements.

As described herein, the disclosed embodiments may include presenting an issue graph in various ways. In some embodiments, the issue graph may be presented as a network of nodes and edges as described in greater detail above. For example, the nodes may indicate stakeholders, organizations, events, data fields, documents, topics, key phrases, or other elements of the issue graph. Edges connecting the nodes may represent a relationship between these nodes. The display may be interactive, to allow a user to zoom in, zoom out, pan, scroll, or otherwise navigate the issue graph within the display. In some embodiments, the display may be three-dimensional, such that nodes and their relationships can be rotated in 3D space. In some embodiments, the display may allow a user to select one or more nodes or edges to display additional information about a node or relationship between nodes. In some embodiments, the display may allow a user to modify one or more properties of a node or edge by selecting an edge. For example, this may include modifying a relationship, deleting a relationship, adding a new relationship, or otherwise modifying the issue graph.

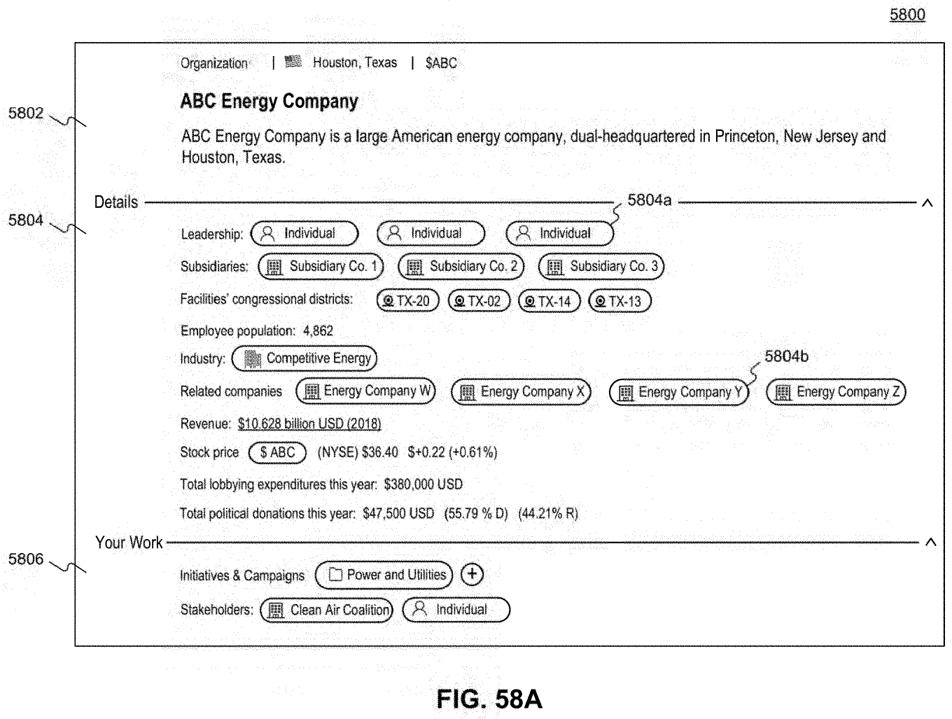

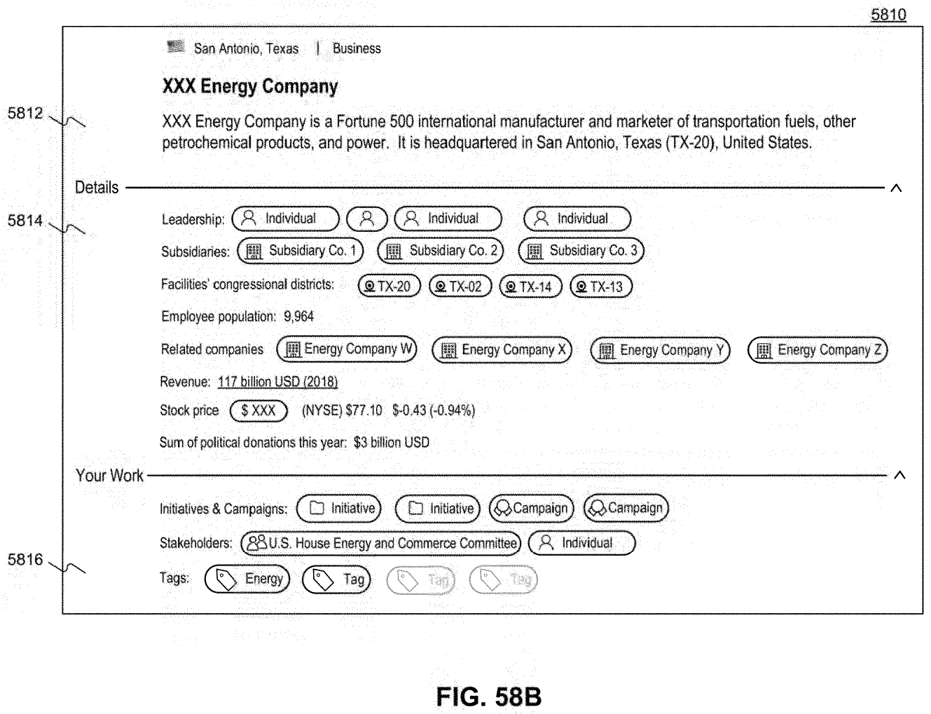

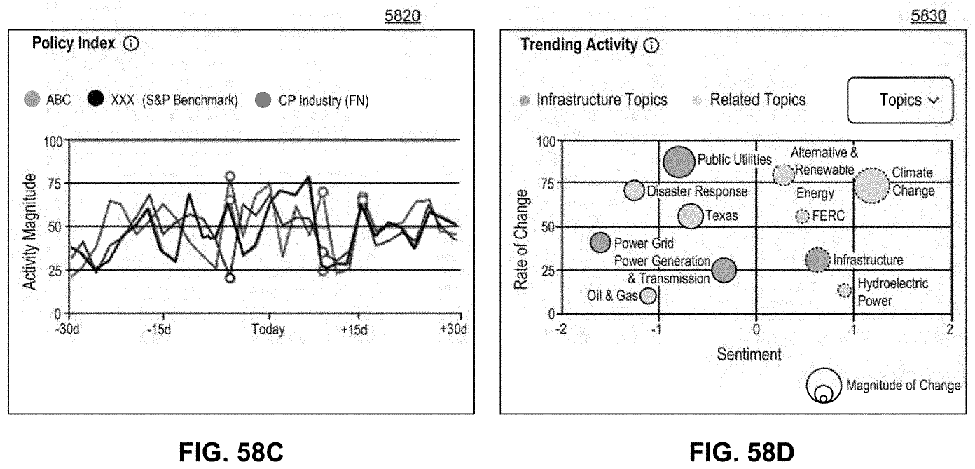

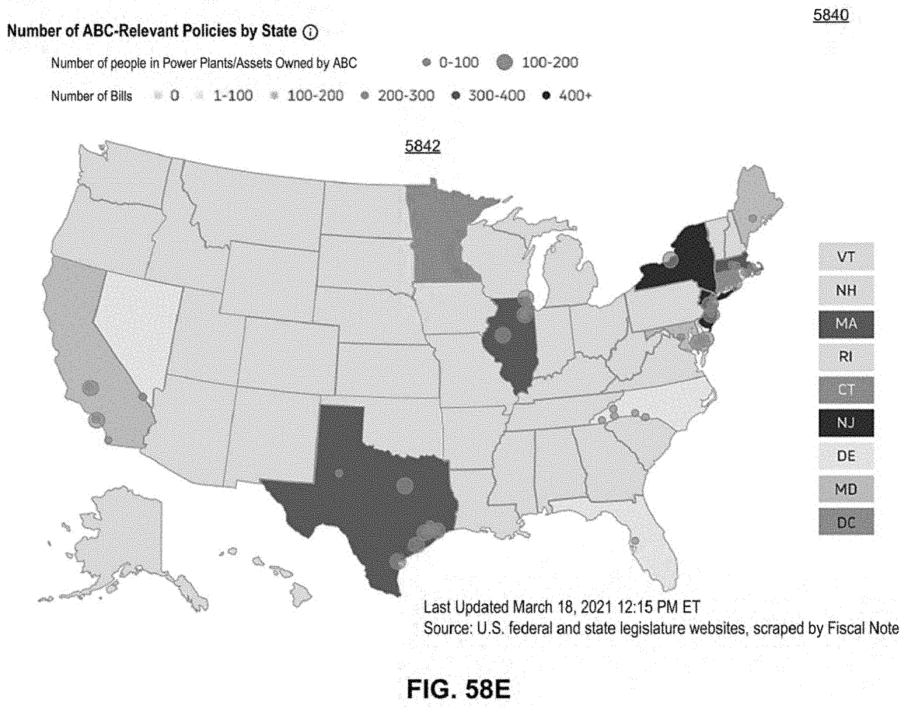

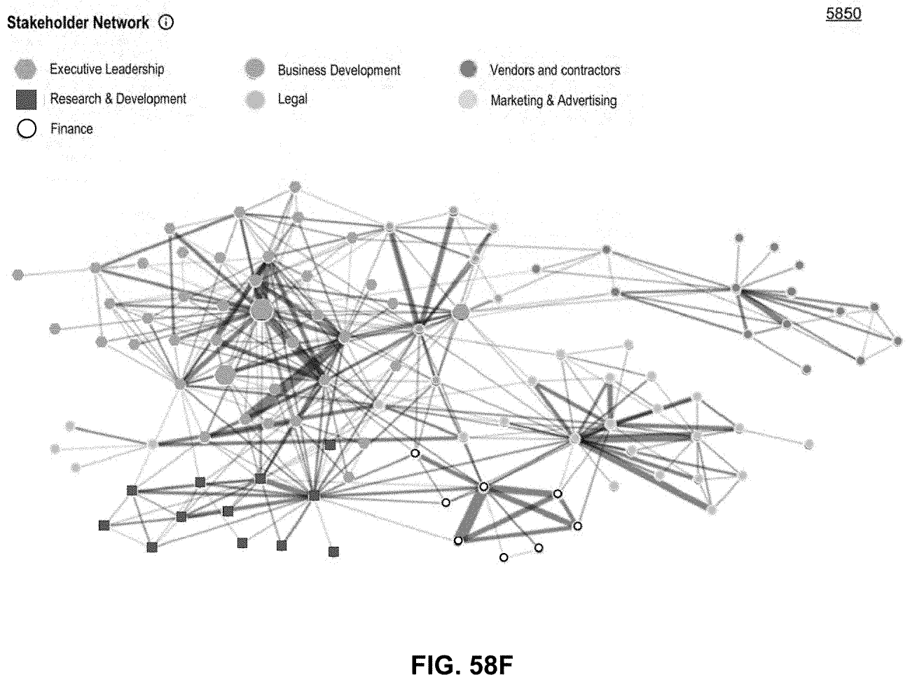

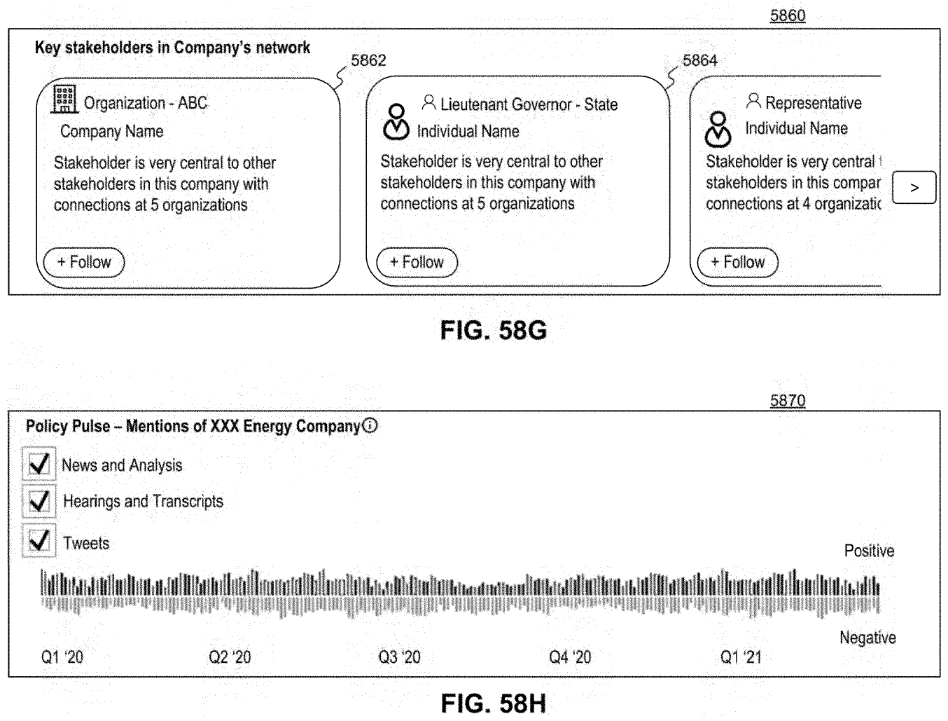

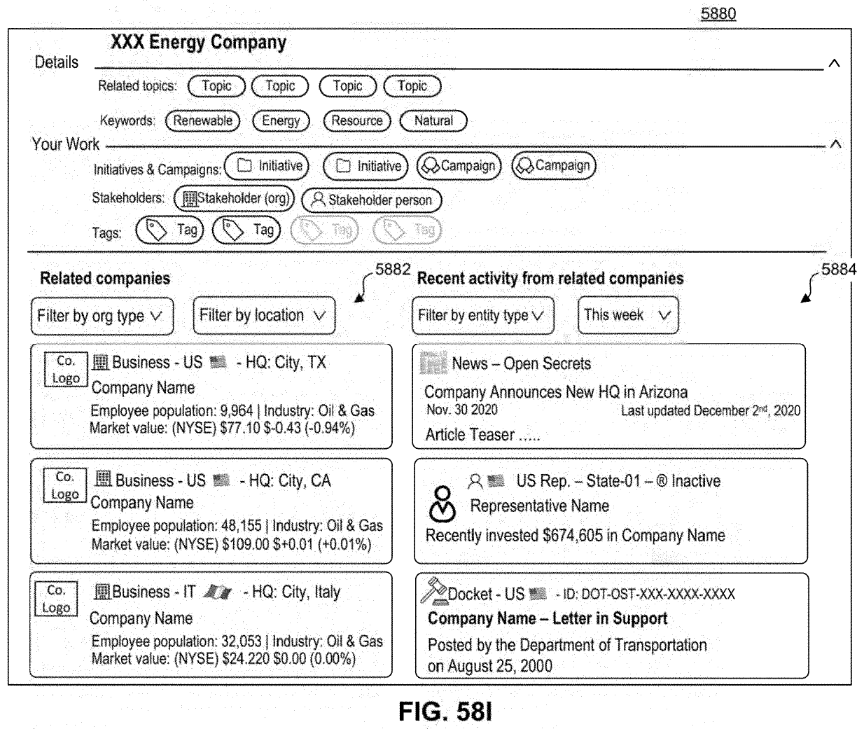

In some embodiments, displaying the issue graph may include displaying information extracted from the issue graph via one or more user interfaces. FIGS. 58A, 58B, 58C, 58D, 58E, 58F, 58G, 58H, 58H, and 58I illustrate example user interface elements for presenting an issue graph, consistent with the disclosed embodiments. It is to be understood that these interfaces are provided by way of example and information from the issue graphs may in various other forms of interfaces. In some embodiments, two or more of the various user interface elements described herein may be displayed as part of the same display.

FIG. 58A illustrates an example user interface 5800 displaying a company profile including information extracted from the issue graphs described above. In this example, user interface 5800 may include an overview section 5802 providing information for a company “ABC Energy Company.” User interface 5800 may further include a details section providing additional details about the company. In some embodiments, the details section may include relationship information included in one or more issue graphs. For example, this may include stakeholders associated with the company, such as individual 5804a which may be involved in the leadership of ABC Energy Company, or energy company 5804b, which may be related to ABC Energy Company. Other examples may include, subsidiary companies, congressional districts associated with company locations, an industry associated with the company, or various other relationships described herein. User interface 5800 may also include a “Your Work” section 5806, which may include links to various tags or properties associated with the company. This section may include relationships or information specific to a particular user of interface 5800.

In some embodiments, selecting various elements displayed on user interface 5800 may bring up additional information. For example, selecting individual 5804a may cause a separate user interface associated with individual 5804a to be displayed. FIG. 58B illustrates another example user interface 5810 displaying a company profile for another company, XXX Energy Company. As with interface 5800, interface 5810 may include a summary section 5812, a “Details” section 5814, and a “Your Work” section 5816.

FIG. 58C illustrates an example policy index user interface 5820 consistent with the disclosed embodiments. In particular, user interface 5820 may include a graphical representation of events associated with an organization over time. In this example, user interface 5820 may display events associated with ABC Energy Company and XXX Energy Company. In some embodiments, user interface 5820 may be customizable to filter only certain categories of events, or similar filter criteria. As shown in FIG. 58C, user interface 5820 may further include a reference dataset “CP Industry” which may indicate an average number of events for organizations within the industry, or other reference data.

FIG. 58D illustrates an example user interface 5830 showing industry trends, consistent with the disclosed embodiments. User interface 5830 displays various subtopics or related topics deemed relevant to a company. In particular, user interface 5830 may display various bubbles, each representing a different infrastructure topic or a topic deemed relevant to an organization. Each bubble may be positioned within a graphical display according to properties of the topic or subtopic. In this example, a vertical axis may represent a rate of change associated with the trend whereas a horizontal axis may represent a sentiment associated with the topic (e.g., a degree of how positive or negative a sentiment is). A size of the bubble may indicate a magnitude of the change in popularity of a topic.

FIG. 58E illustrates an example geographic user interface 5830 showing policies relevant to an organization by location, consistent with the disclosed embodiments. As shown in FIG. 58E, user interface 5830 may include a map 5842, which may indicate the locations of facilities or other assets associated with an organization within the U.S. While a national map is provided by way of example, similar maps may be shown for global presence, for individual states, for individual counties, or other territories. In this example, map 5842 may include one or more bubble indicating the location of assets associated with the company. The size of the bubble may indicate the relative size of the asset (e.g., based on the number of employees, a degree of influence, etc.). Further, each state (or other territory) may be shaded to indicate a number of bills relevant to a particular organization.

FIG. 58F illustrates an example stakeholder network user interface 5850, consistent with the disclosed embodiments. As described above, an issue graph may be represented as various nodes and edges. User interface 5850 may illustrate various stakeholders associated with an organization (e.g., employees) which may be represented as nodes, with relationships between the stakeholders represented as edges. In some embodiments, the various stakeholders may be represented as nodes having a distinguishing characteristic indicating a category of the stakeholder, as shown.

FIG. 58G illustrates an example user interface 5860 summarizing key stakeholders in an organization's network, consistent with the disclosed embodiments. User interface 5860 may include a plurality of stakeholder card elements 5862 and 5864 identifying relevant stakeholders. For example, card element 5862 may indicate another organization associated with a company, and card element 5864 may indicate an elected official relevant to the company. The card elements may also include other information indicating a degree of relevance, such as a number of relevant connections the stakeholder has.

FIG. 58H illustrates an example “policy pulse” user interface 5870 indicating a number of mentions of a company in the media, consistent with the disclosed embodiments. User interface 5870 may be similar to user interface 5820, as described above. As shown in FIG. 58H, user interface 5870 may split mentions between positive and negative sentiments. user interface 5870 may further allow filtering types of media sources, such as news articles, hearings or transcripts, social media posts, or various other categories.

FIG. 58I illustrates another example company profile user interface 5880, consistent with the disclosed embodiments. User interface 5880 may be similar to user interfaces 5800 and 5810 described above. User interface 5880 may further include element 5882 showing companies related to XXX Energy Company. Element 5882 may allow related companies to be filtered based on types of organizations, locations of organizations, or various other information. User interface 5880 may also include an element 5884 showing recent activity from related companies. This may include news or media articles associated with related companies, investments by stakeholders in relevant companies, documents associated with related companies, or the like. Element 5884 may also be filtered based on entity types, timings of events or activities, locations of activities, particular companies the activity is related to, or the like.

In some embodiments, a machine-trained model may be trained to identify stakeholders that are relevant to an issue. For example, this may include non-policymakers that are relevant to an issue, such as individuals that are passionate about an issue, subject matter experts associated with an issue, or the like. Similar to the “influence factor” described throughout the present disclosure, the system may determine importance scores for one or more stakeholders relative to an issue. The importance scores may then be used to identify one or more stakeholders relevant to an issue, which may be represented in an issue graph.

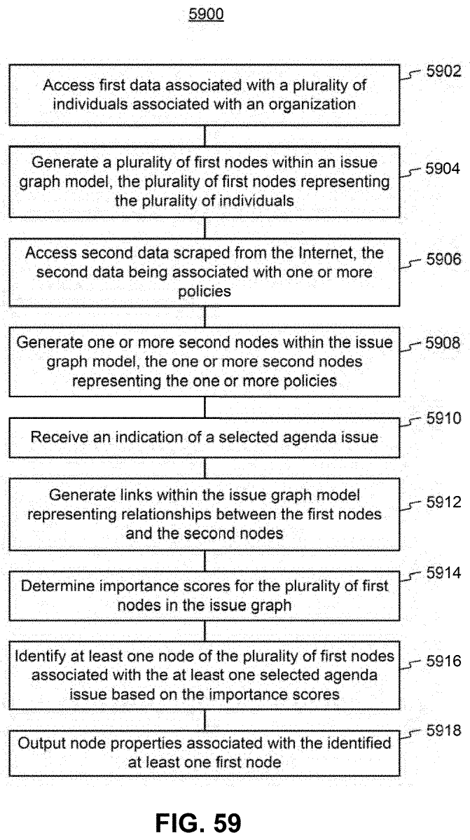

FIG. 59 illustrates a flow chart of an example process 5900 for identifying stakeholders relative to an issue, consistent with the disclosed embodiments. Process 5900 may be performed by at least one processing device of a server (e.g., central server 105 of FIG. 1) or any other appropriate hardware and/or software. In some embodiments, some or all of process 5900 may be performed by a different device associated with system 100. In some embodiments, a non-transitory computer readable medium may contain instructions that when executed by a processor cause the processor to perform process 5900. Further, process 5900 is not necessarily limited to the steps shown in FIG. 59, and any steps or processes of the various embodiments described throughout the present disclosure may also be included in process 5900, including those described above with respect to FIGS. 55 and 57.

At step 5902, process 5900 may include accessing first data associated with a plurality of individuals associated with an organization. The plurality of individuals may be non-policymaker stakeholders of the organization, as described above. For example, this may include employees or other members of the organization that are not policymakers. The first data may be obtained from one or more of a variety of data source providers. For example, this may include a list of members of the organization, such as a company directory or other list associated with a company. In some embodiments, the first data may include data associated with a social network. For example, the first data may include data extracted from LinkedIn™ or another social network. In some embodiments, the first data may be extracted from a database, a webpage, or other source of data that may identify individuals within an organization. In some embodiments, step 5902 may include scraping the Internet to obtain the first data and therefore may be performed using one or more applications configured to function as web scrapers, as described above.

In some embodiments, process 5900 may further include receiving information identifying the organization. For example, this may include receiving information identifying the organization from a user. In some embodiments, this may include receiving they information identifying the information from the user via a user interface. As another example, the information identifying the organization may received based on the user being a member of the organization. For example, the user may be associated with the organization based on a user profile, metadata, or other information indicating the user is the member of the organization. Process 5900 may automatically identify the organization based on this information.

At step 5904, process 5900 may include generating a plurality of first nodes within an issue graph model based at least in part on the first data. The one or more first nodes may be generated to represent the plurality of individuals. In some embodiments, each individual may be represented by a different first node within the issue graph model. For example, an individual may be represented as a node in an issue graph similar to User 1 and User 2, as shown in FIG. 39. In some embodiments, the issue graph may be generated using a machine-trained model, as described above. For example, the model may be trained to analyze the first data obtained from a plurality of data sources in step 5902 and automatically generate nodes for different individuals based on the information.

At step 5906, process 5900 may include accessing second data scraped from the Internet. The second data may comprise data associated with one or more policies. For example, the second data may include a topic associated with the policy, a title of the policy, a sponsor of the policy, a date associated with the policy, a text of the policy, notes associated with the policy, or the like. In some embodiments, step 5910 may be performed using one or more applications configured to function as web scrapers, as described above.

At step 5906, process 5900 may include generating one or more second nodes within the issue graph model representing the one or more policies. For example, this may include generating a policy document node similar to the node representing document 3702, as described above with respect to FIG. 37. In some embodiments, the second node may be generated using a machine-trained model, similar to with step 5904.

At step 5908, process 5900 may include receiving an indication of a selected agenda issue. In some embodiments, the selection may be received through a user interface, which may be similar to the various user interfaces described above with respect to FIGS. 49-54. For example, step 5908 may include receiving a selection by user(s) 107 received at user input module 1208.

In some embodiments, step 5908 may include accessing a plurality of agenda issues. For example, a server may maintain a list of user-selectable agenda issues. As described above, the list of user-selectable agenda issues may be stored in modular database 1212, one or more storage servers 205a and 205b, as part of sources 103a, 103b, and 103c comprising one or more local databases, or various other storage locations. Step 5908 may further include presenting the plurality of agenda issues to a user via a user interface. Each of the plurality of agenda issues may be configured for selection by the user via the user interface. In some embodiments, each of the listed user-selectable agenda issues may be configured to be selected by the user via input received from the user. Step 5908 may then include receiving, via the user interface, a selection from the user of at least one of the plurality of agenda issues.

At step 5912, process 5900 may include generating links within the issue graph model representing relationships between the first nodes and the second nodes. For example, this may include generating edges linking nodes to one or more other nodes within an issue graph model. As described herein, the issue graph model may be represented as a network of connections or lack thereof, between the first nodes (e.g., individuals) and the second node or nodes (e.g., the one or more policies) on each of the agenda issues. The relationships may be identified based at least in part on the data associated with the plurality of individuals, the data associated with the plurality of policy documents, and the selected agenda issue. In some embodiments, the links may be generated using the machine-trained model, as described herein. For example, the machine-trained model may be trained to analyze structured or unstructured data and identify links between non-policymaker individuals and policies, as described above. In some embodiments, the issue graph model may be generated using additional information. For example, process 5900 may include parsing and ingesting data from a data source external to the system and generating the issue graph model based on the ingested data.

At step 5914, process 5900 may include determining importance scores for the plurality of first nodes in the issue graph. The importance scores may comprise a measure of how important or relevant a policy is to an individual. For example, individuals that have a greater association with a particular policy may be assigned a greater importance score.

In some embodiments, the importance score may be determined based on application of a graph algorithm to the issue graph model (e.g., a subgraph including the first nodes and second node). The importance score may be determined based on various factors associated with the issue graph. In some embodiments, the importance score may be determined based on a number of relationships between the first nodes and the second node. For example, this may include a number of links between the first nodes and the second node, either directly or indirectly. As another example, the importance score may be determined based on the presence of at least one type of relationship between the first nodes and the second node. For example, this may be reflected based on a type of edge linking two or more nodes.

At step 5916, process 5900 may include identifying at least one node of the plurality of first nodes associated with the at least one selected agenda issue based on the importance scores. For example, this may include identifying a node associated with the highest importance scores in relation to the policy. In some embodiments, this may include identifying nodes associated with an importance score that exceeds a predetermine threshold score. The identified node may be determined to have various relationships with the selected agenda issue. For example, identifying the at least one node may include determining the at least one individual has a degree of expertise related to the at least one selected agenda issue. As another example, identifying the at least one node includes determining the at least one individual is a point of contact for the organization for the at least one selected agenda issue. For example, the issue graph may indicate that the at least one individual is a “resident expert” or main contact for the selected agenda issue within the organization. In some embodiments, identifying the at least one node may include identifying at least one of a comment or article authored by an individual associated with the at least one node. As another example, identifying the at least one node may include determining a degree of influence an individual associated with the at least one node is expected to have on others in relation to the selected agenda issue. Various other relationships between the individual and the selected agenda issue may be identified as described

In step 5918, process 5900 may include outputting node properties associated with the identified at least one node. The node properties may include any information associated with the first node. For example, this may include a name, demographic information, an address, or other information associated with a policymaker represented by the node. In some embodiments, the node properties may include the first data accessed in step 5902. Step 5918 may include outputting additional recommendations or information. For example, outputting the identification information associated with the identified at least one individual may include generating a suggested action associated with the identified at least one individual. For example, this may include generating a suggested action of contacting the individual, including the individual in a targeted campaign (e.g., emails, direct mailings, etc.), monitoring actions of the individual, or various other actions described herein.

In some embodiments, process 5900 may include additional steps beyond the steps shown in FIG. 59. For example, process 5900 may include transforming the organizational influence factor into a graphical display that presents the influence factors of the organization on each of the plurality of policymakers on each of the agenda issues selected as being of interest to the organization. For example, outputting the node properties associated with the identified at least one first node may include displaying a network representing the issue graph model, similar to the network described above with respect to FIG. 59. The displayed network may be interactive, thus enabling a user who engages with the network to view information about the organization. The displayed network may further allow a user to visualize the various nodes described above and their relationships. For example, the organization may be graphically represented as a node in the network. As another example, the selected agenda issue may similarly represented as a node in the network. In some embodiments, displaying the network may include highlighting the at least one first node. This highlighting may indicate the identified at least one first node is likely to be associated with the selected agenda issue.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules may be created using any of the techniques known to one skilled in the art or can be designed in connection with existing software. For example, program sections or program modules may be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. The steps of the disclosed methods may be modified in any manner, including by reordering steps and/or inserting or deleting steps. Further, the section headings contained herein are merely for ease of reference and are not limiting. It is intended, therefore, that the specification and examples be considered as illustrative only, with a true scope and spirit being indicated by the following claims and their full scope of equivalents.

1. A system for analyzing organizational influence data, the system comprising:
at least one processor configured to:
scrape a first plurality of sources on the Internet using a web crawler and an extraction bot to identify first data associated with a plurality of policymakers, wherein the web crawler is configured to perform functions of finding, indexing, and fetching information from the plurality of sources on the Internet, and wherein the extraction bot is configured to perform processing on the information from the plurality of sources to generate the first data;
generate, using a machine trained model, one or more first nodes within an issue graph model based at least in part on the first data, the one or more first nodes representing the plurality of policymakers, the model having been trained using a training set of documents to extract nodes and relationships between the nodes from unstructured text within the training set of documents;
generate, using the machine trained model, a second node within the issue graph model representing an organization;
store the one or more first nodes and the second node in a graph database;
receive, via a user interface, a selection of at least one agenda issue of interest to the organization;
access second data scraped from a second plurality of sources on the Internet, the second data comprising data associated with the organization;
generate, using the machine trained model, links within the issue graph model representing relationships between the one or more first nodes and the second node stored in the graph database, the relationships being identified based at least in part on the first data, the second data, and the selected agenda issue, the links being associated with at least one label indicating a type of an associated relationship between the one or more first nodes and the second node, the type of relationship being identified using the machine trained model;
determine an organizational influence factor, the organizational influence factor comprising a measure of how likely the second node is to affect a property of each of the plurality of first nodes, where the property includes a position of each of the plurality of policymakers on the at least one selected agenda issue, the position comprising at least one of a stance or political position of a policymaker on the at least one selected agenda issue and not an indicator of an outcome of a particular policymaking, the organizational influence factor being based on the type of relationship;
identify at least one node of the plurality of first nodes associated with the at least one selected agenda issue based on the organizational influence factor; and
output node properties associated with the identified at least one node, wherein outputting the node properties includes:
causing display of a network within the user interface, the network representing the issue graph model and including graphical representations of the one or more first nodes, the second node, and the links; and
highlighting the at least one node in the user interface to indicate the identified at least one node is likely to be associated with the selected agenda issue.

2. The system of claim 1, wherein the organizational influence factor is determined based on a number of relationships between the one or more first nodes and the second node.

3. The system of claim 1, wherein the organizational influence factor is determined based on the presence of at least one type of relationship between the one or more first nodes and the second node.

4. The system of claim 1, wherein the organizational influence factor is determined based on application of a graph algorithm to the issue graph model.

5. The system of claim 1, wherein the organizational influence factor is determined based on at least one pattern in the data associated with the organization.

6. (canceled)

7. (canceled)

8. The system of claim 1, wherein the organization is represented as a node in the network.

9. The system of claim 1, wherein the selected agenda issue is represented as a node in the network.

10. The system of claim 1, wherein the at least one processor is further configured to cause the display of at least one control to adjust weighting of the at least one selected agenda issue.

11. The system of claim 10, wherein the at least one processor is further configured to adjust the displayed network based on subsequent user manipulation of the at least one weighting control.

12. The system of claim 1, wherein the at least one processor is further configured to access an additional organizational influence factor, and to adjust the displayed network based on the additional organizational influence factor.

13. The system of claim 1, wherein the displayed network is interactive, enabling a user who engages with the network to view information about the organization.

14. The system of claim 1, wherein the at least one selected agenda issue includes a legislative agenda issue, and the plurality of policymakers include legislators.

15. The system of claim 1, wherein the at least one selected agenda issue includes a regulatory agenda issue, and the plurality of policymakers include at least one of regulators or government officials.

16. The system of claim 1, wherein the at least one selected agenda issue is related to one or more government bodies.

17. The system of claim 1, wherein the data associated with the organization includes at least one of an organizational posture, an effectiveness of the organization, a monetary lobbying amount, an office location, a comment sentiment, or a revenue of the organization.

18. The system of claim 1, wherein the second data further includes individual policymaker data, the individual policymaker data including at least one of demographic information, a voting history, or a party affiliation,

19. A computer-implemented method for analyzing organizational influence data, the method comprising:
scraping a first plurality of sources on the Internet using a web crawler and an extraction bot to identify first data associated with a plurality of policymakers, wherein the web crawler is configured to perform functions of finding, indexing, and fetching information from the plurality of sources on the Internet, and wherein the extraction bot is configured to perform processing on the information from the plurality of sources to generate the first data;
generating, using a machine trained model, one or more first nodes within an issue graph model based at least in part on the first data, the one or more first nodes representing the plurality of policymakers, the model having been trained using a training set of documents to extract nodes and relationships between the nodes from unstructured text within the training set of documents;
generating, using the machine trained model, a second node within the issue graph model representing an organization;
storing the one or more first nodes and the second node in a graph database;
receiving, via a user interface, a selection of at least one agenda issue of interest to the organization;
accessing second data scraped from a second plurality of sources on the Internet, the second data comprising data associated with the organization;
generating, using the machine trained model, links within the issue graph model representing relationships between the one or more first nodes and the second node stored in the graph database, the relationships being identified based at least in part on the first data, the second data, and the selected agenda issue, the links being associated with at least one label indicating a type of an associated relationship between the one or more first nodes and the second node, the type of relationship being identified using the machine trained model;
determining an organizational influence factor, the organizational influence factor comprising a measure of how likely the second node is to affect a property of each of the plurality of first nodes, where the property includes a position of each of the plurality of policymakers on the at least one selected agenda issue, the position comprising at least one of a stance or political position of a policymaker on the at least one selected agenda issue and not an indicator of an outcome of a particular policymaking, the organizational influence factor being based on the type of relationship;
identifying at least one node of the plurality of first nodes associated with the at least one selected agenda issue based on the organizational influence factor; and
outputting node properties associated with the identified at least one node, wherein outputting the node properties includes:
causing display of a network within the user interface, the network representing the issue graph model and including graphical representations of the one or more first nodes, the second node, and the links; and
highlighting the at least one node in the user interface to indicate the identified at least one node is likely to be associated with the selected agenda issue.

20. A non-transitory computer-readable medium comprising instructions that, when executed by at least one processor, cause the at least one processor to perform operations including:
scraping a first plurality of sources on the Internet using a web crawler and an extraction bot to identify first data associated with a plurality of policymakers, wherein the web crawler is configured to perform functions of finding, indexing, and fetching information from the plurality of sources on the Internet, and wherein the extraction bot is configured to perform processing on the information from the plurality of sources to generate the first data;
generating, using a machine trained model, one or more first nodes within an issue graph model based at least in part on the first data, the one or more first nodes representing the plurality of policymakers, the model having been trained using a training set of documents to extract nodes and relationships between the nodes from unstructured text within the training set of documents;
generating, using the machine trained model, a second node within the issue graph model representing an organization;
storing the one or more first nodes and the second node in a graph database;
receiving, via a user interface, a selection of at least one agenda issue of interest to the organization;
accessing second data scraped from a second plurality of sources on the Internet, the second data comprising data associated with the organization;
generating, using the machine trained model, links within the issue graph model representing relationships between the one or more first nodes and the second node stored in the graph database, the relationships being identified based at least in part on the first data, the second data, and the selected agenda issue, the links being associated with at least one label indicating a type of an associated relationship between the one or more first nodes and the second node, the type of relationship being identified using the machine trained model;
determining an organizational influence factor, the organizational influence factor comprising a measure of how likely the second node is to affect a property of each of the plurality of first nodes, where the property includes a position of each of the plurality of policymakers on the at least one selected agenda issue, the position comprising at least one of a stance or political position of a policymaker on the at least one selected agenda issue and not an indicator of an outcome of a particular policymaking, the organizational influence factor being based on the type of relationship;
identifying at least one node of the plurality of first nodes associated with the at least one selected agenda issue based on the organizational influence factor; and
outputting node properties associated with the identified at least one node, wherein outputting the node properties includes:
causing display of a network within the user interface, the network representing the issue graph model and including graphical representations of the one or more first nodes, the second node, and the links; and
highlighting the at least one node in the user interface to indicate the identified at least one node is likely to be associated with the selected agenda issue.
